(19) United States
(12) Patent Application Publication
(10) Pub. No.: US 2025/0055021 A1
(43) Pub. Date: Feb. 13, 2025

(54) LITHIUM ION BATTERIES INCLUDING CO-INTERCALATION-FREE ETHER SOLVENTS

(71) Applicant: The University of Chicago, Chicago, IL (US)

(72) Inventors: Chibueze AMANCHUKWU, Chicago, IL (US); Peiyuan MA, Chicago, IL (US)

(21) Appl. No.: 18/904,747

(22) Filed: Oct. 2, 2024

Related U.S. Application Data
(63) Continuation of application No. PCT/US2023/065356, filed on Apr. 5, 2023.
(60) Provisional application No. 63/327,924, filed on Apr. 6, 2022.

(51) Int. Cl. H01M 10/0525; H01M 4/02; H01M 4/38; H01M 4/58; H01M 10/0568; H01M 10/0569; H01M 10/058

(52) U.S. Cl. CPC H01M 10/0525; H01M 4/382; H01M 4/5825; H01M 10/0568; H01M 10/0569; H01M 10/058; H01M 2004/028

(57) ABSTRACT

Lithium-ion cells including fluoroether electrolytes and configured to promote lithium intercalation and (de)intercalation within graphite without fluoroether co-intercalation are provided. Processes for preparing the lithium-ion cells are further provided.

### TECHNICAL FIELD

The present disclosure relates to batteries. More particularly, the disclosure relates to lithium ion batteries including co-intercalation-free ether solvents.

### BACKGROUND

Lithium-ion batteries have been used widely to power portable electronics due to their high energy densities, and have shown great promise in enabling the “electrification” of transport. The first, dominant lithium-ion chemistry included a graphite anode, a LiCoO₂ cathode, and an electrolyte including 1 M LiPF₆ dissolved in ethylene carbonate (“EC”) and a linear carbonate (for example, dimethyl carbonate, diethyl carbonate, or ethyl methyl carbonate). Fervent research to improve the performance of lithium-ion batteries has led to novel anode and cathode materials, such as Li₄T₅O₁₂ (“LTO”) anode for high power, and cathodes such as inexpensive LiFePO₄, thermally stable LiMn₂O₄, and high-capacity LiNiₓMn_{y}Co_{z}.

By contrast, electrolyte innovation has stalled, and all electrolytes currently used are still based on combinations of EC, linear carbonate, and LiPF₆. EC-based electrolytes are considered state-of-the-art because they enable reversible lithium (de)intercalation by surface passivation. However, EC has a relatively high melting point, and LiPF₆ has relatively poor thermal stability, so the operating temperature range for EC-based electrolytes is limited to −20° C. to 40° C., and attempts at rapid charging have been hampered. For the past thirty years, additive engineering, in which <5% of a salt or a solvent is added to the electrolyte, has been the primary approach to modulate electrolyte physicochemical properties and electrode surface passivation. The lack of alternative lithium-ion electrolytes has stymied the development of next-generation cathode chemistries, such as those based on low cobalt (LiNiO₂), high voltage (LiCoPO₄), or conversion cathodes such as sulfur and oxygen that chemically react with carbonate solvents.

Ether compounds are thought to be more promising candidates for electrolyte solvents, and have been explored for various battery chemistries due to having good reductive stability, low melting point, and low viscosity. However, when used in lithium-ion batteries, ether molecules have had a tendency to insert between the individual graphene layers of graphite, together with lithium ions, in a process known as “solvent co-intercalation.” Solvent co-intercalation leads to significant decay in energy density; graphite electrodes cycled in glyme electrolytes have achieved approximately 50% of theoretical graphite capacity, with much higher overpotential (>1 V on average). Thus, glymes have been non-starters for lithium-ion batteries.

To suppress solvent co-intercalation of ether solvents, high-concentration electrolytes (“HCEs”) have been explored. At high salt concentrations, such as concentrations above 1 M, solvation structure may be dominated by ion-pairing, and solvent co-intercalation may be suppressed by an anion-derived solid electrolyte interphase (“SEI”). However, HCEs have been limited by poor wettability, low ionic conductivity, and high cost, given that the salt is often the most expensive component of the electrolyte. Localized high-concentration electrolytes (“LHCEs”) address challenges facing HCEs by diluting a LCE with a hydrofluoroether solvent. Because a LHCE diluent cannot dissolve lithium salt, the solvation structure in HCEs is maintained. Regardless, both HCEs and LHCEs have to maintain a high salt to solvating solvent molar ratio (approximately 0.5-1) so as to suppress solvent co-intercalation, because the tendency of ether solvents to co-intercalate remains. With LHCEs, any loss in lithium inventory within the electrolyte during cycling may change the solvation structure and enable undesired solvent co-intercalation, and consequently, may degrade the battery.

Thus, there is a need for solvents that prevent solvent co-intercalation within lithium ion batteries at conventional salt concentrations. Further, there is a need for lithium-ion batteries that are operable at larger ranges of temperature and/or capable of rapid charging, and/or that incorporate novel cathodes.

### SUMMARY

In an example, the present disclosure provides a lithium-ion cell. The lithium-ion cell includes a first electrode including lithium metal or lithium iron phosphate (LiFePO₄). The lithium-ion cell further includes a second electrode including graphite. The lithium-ion cell further includes a fluoroether electrolyte including one or more compounds of formulae (I), (II), and/or (III):

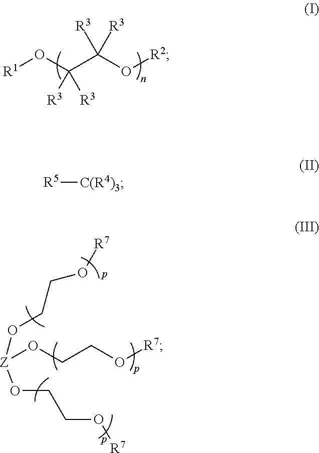

R¹ is a fluoro-substituted C₂-C₆ alkyl group; R² is a C₂-C₆ alkyl group or a fluoro-substituted C₂-C₆ alkyl group; each R³ independently is H, F, methyl, or fluoro-substituted methyl; n is 0, 1, 2, 3, 4, or 5; each R⁴ is —CH₂—(OCH₂CH₂)ₘ—OR⁶; R⁵ is methyl or R⁴; R⁶ is a fluoro-substituted C₂-C₆ alkyl group; m is 0, 1, 2, 3, 4, or 5; each R⁷ is a fluoro-substituted C₂-C₆ alkyl group; Z is B, Al, or P═O; and p is 0, 1, 2, 3, 4, or 5. A lithium salt may be dissolved in the fluoroether electrolyte. During cycling, the lithium-ion cell may be configured to promote lithium inercalation and (de)intercalation within graphite without fluoroether co-intercalation. The lithium salt may be selected from the group consisting of lithium bis(fluorosulfonyl)amide (LiFSA), LiTFSI, LiOTf, LiNO₃, LiPF₆, lithium bis(oxalato)borate (LiBOB), lithium difluoro(oxalato)borate (LiDFOB), LiBF₄, and LiClO₄. The molarity of the lithium salt in the fluoroether electrolyte may be from about 0.1 M to about 5.0 M. During cycling, the lithium-ion cell may be configured to retain at least 80% capacity between a temperature range of from about −20° C. to about 60° C. The lithium-ion cell may be configured to maintain a first-cycle coulombic efficiency of at least 85%. A battery, may including a plurality of the lithium-ion cells connected in series or in parallel.

In another example, the present disclosure provides a process for preparing a lithium-ion cell. The process includes dissolving a lithium salt in a fluoroether electrolyte including one or more compounds of formulae (I), (II), and/or (III) so as to provide a solution:

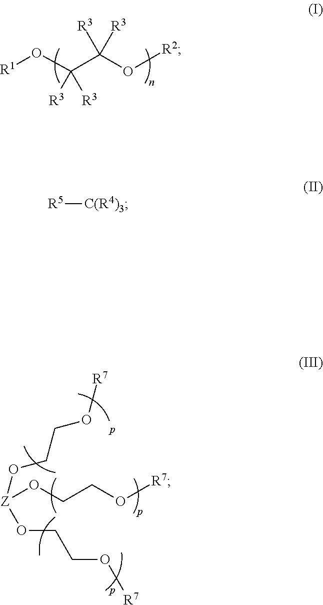

R¹ is a fluoro-substituted C₂-C₆ alkyl group; R² is a C₂-C₆ alkyl group or a fluoro-substituted C₂-C₆ alkyl group; each R³ independently is H, F, methyl, or fluoro-substituted methyl; n is 0, 1, 2, 3, 4, or 5; each R⁴ is —CH₂—(OCH₂CH₂)ₘ—OR⁶; R⁵ is methyl or R⁴; R⁶ is a fluoro-substituted C₂-C₆ alkyl group; m is 0, 1, 2, 3, 4, or 5; each R⁷ is a fluoro-substituted C₂-C₆ alkyl group; Z is B, Al, or P═O; and p is 0, 1, 2, 3, 4, or 5. The process further includes adding the solution to a cell including a first electrode including lithium metal and a second electrode including graphite. The lithium salt may be selected from the group consisting of LiFSA, LiTFSI, LiOTf, LiNO₃, LiPF₆, LiBOB, LiDFOB, LiBF₄, and LiClO₄. The molarity of the lithium salt in the fluoroether electrolyte is from about 0.1 M to about 5.0 M. During cycling, the lithium-ion cell may be configured to retain at least 80% capacity between a temperature range of from about −20° C. to about 60° C. The lithium-ion cell may be configured to maintain a first-cycle coulombic efficiency of at least 85%.

In yet another example, the present disclosure provides a lithium-ion cell. The lithium-ion cell includes a first electrode including lithium metal. The lithium-ion cell further includes a second electrode including graphite. The lithium-ion cell further includes a fluoroether electrolyte including one or more compounds selected from the group consisting of:

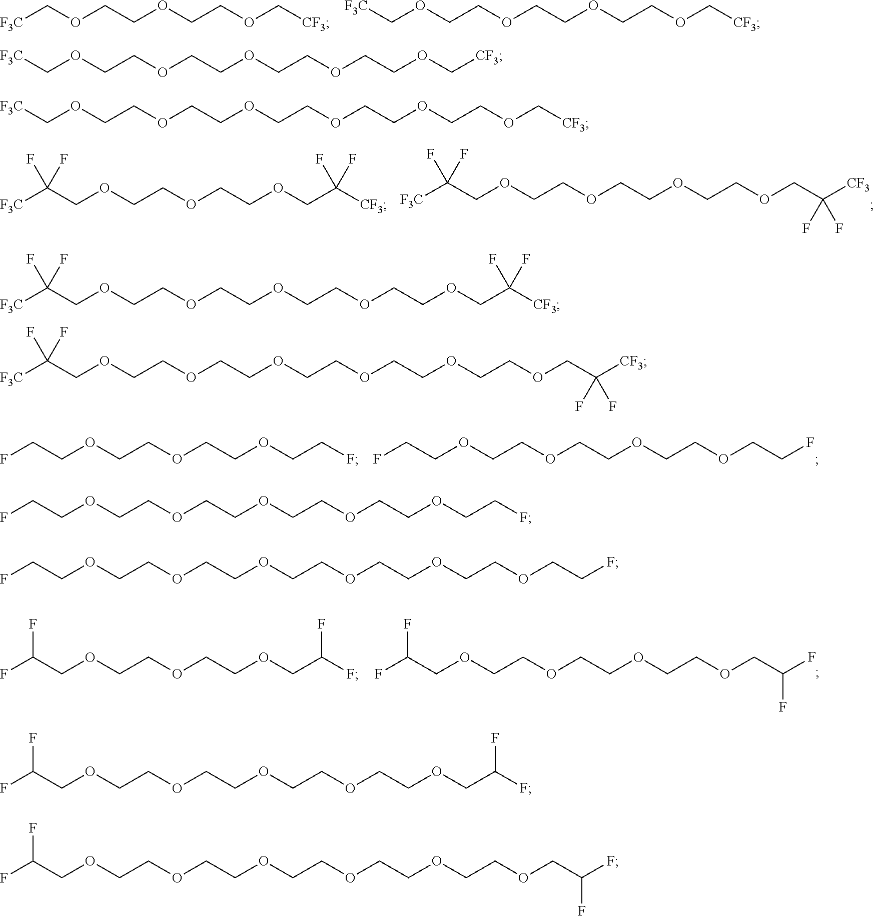

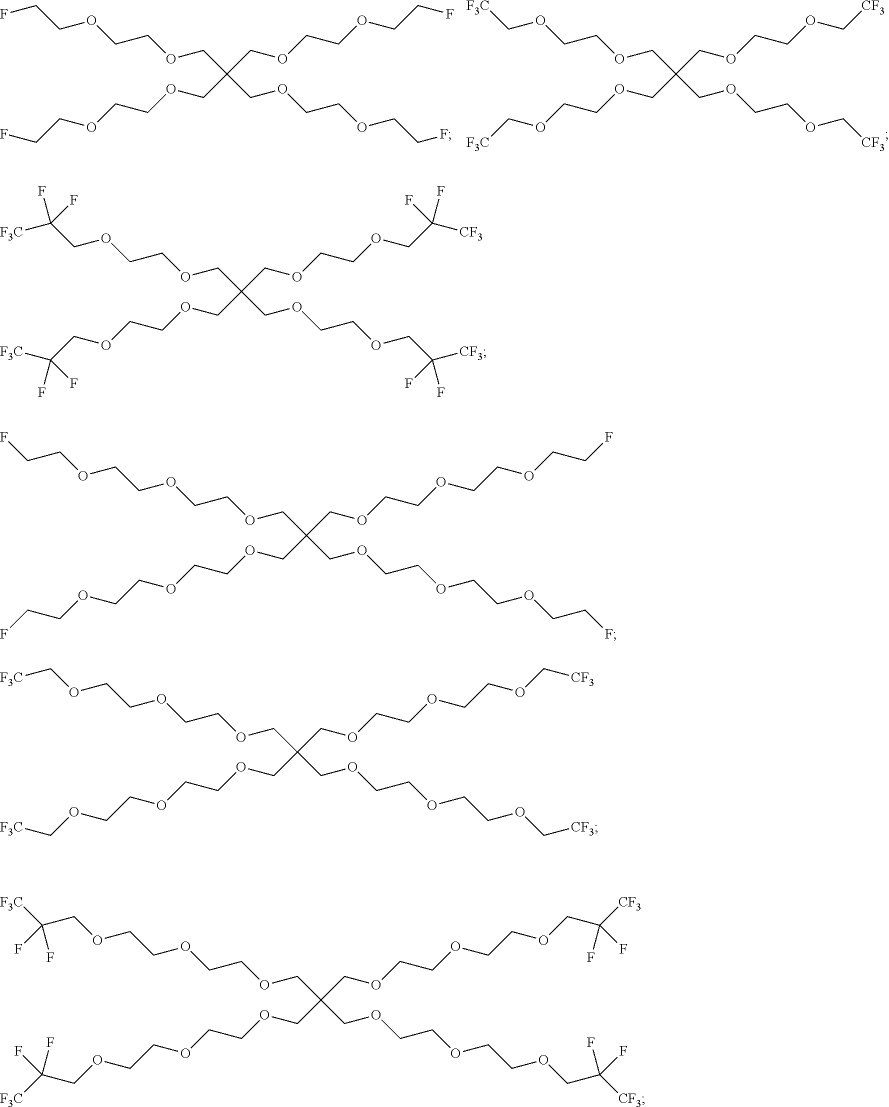

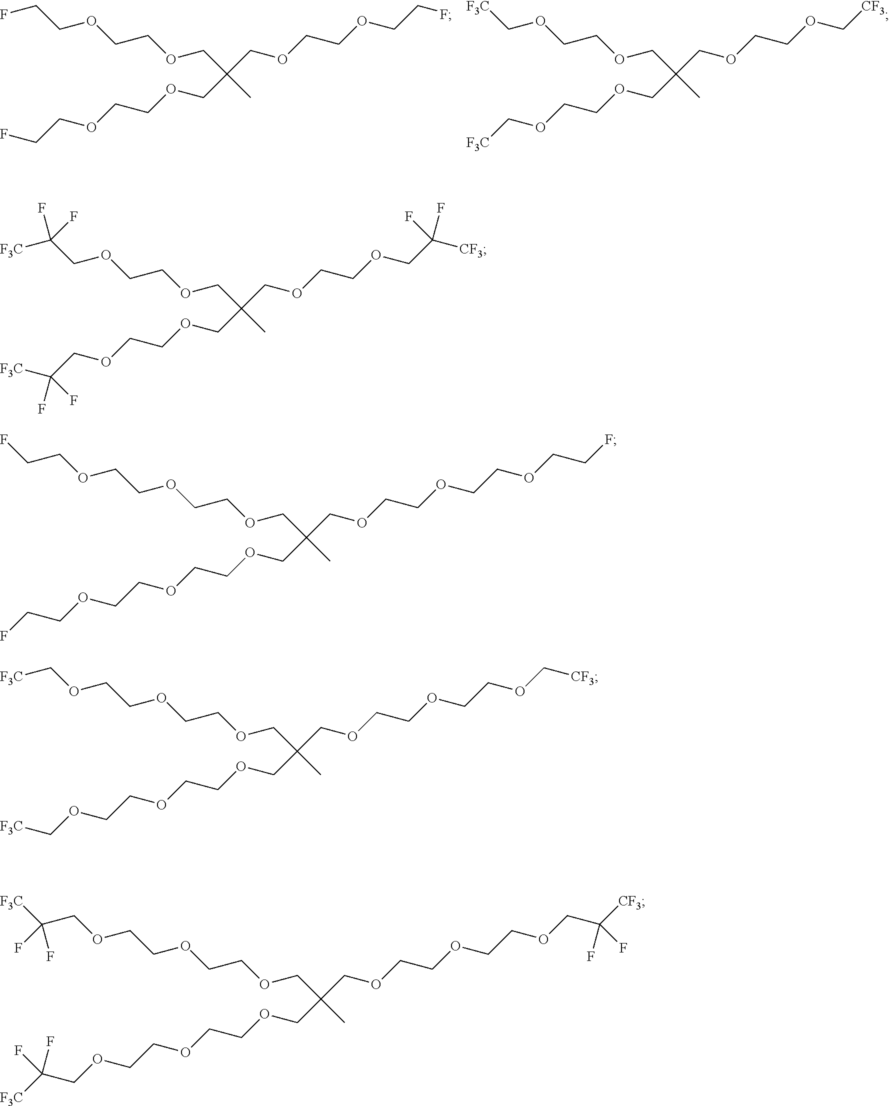

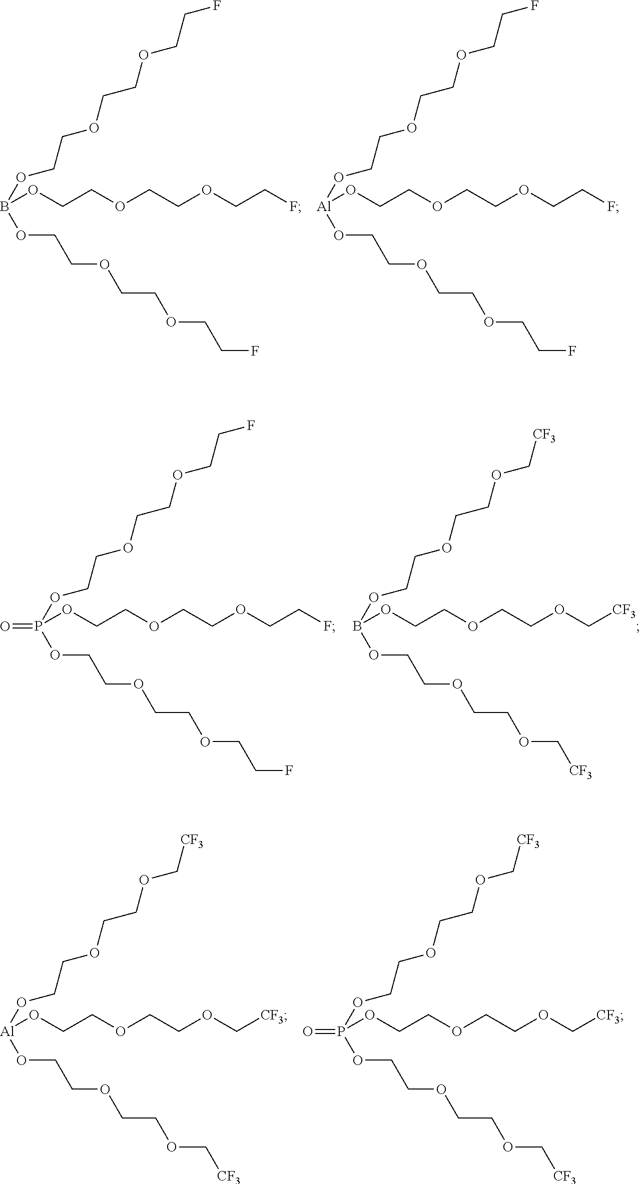

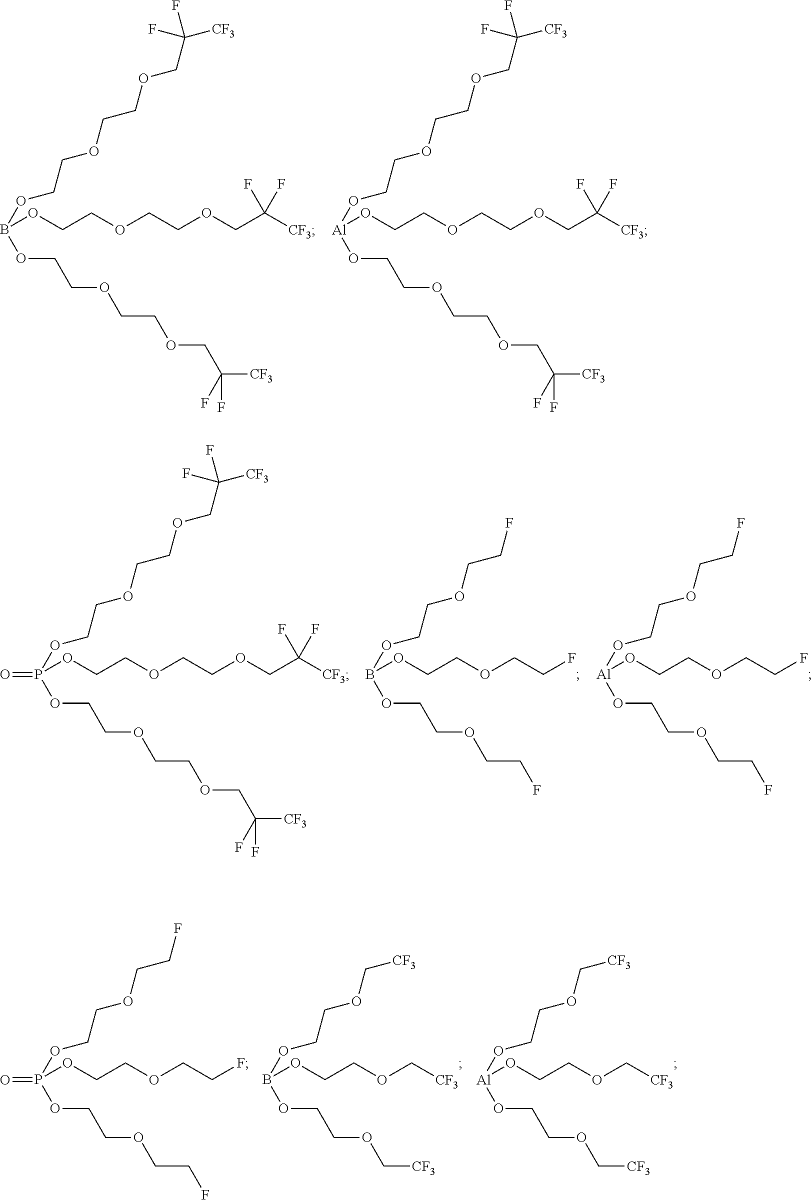

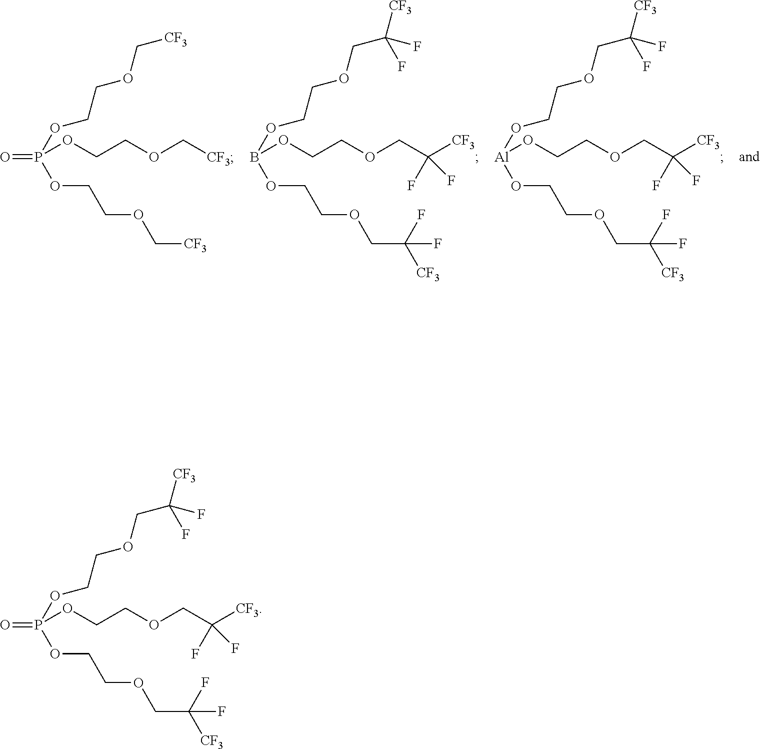

A lithium salt may be dissolved in the fluoroether electrolyte. During cycling, the lithium-ion cell may be configured to promote lithium intercalation and (de)intercalation within graphite without fluoroether co-intercalation. The lithium salt may be selected from the group consisting of LiFSA, LiTFSI, LiOTf, LiNO₃, LiPF₆, LiBOB, LiDFOB, LiBF₄, and LiClO₄. The molarity of the lithium salt in the fluoroether electrolyte may be from about 0.1 M to about 5.0 M. During cycling, the lithium-ion cell may be configured to retain at least 80% capacity between a temperature range of from about −20° C. to about 60° C. The lithium-ion cell may be configured to maintain a first-cycle coulombic efficiency of at least 85%. The lithium-ion cell may be configured to produce graphite intercalation compounds. A plurality of the lithium-ion cells may be connected in series or in parallel.

In yet another example, the present disclosure provides a composition including a compound of formula (III):

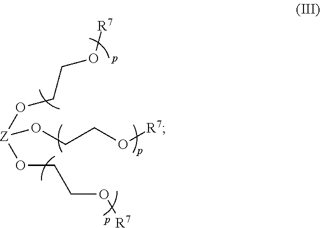

wherein each R⁷ is a fluoro-substituted C₂-C₆ alkyl group; Z is B, Al, or P═O; and p is 0, 1, 2, 3, 4, or 5.

In yet another example, the present disclosure provides a composition including a compound selected from the group consisting of:

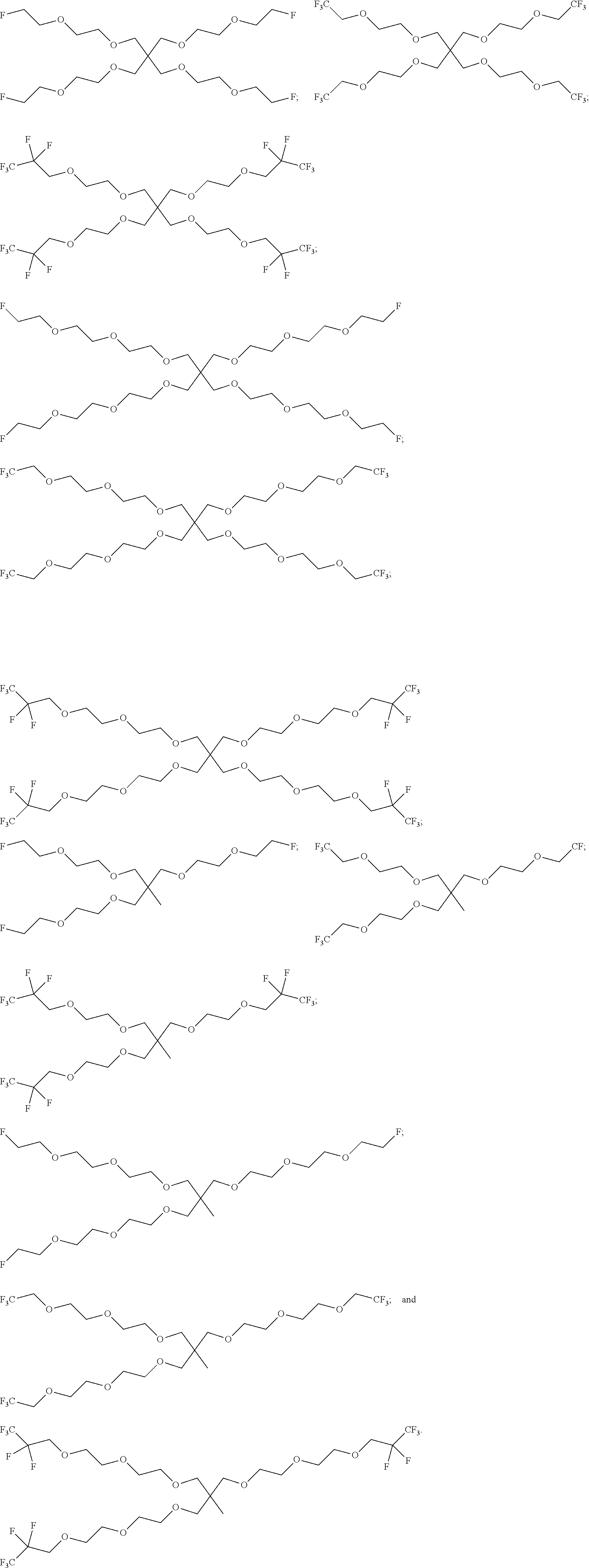

Further areas of applicability will become apparent from the description provided herein. It should be understood that the description and specific examples are intended for purposes of illustration only and are not intended to limit the scope of the present disclosure.

### DRAWINGS

In order that the present disclosure may be well understood, there will now be described various forms thereof, given by way of example, reference being made to the accompanying drawings. The components in the figures are not necessarily to scale.

FIG. 1 illustrates a cyclic voltammetry plot for lithium graphite (“Li/Gr”) cells using 1 M LiFSA in E3F1, 1 M LiFSA in diglyme, and 1 M LiPF₆ in EC/DMC as electrolytes, at a scan rate of 0.05 mV s⁻¹ from open circuit voltage to 0.01 V and then reverse-scanned to 2.5 V;

FIG. 2 illustrates a voltage profile for the first galvanostatic cycle of Li/Gr cells at a current rate of C/21 (1C ˜2.17 mA cm⁻²), using 1 M LiFSA in E3F1, 1 M LiFSA in diglyme, and 1 M LiPF₆ in EC/DMC;

FIG. 3 illustrates a voltage profile for Li/Gr cells using 1 M LiFSA in E4F1, 1 M LiFSA in E5F1, and 0.5 M LiFSA in E3F1;

FIG. 4 illustrates a first-order derivative of a first lithiation curve in a Li/Gr cell using 1 M LiSA in E3F1, with an inset including a zoomed-in view of differential curves of both first and second lithiations for comparison;

FIG. 5 illustrates a first-order derivative of a first lithiation curve in a Li/Gr cell using 1 M LiPF₆ in EC/DMC, with an inset including a zoomed-in view of differential curves of both first and second lithiations for comparison;

FIG. 6 illustrates a first-order derivative of a first lithiation curve in a Li/Gr cell using 1 M LiFSA in diglyme, with an inset including a zoomed-in view of differential curves of both first and second lithiations for comparison;

FIG. 7 illustrates the evolution of discharge capacity and Coulombic efficiency with cycle number, the cycles cycled at a current rate of C/3 after three formation cycles at C/20, and illustrates two replicate cells of each test;

FIG. 8 illustrates the evolution of discharge capacity and Coulombic efficiency with cycle number;

FIG. 9 illustrates XRD patterns of lithiated graphite with pristine graphite as control for graphite electrodes lithiated in 1 M LiFSA in E3F1 (“E3F1”), 1 M LiFSA in E4F1 (“E4F1”), 1 M LiPF₆ in EC/DMC (“EC/DMC”), and 1 M LiFSA in diglyme (“diglyme”) electrolytes, with an inset illustrating zoomed-in views of the region from 2θ=20°−30° (lithiated graphite samples prepared in Li/Gr cells by charging at a constant current of C/20 to 0.01 V or 20 hours with graphite as the working electrode and lithium metal as counter electrode);

FIG. 10 illustrates Raman spectra of graphite electrodes lithiated in 1 M LiFSA in E3F1, 1 M LiFSA in E4F1, 1 M LiPF₆ in EC/DMC, and 1 M LiFSA in diglyme electrolytes, with pristine graphite as control;

FIG. 11 illustrates ⁷Li solid-state magic-angle spinning (“MAS”) NMR spectra of graphite lithiated in 1 M LiFSA in E3F1, 1 M LiFSA in E4F1, 1 M LiPF₆ in EC/DMC, and 1 M LiFSA in diglyme electrolytes (NMR spectra intensity and peak integrations normalized by number of scan and sample mass);

FIG. 12 illustrates ¹H solid-state MAS NMR spectra of graphite lithiated in 1 M LiFSA in E3F1, 1 M LiFSA in E4F1, 1 M LiPF₆ in EC/DMC, and 1 M LiFSA in diglyme electrolytes, with an inset illustrating spectra magnified by 30x;

FIG. 13 illustrates ¹H NMR peak integrations for the ¹H NMR spectra illustrated in FIG. 12;

FIG. 14 illustrates a time-aligned XRD pattern and voltage profile of a Li/Gr cell using 1 M LiFSA in E3F1 electrolyte cycled at a current rate of C/10;

FIG. 15 illustrates a time-aligned XRD pattern and voltage profile of a Li/Gr cell using 1 M LiFSA in diglyme electrolyte cycled at a current rate of C/10;

FIG. 16 illustrates evolution of graphene interlayer distance when graphite is lithiated in E3F1 electrolyte;

FIG. 17 illustrates a zoomed-in view of XRD patterns at selected points of cycling, marked by black dots in FIG. 14);

FIG. 18 illustrates a zoomed-in view of XRD patterns at selected points of cycling, marked by black dots in FIG. 15);

FIG. 19 illustrates X-ray photoelectron spectroscopy (“XPS”) of graphite electrodes retrieved from corresponding Gr/LFP cells after formation cycles, ending on deintercalation, specifically C is spectra;

FIG. 20 illustrates XPS O is spectra for graphite electrodes retrieved from corresponding Gr/LFP cells after formation cycles, ending on deintercalation;

FIG. 21 illustrates XPS F is spectra for graphite electrodes retrieved from corresponding Gr/LFP cells after formation cycles, ending on deintercalation;

FIG. 22 illustrates XPS F is spectra for graphite electrodes retrieved from corresponding Gr/LFP cells after formation cycles (ending on deintercalation) with pristine graphite as control;

FIG. 23 illustrates XPS F is spectra of graphite electrodes retrieved from corresponding Gr/LFP cells after formation cycles (ending on deintercalation) with pristine graphite as control;

FIG. 24 illustrates DFT-optimized structures of E3F1 molecule in neutral and different reduced states;

FIG. 25 illustrates a comparison of ether electrolytes for lithium-ion batteries;

FIG. 26 illustrates a ¹H NMR spectrum of E3F1;

FIG. 27 illustrates a ¹³C NMR spectrum of E3F1;

FIG. 28 illustrates a ¹⁹F NMR spectrum of E3F1;

FIG. 29 illustrates a ¹H NMR spectrum of 1,14-difluoro-3,6,9,12-tetraoxatetradecane;

FIG. 30 illustrates a ¹³C NMR spectrum of 1,14-difluoro-3,6,9,12-tetraoxatetradecane;

FIG. 31 illustrates a ¹⁹F NMR spectrum of 1,14-difluoro-3,6,9,12-tetraoxatetradecane;

FIG. 32 illustrates a ¹H NMR spectrum of tris(2-(2,2,2-trifluoroethoxy)ethyl) borate;

FIG. 33 illustrates a ¹³C NMR spectrum of tris(2-(2,2,2-trifluoroethoxy)ethyl) borate;

FIG. 34 illustrates a ¹⁹F NMR spectrum of tris(2-(2,2,2-trifluoroethoxy)ethyl) borate;

FIG. 35 illustrates a ¹¹B NMR spectrum of tris(2-(2,2,2-trifluoroethoxy)ethyl) borate;

FIG. 36 illustrates a voltage-capacity plot for a Li/Gr cell using 1 M LiFSA in 1,14-difluoro-3,6,9,12-tetraoxatetradecane;

FIG. 37 illustrates an X-ray powder diffraction pattern of a graphite electrode lithiated in 1 M LiFSA in 1,14-difluoro-3,6,9,12-tetraoxatetradecane;

FIG. 38 illustrates the evolution of discharge with cycle number for a Li/Gr half cell using 1 M LiFSA in 1,14-difluoro-3,6,9,12-tetraoxatetradecane; and

FIG. 39 illustrates the evolution of discharge with cycle number for a Gr/LFP full cell using 1 M LiFSA in 1,14-difluoro-3,6,9,12-tetraoxatetradecane.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and other not expressed as an approximation. It will be further understood that an endpoint of each range is significant both in relation to another endpoint, and independently of another endpoint.

The uses of the terms “a” and “an” and “the” and similar referents in the context of describing the present disclosure (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

As used herein, the terms “comprise(s),” “include(s),” “having,” “has,” “can,” “contain(s),” and variants thereof, are intended to be open-ended transitional phrases, terms, or words that do not preclude the possibility of additional acts, structures, elements, or components. The present description also contemplates other embodiments “comprising,” “consisting of,” and “consisting essentially of” the examples or elements presented herein, whether explicitly set forth or not.

As used herein, the term “about,” when used in the context of a numerical value or range set forth means a variation of ±15%, or less, of the numerical value. For example, a value differing by ±15%, ±14%, ±10%, or ±5%, among others, would satisfy the definition of “about,” unless more narrowly defined in particular instances.

As used herein, the term “alkyl,” by itself or as part of another substituent, means, unless otherwise stated, a straight, branched, or cyclic chain hydrocarbon (“cycloalkyl”) having the number of carbon atoms designated (i.e., “C₁-C₆” means one to six carbons). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl.

As used herein, the term “intercalation” refers to the reversible inclusion or insertion of a chemical species in-between layers of a material with layered structures, such as graphite.

The terms “solvent intercalation,” “solvent co-intercalation,” “electrolyte intercalation,” and “electrolyte co-intercalation” refer to the inclusion or insertion of a chemical species participating in a chemical reaction as a solvent and/or an electrolyte in-between layers of a material with layered structures.

As used herein, the term “fluoro-substituted” means the substitution of one, more than one, or all hydrogens in a hydrocarbon or a monovalent hydrocarbon substituent with monovalent fluorine atoms.

In an example, a fluoroether electrolyte of the present disclosure may include one or more compounds of formula (I):

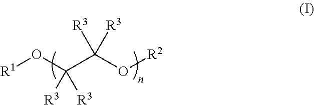

wherein R¹ is a fluoro-substituted C₂-C₆ alkyl group;
R² is a C₂-C₆ alkyl group or a fluoro-substituted C₂-C₆ alkyl group;
each R³ independently is H, F, methyl, or fluoro-substituted methyl; and
n is 0, 1, 2, 3, 4, or 5.

In another example, R² is a C₂ alkyl group, or a C₃ alkyl group, or a C₄ alkyl group, or a C₅ alkyl group, or a C₆ alkyl group.

In yet another example, R² is a fluoro-substituted C₂ alkyl group, or a fluoro-substituted C₃ alkyl group, or a fluoro-substituted C₄ alkyl group, or a fluoro-substituted C₅ alkyl group, or a fluoro-substituted C₆ alkyl group.

In yet another example, each R³ is hydrogen.

In yet another example, each R³ is fluorine.

Examples of compounds of formula (I) may include 1,1,1-trifluoro-2-(2-(2-(2,2,2-trifluoroethoxy)ethoxy)ethoxy)ethane (“E3F1”), 1,1,1,14,14,14-hexafluoro-3,6,9,12-tetraoxatetradecane (“E4F1”), 1,1,1,17,17,17-hexafluoro-3,6,9,12,15-pentaoxaheptadecane (“E5F1”), 1,1,1,20,20,20-hexafluoro-3,6,9,12,15,18-hexaoxaicosane (“E6F1”), 1,1,1,2,2-pentafluoro-3-(2-(2-(2,2,3,3,3-pentafluoropropoxy)ethoxy)ethoxy)propane (“E3F2”), 1,1,1,2,2,15,15,16,16,16-decafluoro-4,7,10,13-tetraoxahexadecane (“E4F2”), 1,1,1,2,2,18,18,19,19,19-decafluoro-4,7,10,13,16-pentaoxanonadecane (“E5F2”), 1,1,1,2,2,21,21,22,22,22-decafluoro-4,7,10,13,16,19-hexaoxadocosane (“E6F2”), 1-fluoro-2-(2-(2-(2-fluoroethoxy)ethoxy)ethoxy)ethane, 1,14-difluoro-3,6,9,12-tetraoxtetradecane, 1,17-difluoro-3,6,9,12,15-pentaoxaheptadecane, 1,20-difluoro-3,6,9,12,15,18-hexaoxaicosane, 2-(2-(2-(2,2-difluoroethoxy)ethoxy)ethoxy)-1,1-difluoroethane, 1,1,14,14-tetrafluoro-3,6,9,12-tetraoxatetradecane, 1,1,17,17-tetrafluoro-3,6,9,12,15-pentaoxaheptadecane, and/or 1,1,20,20-tetrafluoro-3,6,9,12,15,18-hexaoxaicosane.

The systematic chemical name 1,1,1-trifluoro-2-(2-(2-(2,2,2-trifluoroethoxy)ethoxy)ethoxy)ethane, abbreviated herein as “E3F1,” corresponds to a compound with a structural formula of:

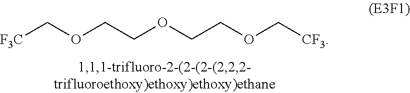 [SMILES: FC(F)(F)COCCOCCOCC(F)(F)F]

The systematic chemical name 1,1,1,14,14,14-hexafluoro-3,6,9,12-tetraoxatetradecane, abbreviated herein as “E4F1,” corresponds to a compound with a structural formula of:

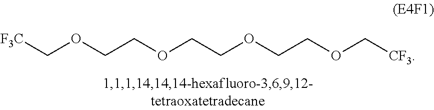 [SMILES: FC(F)(F)COCCOCCOCCOCC(F)(F)F]

The systematic chemical name 1,1,1,17,17,17-hexafluoro-3,6,9,12,15-pentaoxaheptadecane, abbreviated herein as “E5F1,” corresponds to a compound with a structural formula of:

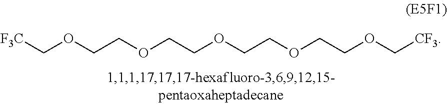 [SMILES: FC(F)(F)COCCOCCOCCOCCOCC(F)(F)F]

The systematic chemical name 1,1,1,20,20,20-hexafluoro-3,6,9,12,15,18-hexaoxaicosane, abbreviated herein as “E6F1,” corresponds to a compound with a structural formula of:

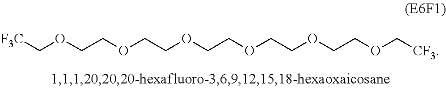 [SMILES: FC(F)(F)COCCOCCOCCOCCOCCOCC(F)(F)F]

The systematic chemical name 1,1,1,2,2-pentafluoro-3-(2-(2-(2,2,3,3,3-pentafluoropropoxy)ethoxy)ethoxy)propane, abbreviated herein as “E3F2,” corresponds to a compound with a structural formula of:

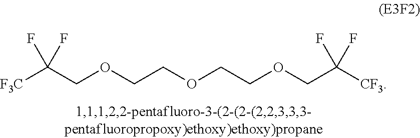 [SMILES: FC(F)(F)C(F)(F)COCCOCCOCC(F)(F)C(F)(F)F]

The systematic chemical name 1,1,1,2,2,15,15,16,16,16-decafluoro-4,7,10,13-tetraoxahexadecane, abbreviated herein as “E4F2,” corresponds to a compound with a structural formula of:

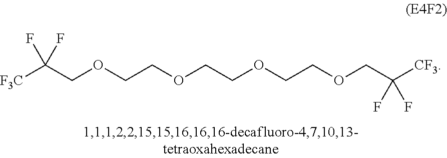 [SMILES: FC(F)(F)C(F)(F)COCCOCCOCCOCC(F)(F)C(F)(F)F]

The systematic chemical name 1,1,1,2,2,18,18,19,19,19-decafluoro-4,7,10,13,16-pentaoxanonadecane, abbreviated herein as “E5F2,” corresponds to a compound with a structural formula of:

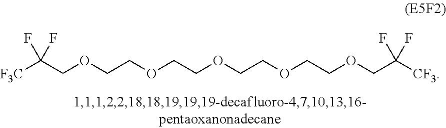 [SMILES: FC(F)(F)C(F)(F)COCCOCCOCCOCCOCC(F)(F)C(F)(F)F]

The systematic chemical name 1,1,1,2,2,21,21,22,22,22-decafluoro-4,7,10,13,16,19-hexaoxadocosane, abbreviated herein as “E6F2,” corresponds to a compound with a structural formula of:

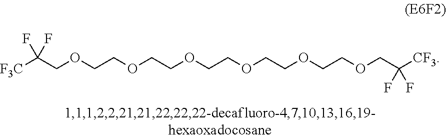 [SMILES: FC(F)(F)C(F)(F)COCCOCCOCCOCCOCCOCC(F)(F)C(F)(F)F]

The systematic chemical name 1-fluoro-2-(2-(2-(2-fluoroethoxy)ethoxy)ethoxy)ethane corresponds to a compound with a structural formula of:

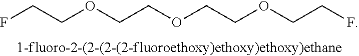 [SMILES: FCCOCCOCCOCCF]

The systematic chemical name 1,14-difluoro-3,6,9,12-tetraoxatetradecane corresponds to a compound with a structural formula of:

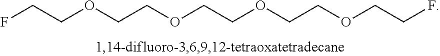 [SMILES: FCCOCCOCCOCCOCCF]

The systematic chemical name 1,17-difluoro-3,6,9,12,15-pentaoxaheptadecane corresponds to a compound with a structural formula of:

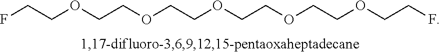 [SMILES: FCCOCCOCCOCCOCCOCCF]

The systematic chemical name 1,20-difluoro-3,6,9,12,15,18-hexaoxaicosane corresponds to a compound with a structural formula of:

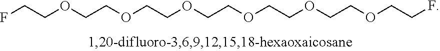 [SMILES: FCCOCCOCCOCCOCCOCCOCCF]

The systematic chemical name 2-(2-(2-(2,2-difluoroethoxy)ethoxy)ethoxy)-1,1-difluoroethane corresponds to a compound with a structural formula of:

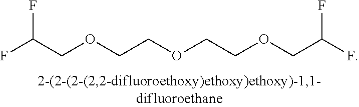 [SMILES: FC(F)COCCOCCOCC(F)F]

The systematic chemical name 1,1,14,14-tetrafluoro-3,6,9,12-tetraoxatetradecane corresponds to a compound with a structural formula of:

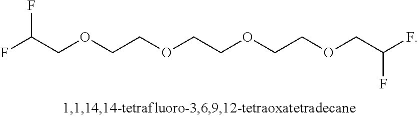 [SMILES: FC(F)COCCOCCOCCOCC(F)F]

The systematic chemical name 1,1,17,17-tetrafluoro-3,6,9,12,15-pentaoxaheptadecane corresponds to a compound with a structural formula of:

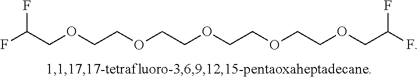 [SMILES: FC(F)COCCOCCOCCOCCOCC(F)F]

The systematic chemical name 1,1,20,20-tetrafluoro-3,6,9,12,15,18-heaxaoxaicosane corresponds to a compound with a structural formula of:

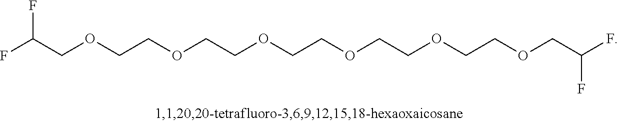 [SMILES: FC(F)COCCOCCOCCOCCOCCOCC(F)F]

In yet another example, a fluoroether electrolyte of the present disclosure may include one or more compounds of formula (II):

R⁵—C(R⁴)₃ (II)
wherein each R⁴ is —CH₂—(OCH₂CH₂)ₘ—OR⁶;
R⁵ is methyl or R⁴.
R⁶ is a fluoro-substituted C₂-C₆ alkyl group; and
m is 0, 1, 2, 3, 4, or 5.

In yet another example, R⁶ is a fluoro-substituted C₂ alkyl group, or R⁶ is a fluoro-substituted C₃ alkyl group, or R⁶ is a fluoro-substituted C₄ alkyl group, or R⁶ is a fluoro-substituted C₅ alkyl group, or R⁶ is a fluoro-substituted C₆ alkyl group.

Examples of compounds of formula (II) may include 1,15-difluoro-8,8-bis((2-(2-fluoroethoxy)ethoxy)methyl)-3,6,10,13-tetraoxapentadecane, 1,1,1,15,15,15-hexafluoro-8,8-bis((2-(2,2,2-trifluoroethoxy)ethoxy)methyl)-3,6,10,13-tetraoxapentadecane, 1,1,1,2,2,16,16,17,17,17-decafluoro-9,9-bis((2-(2,2,3,3,3-pentafluoropropoxy)ethoxy)methyl)-4,7,11,14-tetraoxaheptadecane, 1,21-difluoro-11,11-bis((2-(2-(2-fluoroethoxy)ethoxy)ethoxy)methyl)-3,6,9,13,16,19-hexaoxahenicosane, 1,1,1,21,21,21-hexafluoro-11,11-bis((2-(2-(2,2,2-trifluoroethoxy)ethoxy)ethoxy)methyl)-3,6,9,13,16,19-hexaoxahenicosane, 1,1,1,2,2,22,22,23,23,23-decafluoro-12,12-bis((2-(2-(2,2,3,3,3-pentafluoropropoxy)ethoxy)ethoxy)methyl)-4,7,10,14,17,20-hexaoxatricosane, 1,5-difluoro-8-((2-(2-fluoroethoxy)ethoxy)methyl)-8-methyl-3,6,10,13-tetraoxapentadecane, 1,1,1,15,15,15-hexafluoro-8-methyl-8-((2-(2,2,2-trifluoroethoxy)ethoxy)methyl)-3,6,10,13-tetraoxapentadecane, 1,1,1,2,2,16,16,17,17,17-decafluoro-9-methyl-9-((2-(2,2,3,3,3-pentafluoropropoxy)ethoxy)methyl)-4,7,11,14-tetraoxaheptadecane, 1,21-difluoro-11-((2-(2-(2-fluoroethoxy)ethoxy)ethoxy)methyl)-11-methyl-3,6,9,13,16,19-hexaoxahenicosane, 1,1,1,21,21,21-hexafluoro-11-methyl-11-((2-(2-(2,2,2-trifluoroethoxy)ethoxy)ethoxy)methyl)-3,6,9,13,16,19-hexaoxahenicosane, and/or 1,1,1,2,2,22,22,23,23,23-decafluoro-12-methyl-12-((2-(2-(2,2,3,3,3-pentafluoropropoxy)ethoxy)ethoxy)methyl)-4,7,10,14,17,20-hexaoxatricosane.

The systematic chemical name 1,15-difluoro-8,8-bis((2-(2-fluoroethoxy)ethoxy)methyl)-3,6,10,13-tetraoxapentadecane corresponds to a compound with a structural formula of:

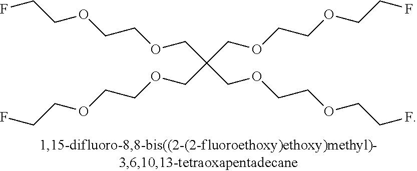 [SMILES: FCCOCCOCC(COCCOCCF)(COCCOCCF)COCCOCCF]

The systematic chemical name 1,1,1,15,15,15-hexafluoro-8,8-bis((2-(2,2,2-trifluoroethoxy)ethoxy)methyl)-3,6,10,13-tetraoxapentadecane corresponds to a compound with a structural formula of:

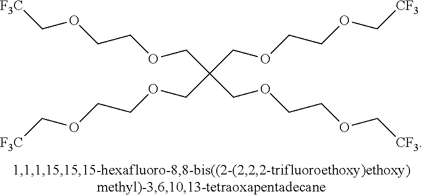 [SMILES: FC(F)(F)COCCOCC(COCCOCC(F)(F)F)(COCCOCC(F)(F)F)COCCOCC(F)(F)F]

The systematic chemical name 1,1,1,2,2,16,16,17,17,17-decafluoro-9,9-bis((2-(2,2,3,3,3-pentafluoropropoxy)ethoxy)methyl)-4,7,11,14-tetraoxaheptadecane corresponds to a compound with a structural formula of:

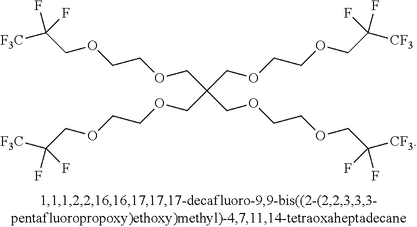 [SMILES: FC(F)(F)C(F)(F)COCCOCC(COCCOCC(F)(F)C(F)(F)F)(COCCOCC(F)(F)C(F)(F)F)COCCOCC(F)(F)C(F)(F)F]

The systematic chemical name 1,21-difluoro-11,11-bis((2-(2-(2-fluoroethoxy)ethoxy)ethoxy)methyl)-3,6,9,13,16,19-hexaoxahenicosane corresponds to a compound with a structural formula of:

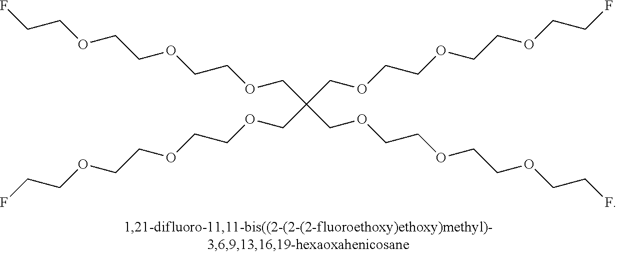 [SMILES: FCCOCCOCCOCC(COCCOCCOCCF)(COCCOCCOCCF)COCCOCCOCCF]

The systematic chemical name 1,1,1,21,21,21-hexafluoro-11,11-bis((2-(2-(2,2,2-trifluoroethoxy)ethoxy)ethoxy)methyl)-3,6,9,13,16,19-hexaoxahenicosane corresponds to a compound with a structural formula of:

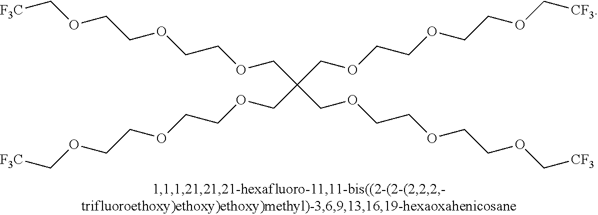 [SMILES: FC(F)(F)COCCOCCOCC(COCCOCCOCC(F)(F)F)(COCCOCCOCC(F)(F)F)COCCOCCOCC(F)(F)F]

The systematic chemical name 1,1,1,2,2,22,22,23,23,23-decafluoro-12,12-bis((2-(2-(2,2,3,3,3-pentafluoropropoxy)ethoxy)ethoxy)methyl)-4,7,10,14,17,20-hexaoxatricosane corresponds to a compound with a structural formula of:

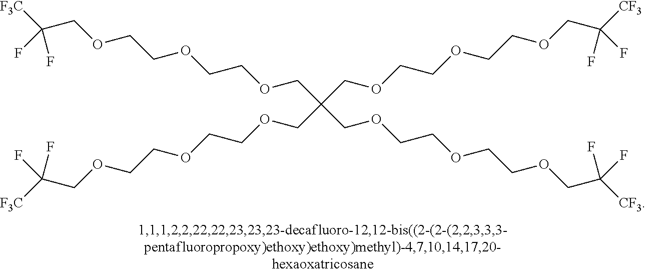 [SMILES: FC(F)(F)C(F)(F)COCCOCCOCC(COCCOCCOCC(F)(F)C(F)(F)F)(COCCOCCOCC(F)(F)C(F)(F)F)COCCOCCOCC(F)(F)C(F)(F)F]

The systematic chemical name 1,15-difluoro-8-((2-(2-fluoroethoxy)ethoxy)methyl)-8-methyl-3,6,10,13-tetraoxapentadecane corresponds to a compound with a structural formula of:

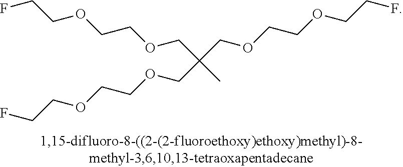 [SMILES: CC(COCCOCCF)(COCCOCCF)COCCOCCF]

Compounds of formula (II) wherein R⁵ is methyl may be prepared by nucleophilic substitution of an appropriate tribromide with a protected sodium alkoxide. See Kai Li, et al., Synthesis and Characterization of Pentaerythritol-Derived Oligoglycol and Their Application to Catalytic Wittig-Type Reactions, 60 J. ORGANIC CHEMISTRY 3986 (2004), incorporated by reference herein in its entirety.

The systematic chemical name 1,1,1,15,15,15-hexafluoro-8-methyl-8-((2-(2,2,2-trifluoroethoxy)ethoxy)methyl)-3,6,10,13-tetraoxapentadecane corresponds to a compound with a structural formula of:

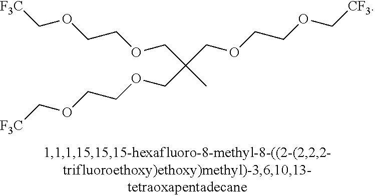 [SMILES: CC(COCCOCC(F)(F)F)(COCCOCC(F)(F)F)COCCOCC(F)(F)F]

The systematic chemical name 1,1,1,2,2,16,16,17,17,17-decafluoro-9-methyl-9-((2-(2,2,3,3,3-pentafluoropropoxy)ethoxy)methyl)-4,7,11,14-tetraoxaheptadecane corresponds to a compound with a structural formula of:

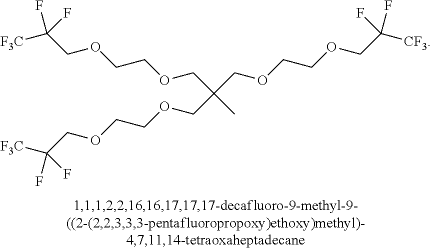 [SMILES: CC(COCCOCC(F)(F)C(F)(F)F)(COCCOCC(F)(F)C(F)(F)F)COCCOCC(F)(F)C(F)(F)F]

The systematic chemical name 1,21-difluoro-11-((2-(2-(2-fluoroethoxy)ethoxy)ethoxy)methyl)-11-methyl-3,6,9,13,16,19-hexaoxahenicosane corresponds to a compound with a structural formula of:

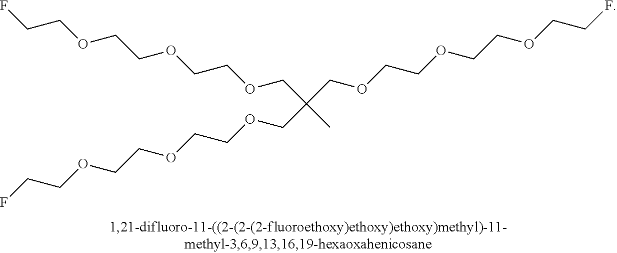 [SMILES: CC(COCCOCCOCCF)(COCCOCCOCCF)COCCOCCOCCF]

The systematic chemical name 1,1,1,21,21,21-hexafluoro-11-methyl-11-((2-(2-(2,2,2-trifluoroethoxy)ethoxy)ethoxy)methyl)-3,6,9,13,16,19-hexaoxahenicosane corresponds to a compound with a structural formula of:

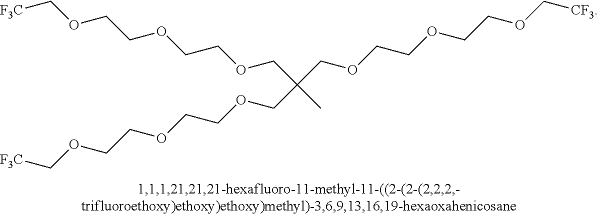 [SMILES: CC(COCCOCCOCC(F)(F)F)(COCCOCCOCC(F)(F)F)COCCOCCOCC(F)(F)F]

The systematic chemical name 1,1,1,2,2,22,22,23,23,23-decafluoro-12-methyl-12-((2-(2-(2,2,3,3,3-pentafluoropropoxy)ethoxy)ethoxy)methyl)-4,7,10,14,17,20-hexaoxatricosane corresponds to a compound with a structural formula of:

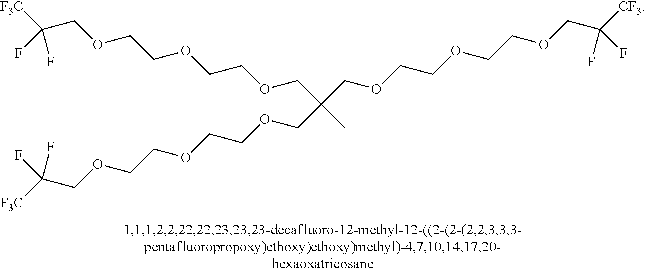 [SMILES: CC(COCCOCCOCC(F)(F)C(F)(F)F)(COCCOCCOCC(F)(F)C(F)(F)F)COCCOCCOCC(F)(F)C(F)(F)F]

In yet another example, a fluoroether electrolyte of the present disclosure may include one or more compounds of formula (III):

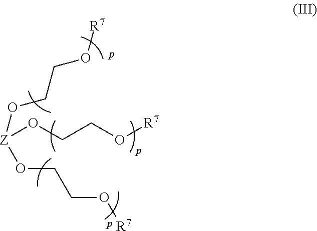

wherein each R⁷ is a fluoro-substituted C₂-C₆ alkyl group;
Z is B, Al, or P═O; and
p is 0, 1, 2, 3, 4, or 5.

In yet another example, each R⁷ is a fluoro-substituted C₂ alkyl group, or a fluoro-substituted C₃ alkyl group, or a fluoro-substituted C₄ alkyl group, or a fluoro-substituted C₅ alkyl group, or a fluoro-substituted C₆ alkyl group.

Examples of compounds of formula (III) may include tris(2-(2-(2-fluoroethoxy)ethoxy)ethyl) borate, tris(2-(2-(2-fluoroethoxy)ethoxy)ethoxy)aluminum, tris(2-(2-(2-fluoroethoxy)ethoxy)ethyl) phosphate, tris(2-(2-(2,2,2-trifluoroethoxy)ethoxy)ethyl) borate, tris(2-(2-(2,2,2-trifluoroethoxy)ethoxy)ethoxy)aluminum, tris(2-(2-(2,2,2-trifluoroethoxy)ethoxy)ethyl) phosphate, tris(2-(2-(2,2,3,3,3-pentafluoropropoxy)ethoxy)ethyl) borate, tris(2-(2-(2,2,3,3,3-pentafluoropropoxy)ethoxy)ethoxy)aluminum, tris(2-(2-(2,2,3,3,3-pentafluoropropoxy)ethoxy)ethyl) phosphate, tris(2-(2-fluoroethoxy)ethyl) borate, tris(2-(2-fluoroethoxy)ethoxy)aluminum, tris(2-(2-fluoroethoxy)ethyl) phosphate, tris(2-(2,2,2-trifluoroethoxy)ethyl) borate, tris(2-(2,2,2-trifluoroethoxy)ethoxy)aluminum, tris(2-(2,2,2-trifluoroethoxy)ethyl) phosphate, tris(2-(2,2,3,3,3-pentafluoropropoxy)ethyl) borate, tris(2-(2,2,3,3,3-pentafluoropropoxy)ethoxy)aluminum, and/or tris(2-(2,2,3,3,3-pentafluoropropoxy)ethyl) phosphate.

The systematic chemical name tris(2-(2-(2-fluoroethoxy)ethoxy)ethyl) borate corresponds to a compound with a structural formula of:

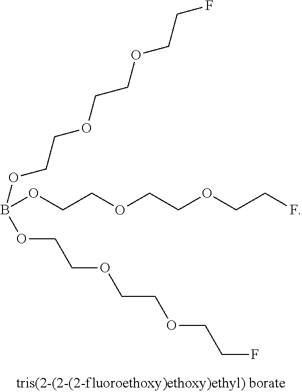 [SMILES: FCCOCCOCCOB(OCCOCCOCCF)OCCOCCOCCF]

The systematic chemical name tris (2- (2-(2-fluoroethoxy)ethoxy)ethoxy) aluminum corresponds to a compound with a structural formula of:

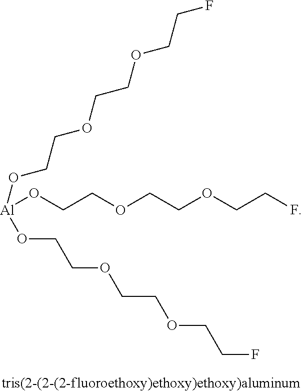

The systematic chemical name tris(2-(2-(2-fluoroethoxy)ethoxy)ethyl) phosphate corresponds to a compound with a structural formula of:

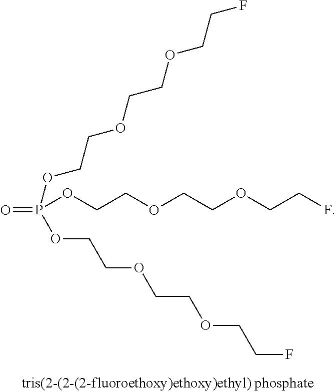 [SMILES: O=P(OCCOCCOCCF)(OCCOCCOCCF)OCCOCCOCCF]

The systematic chemical name tris(2-(2-(2,2,2-trifluoroethoxy)ethoxy)ethyl) borate corresponds to a compound with a structural formula of:

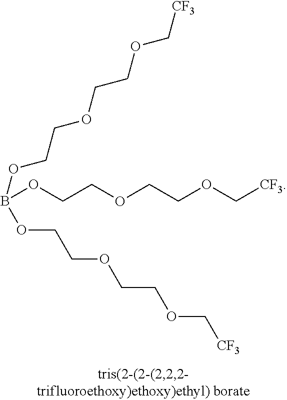 [SMILES: FC(F)(F)COCCOCCOB(OCCOCCOCC(F)(F)F)OCCOCCOCC(F)(F)F]

The systematic chemical name tris(2-(2-(2,2,2-trifluoroethoxy)ethoxy)ethoxy)aluminum corresponds to a compound with a structural formula of:

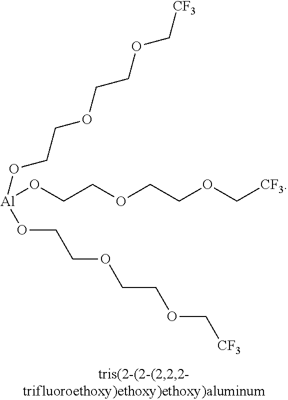

The systematic chemical name tris(2-(2-(2,2,2-trifluoroethoxy)ethoxy)ethyl) phosphate corresponds to a compound with a structural formula of:

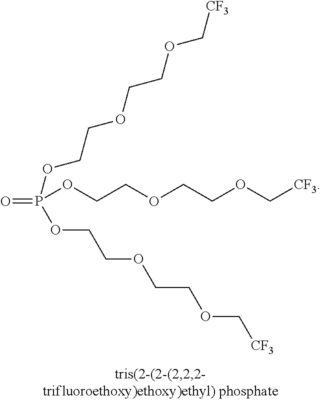 [SMILES: O=P(OCCOCCOCC(F)(F)F)(OCCOCCOCC(F)(F)F)OCCOCCOCC(F)(F)F]

The systematic chemical name tris(2-(2-(2,2,3,3,3-pentafluoropropoxy)ethoxy)ethyl) borate corresponds to a compound with a structural formula of:

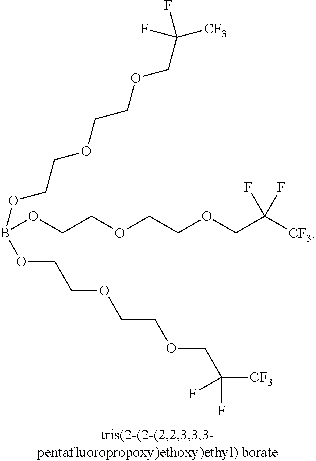 [SMILES: FC(F)(F)C(F)(F)COCCOCCOB(OCCOCCOCC(F)(F)C(F)(F)F)OCCOCCOCC(F)(F)C(F)(F)F]

The systematic chemical name tris(2-(2-(2,2,3,3,3-pentafluoropropoxy)ethoxy)ethoxy)aluminum corresponds to a compound with a structural formula of:

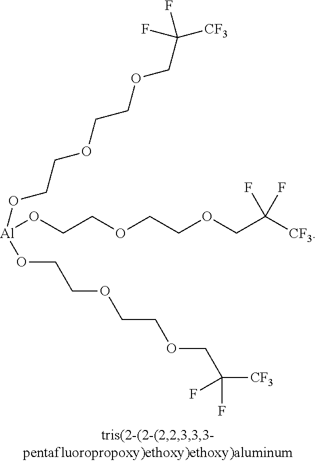

The systematic chemical name tris(2-(2-(2,2,3,3,3-pentafluoropropoxy)ethoxy)ethyl) phosphate corresponds to a compound with a structural formula of:

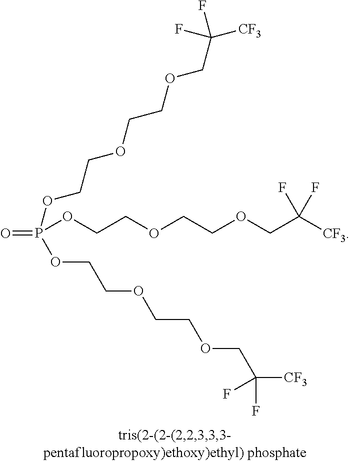 [SMILES: O=P(OCCOCCOCC(F)(F)C(F)(F)F)(OCCOCCOCC(F)(F)C(F)(F)F)OCCOCCOCC(F)(F)C(F)(F)F]

The systematic chemical name tris(2-(2-fluoroethoxy)ethyl) borate corresponds to a compound with a structural formula of:

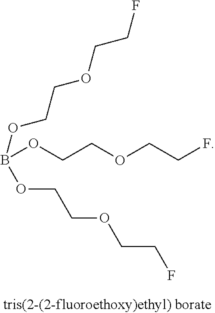 [SMILES: FCCOCCOB(OCCOCCF)OCCOCCF]

The systematic chemical name tris(2-(2-fluoroethoxy)ethoxy)aluminum corresponds to a compound with a structural formula of:

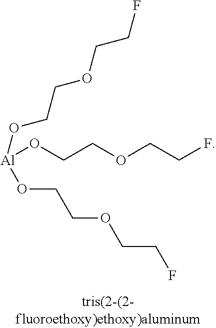

The systematic chemical name tris(2-(2-fluoroethoxy)ethyl) phosphate corresponds to a compound with a structural formula of:

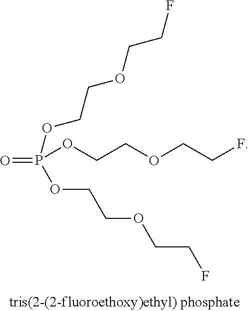 [SMILES: O=P(OCCOCCF)(OCCOCCF)OCCOCCF]

The systematic chemical name tris(2-(2,2,2-trifluoroethoxy)ethyl) borate corresponds to a compound with a structural formula of:

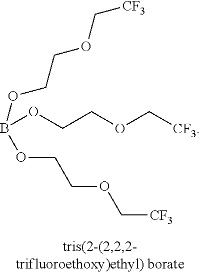 [SMILES: FC(F)(F)COCCOB(OCCOCC(F)(F)F)OCCOCC(F)(F)F]

The systematic chemical name tris(2-(2,2,2-trifluoroethoxy)ethoxy)aluminum corresponds to a compound with a structural formula of:

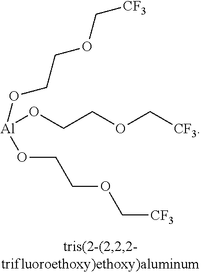

The systematic chemical name tris(2-(2,2,2-trifluoroethoxy)ethyl) phosphate corresponds to a compound with a structural formula of:

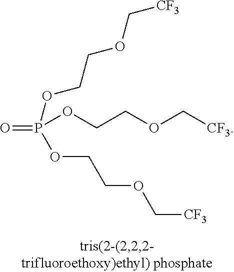 [SMILES: O=P(OCCOCC(F)(F)F)(OCCOCC(F)(F)F)OCCOCC(F)(F)F]

The systematic chemical name tris(2-(2,2,3,3,3-pentafluoropropoxy)ethyl) borate corresponds to a compound with a structural formula of:

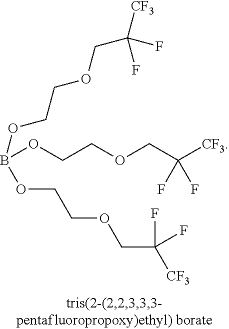 [SMILES: FC(F)(F)C(F)(F)COCCOB(OCCOCC(F)(F)C(F)(F)F)OCCOCC(F)(F)C(F)(F)F]

The systematic chemical name tris(2-(2,2,3,3,3-pentafluoropropoxy)ethoxy)aluminum corresponds to a compound with a structural formula of:

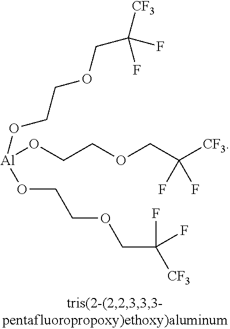

The systematic chemical name tris(2-(2,2,3,3,3-pentafluoropropoxy)ethyl) phosphate corresponds to a compound with a structural formula of:

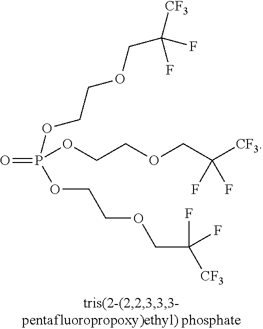 [SMILES: O=P(OCCOCC(F)(F)C(F)(F)F)(OCCOCC(F)(F)C(F)(F)F)OCCOCC(F)(F)C(F)(F)F]

When used in lithium-ion batteries, ether compounds have had a tendency to insert between the graphene layers of graphite together with lithium ions, which leads to significant decay in energy density and only approximately 50% of the theoretical graphite capacity with much higher overpotential. Despite decades of research, ether electrolytes have been unable to support reversible lithium intercalation within graphite at conventional salt concentrations HCEs are limited by poor wettability, low ionic conductivity, and high cost. LHCEs cannot dissolve lithium salts and maintain the solvation structure of HCEs. By contrast, as demonstrated in the present disclosure, it has been surprisingly and unexpectedly found that conductive fluoroether solvents such as the fluoroether electrolytes of formulae (I), (II), and (III) of the present disclosure may enable reversible lithium (de)intercalation within graphite, intrinsically preventing solvent co-intercalation at conventional salt concentrations of approximately 1 M. Electrochemically, it has been surprisingly and unexpectedly discovered that the fluoroether electrolytes of formulae (I), (II), and (III) of the present disclosure demonstrate voltage profiles and cycling performance that mirror commercial carbonate electrolytes at room temperature, and result in energy densities 10 times higher than energy densities obtained by using diglyme ether electrolyte. Further, at 60° C., the fluoroether electrolytes of formulae (I), (II), and (III) of the present disclosure outperform commercial carbonate electrolytes. By in situ and ex situ X-ray diffraction, Raman spectroscopy, and NMR, it has been surprisingly demonstrated that the fluoroether electrolytes of formulae (I), (II), and (III) of the present disclosure enable a desired graphite lithiation mechanism that forms LiC₆ without solvent co-intercalation by passivating the graphite surface with a solvent-derived SEI.

Without wishing to be bound by theory, lithium-ion cells usually refer to cells including a first electrode including graphite, a second electrode including an insertion-type cathode such as lithium iron phosphate (“LFP”), lithium cobalt oxide (LiCoO₂), lithium nickel manganese cobalt oxide (LiNMC), and electrolyte. In an example, a lithium-ion cell of the present disclosure may include a first electrode including lithium metal, a second electrode including graphite, and a fluoroether electrolyte including one or more compounds of formulae (I), (II), and (III). Without wishing to be bound by theory, graphite electrode may operate by the reversible interaction and deintercalation of lithium ion in between graphene layers without significant damage from swelling, while a lithium metal electrode may operate by deposition and stripping of lithium metal, which may cause the problem of lithium dendrite growth as well as safety concerns. Without wishing to be bound by theory, an insertion-type cathode may operate by the insertion and deinsertion of lithium ion into a layered metal oxide framework. By contrast, in lithium-sulfur cells, lithium and sulfur are used as electrodes, and sulfur (S₈) electrode morphology changes significantly after a single discharge.

In lithium-sulfur cells, energy is stored in the sulfur electrode, and during discharge, lithium ions in the electrolyte migrate to the sulfur electrode, where the sulfur is reduced to lithium sulfide. The sulfur is reoxidized to S₈ during the recharge phase. By contrast, in a lithium-ion cell, during discharge, positively charged lithium ions move through the electrolyte and electrons move through the external circuit from the anode, and recombine at the cathode; during charge, electrons and lithium ions move from the cathode to the anode, storing chemical energy in the cell. In lithium-sulfur cells, the sulfur electrode morphology may be preserved by selection of an appropriate electrolyte, thereby inhibiting dissolution of sulfur. By contrast, in lithium-ion cells, lithium ions may intercalate and deintercalated at both electrodes, and selection of an appropriate electrolyte such as a fluoroether electrolyte of formulae (I), (II), or (III), may suppress and/or inhibit and/or prevent intercalation of the electrolyte into the graphite electrode.

In another example, a lithium-ion cell of the present disclosure may include a first electrode including lithium metal, a second electrode including graphite, a fluoroether electrolyte including one or more compounds of formulae (I), (II), and (III) and a lithium salt dissolved in the fluoroether electrolyte. Examples of lithium salts may include lithium bis(trifluoromethane)sulfonimidate (“LiTFSI”), lithium bis(fluorosulfonyl)amide (“LiFSA”), lithium triflate (LiOTf), lithium nitrate (LiNO₃), LiPF₆, lithium bis(oxalato)borate (“LiBOB”), lithium difluoro(oxalato)borate (“LiDFOB”), lithium tetrafluoroborate (LiBF₄), and lithium perchlorate (LiClO₄).

In another example, the molarity of a lithium salt in a fluoroether electrolyte may be from about 0.1 M, or from about 0.2 M, or from about 0.3 M, or from about 0.4 M, or from about 0.5 M to about 1.5 M; or from about 0.5 M to about 1.6 M, or to about 1.7 M, or to about 1.8 M, or to about 1.9 M, or to about 2.0 M, or to about 2.1 M, or to about 2.2 M, or to about 2.3 M, or to about 2.4 M, or to about 2.5 M, or to about 2.6 M, or to about 2.7 M, or to about 2.8 M, or to about 2.9 M, or to about 3.0 M, or to about 3.1 M, or to about 3.2 M, or to about 3.3 M, or to about 3.4 M, or to about 3.5 M, or to about 3.6 M, or to about 3.7 M, or to about 3.8 M, or to about 3.9 M, or to about 4.0 M, or to about 4.1 M, or to about 4.2 M, or to about 4.3 M, or to about 4.4 M, or to about 4.5 M, or to about 4.6 M, or to about 4.7 M, or to about 4.8 M, or to about 4.9 M, or to about 5.0 M, or from any one of the above minima to any one of the above maxima.

In another example, during cycling, a lithium-ion cell may be configured to retain at least 65% capacity, or at least 66% capacity, or at least 67% capacity, or at least 68% capacity, or at least 69% capacity, or at least 70% capacity, or at least 71% capacity, or at least 72% capacity, or at least 73% capacity, or at least 74% capacity, or at least 75% capacity, or at least 76% capacity, or at least 77% capacity, or at least 78% capacity, or at least 79% capacity, or at least 80% capacity.

In another example, during cycling, a lithium-ion cell may be configured to retain at least from 65% to 80% capacity between a temperature range of from about −20° C., or from about −19° C., or from about −18° C., or from about −17° C., or from about −16° C., or from about −15° C., or from about −14° C., or from about −13° C., or from about −12° C., or from about −11° C., or from about −10° C., or from about −9° C., or from about −8° C., or from about −7° C., or from about −6° C., or from about −5° C., or from about −4° C., or from about −3° C., or from about −2° C., or from about −1° C., or from about 0° C., or from about 1° C., or from about 2° C., or from about 3° C., or from about 4° C., or from about 5° C., or from about 6° C., or from about 7° C., or from about 8° C., or from about 9° C., or from about 10° C., or from about 11° C., or from about 12° C., or from about 13° C., or from about 14° C., or from about 15° C., or from about 16° C., or from about 17° C., or from about 18° C., or from about 19° C., or from about 20° C. to about 60° C.

In an example, the present disclosure provides a process for preparing a lithium-ion cell, including: dissolving a lithium salt in a fluoroether electrolyte including one or more compounds of formulae (I), (II), and/or (III) so as to provide a solution; and adding the solution to a cell including a first electrode including lithium metal and a second electrode including graphite.

The compositions and processes described above may be better understood in connection with the following Examples. In addition, the following non-limiting examples are an illustration. The illustrated methods are applicable to other examples of stretchable light-emitting polymers of the present disclosure. The procedures described as general methods describe what is believed will be typically effective to prepare the compositions indicated.

However, the person skilled in the art will appreciate that it may be necessary to vary the procedures for any given example of the present disclosure, e.g., vary the order or steps and/or the chemical reagents used.

### EXAMPLES

### General Information.

### I. Materials.

Potassium hydroxide (>85%), sodium sulfate (anhydrous), sodium hydride (60%, in mineral oil), 2,2,3,3,3-pentafluoro-1-propanol (97%), 2,2,2-trifluoroethanol (99%), 1 M LiPF₆ in EC/DMC (50:50 v/v, battery grade), diethylene glycol (99%), triethylene glycol (99%), tetraethylene glycol (99%), diglyme (anhydrous), α,α,α-trifluorotoluene (99%), dimethoxy ethane (“DME,” anhydrous), tetraglyme (anhydrous), and 4 A molecular sieves were purchased from Sigma-Aldrich. Acetone (99.5%), tetrahydrofuran (certified grade, with 0.025% butylatedhydroxytoluene as a preservative), dichloromethane (99.5%), hexanes (98.5%), ethyl acetate (99.5%), and methanol (99.8%) were purchased from Fisher. Lithium foil (750 m thick), p-toluenesulfonyl chloride (98%), and triglyme (99%) were purchased from Alfa Aesar. Lithium perchlorate (99%), lithium bis(fluorosulfonyl)amide (“LiFSA,” 99%), and pentaethylene glycol (95%) were purchased from Oakwood Chemical. Deuterated acetonitrile (>99.8 atom % D), deuterated water (>99.8 atom % D), and deuterated chloroform (>99.8 atom % D) were purchased from Cambridge Isotope Laboratories. All solvents used for preparing electrolytes were dried by 4 Å molecular sieves overnight, and stored with molecular sieves inside an Argon-filled glovebox (VigorTech, 02 and H₂O<1 ppm). LiFSA salt was vacuum-dried at 120° C. overnight in a heated glovebox antechamber before use and was not exposed to air at any time. Other chemicals were used as received.

Celgard 2325 and 3501 separators were purchased from Celgard LLC. Celgard separators were cut into 18 mm disks. Celgard 2325 separator was rinsed with acetone and vacuum-dried at 70° C., while Celgard 3501 separator was directly vacuum dried at 70° C. They were moved into an Argon-filled glovebox (02 and H₂O<1 ppm) without air exposure before use. All coin cell parts were obtained from Xiamen TOB New Energy Technology. Lithium foils were polished with a brush to remove oxide layer and cut into 12 mm diameter disks before use. Graphite and LiFePO₄ (“LFP”) electrodes were provided by Cell Analysis, Modeling, and Prototyping (“CAMP”) facility of Argonne National Laboratory. Graphite electrode has a total mass loading of 6.35 mg/cm² with 91.83 wt % of Hitachi MagE3 graphite, 2 wt % of Timcal C45 carbon, 6 wt % of Kureha 9300 PVDF binder, and 0.17 wt % of oxalic acid. LFP electrode has a total mass loading of 13.40 mg/cm² with 90 wt % of Johnson Matthey LFP, 5 wt % of Timcal C45 carbon, and 5 wt % of Solvay 5130 PVDF binder. Graphite and LFP electrodes were cut into 12 mm diameter disks, dried at 120° C. overnight in a heated glovebox antechamber before use.

### II. Electrochemical Characterizations.

### A. Coin Cell Preparation:

All of the electrochemical characterizations except for in situ X-ray diffraction (“XRD”) were performed in CR2032 type coin cells with the following configuration: negative case∥spring∥spacer∥anode (counter electrode)∥30 μL electrolyte∥1 separator∥30 μL electrolyte∥cathode (working electrode)∥spacer∥positive case. Celgard 2325 separator was used for most of the electrolytes; for 1 M LiPF₆ in EC/DMC (50:50 v/v), Celgard 3501 was used for better wetting. All the coin cells were assembled inside an Argon-filled glovebox (O₂ and H₂O<1 ppm).

### B. Cyclic Voltammetry (“CV”):

CV tests were performed in coin cells using graphite as working electrode and lithium metal as counter and reference electrode (termed “Li/Gr cells”). A Biologic MPG-2 Potentiostate was used to test Li/Gr cells at 20° C. After resting for 3 hours, cell voltage was scanned from open circuit voltage to 0.01 V and then reverse-scanned to 2.5 V at a rate of 0.05 mV·s⁻¹.

### C. Coin Cell Cycling:

A Neware BTS4000 battery tester was used to cycle Li/Gr and Gr/LFP coin cells. All cells were rested for 10 hours before testing. For the cycling test at elevated temperature, a Memmert IN 110 oven was used to hold the temperature at 60° C.

### D. Electrochemical Impedance Spectroscopy (“EIS”):

Gr/LFP coin cells were first cycled three times at a current rate of C/20 (ending with deintercalation). Afterward, a Biologic VSP-300 Potentiostat was used to measure impedance spectra between 7 MHz and 1 Hz at 20° C.

### III. Physical Characterizations.

### A. Spectroscopy for Product Confirmation.

Fourier transform infrared (FTIR) spectroscopy was performed on a Shimadzu IRTracer-100 spectrometer in reflection mode using a diamond ATR crystal, with the frequency range 400-4000 cm⁻¹. Measurements were performed in the air and at ambient temperature and pressure. Samples were sealed in vials in an argon glovebox (O₂, H₂O<1 ppm) prior to running the measurement. Roughly 20 μL of sample was used for the measurements, and a total of 15 scans were taken in absorbance mode. Acetone was used to clean the probe and ATR crystal.

Gas chromatography mass spectroscopy (“GC-MS”) was performed on an Agilent 7200B quadrupole time-of-flight GC/MS system. The sample was prepared by dissolving products into hexane (HPLC grade) at a 1:100000 volume ratio and was passed through a PTFE filter (0.45 μm) prior to testing.

Nuclear magnetic resonance (“NMR”) spectroscopy was performed on a Bruker Ascend 9.4 T/400 MHz instrument. The NMR sample was prepared by dissolving several milligrams of product into 0.5 mL of deuterated chloroform.

### B. X-Ray Diffraction (XRD):

Lithiated graphite sample were retrieved from Li/Gr cells after lithiating for 20 hours or to 0.01 V at a current rate of C/20. Li/Gr cells were disassembled inside an argon glovebox. Electrolyte residue were carefully wiped off the surface of lithiated graphite and the electrodes were dried under vacuum. Diglyme sample was tested directly without vacuum drying to preserve the structure of solvent co-intercalated complex. Kapton board and tapes were used to seal as-prepared graphite electrode before moving the electrode out of the glovebox and testing at an instrument.

### C. Raman Spectroscopy:

A HORIBA LabRAM HR Evolution Confocal Raman Microscope was used for Raman spectroscopy. A 633 nm laser was used as a light source. Intercalated graphite electrodes were prepared following the procedure described above. For Raman spectroscopy, lithiated graphite was sealed in glass chambers inside an argon-filled glovebox. The glass chamber was assembled using glass slides (Chemglass life science) and silicone isolators purchased from Grace Bio-Laboratories.

### D. In Situ Synchrotron XRD:

Li/Gr cells with Kapton window were prepared.

### E. Nuclear Magnetic Resonance (NMR) Spectroscopy for SEI Extract:

Graphite/LiFePO₄ cells after three formation cycles at C/20 (ending with (de)intercalation) were dissembled in an argon-filled glove box (O₂, H₂O<1 ppm). Cycled graphite electrodes were washed with anhydrous DME three times and dried under vacuum to remove salt and solvent residue. Two pieces of cycled graphite electrodes were rinsed by 0.5 mL of D₂O for 30 minutes and the liquid phase was transferred to an NMR tube. The NMR tube was capped and sealed by PTFE film and parafilm inside a glovebox to avoid any air exposure. NMR spectra were collected with a Bruker Ascend 9.4 T/400 MHz instrument.

### F. Solid-State NMR:

⁷Li and ¹H magic angle spinning NMR experiments were performed using a Bruker Avance III wide-bore 400 MHz solid-state NMR spectrometer (9.5 Tesla). Intercalated graphite electrodes were retrieved from Li/Gr cells as described above. In an argon-filled glovebox (O₂, H₂O<1 ppm), graphite samples were powdered using a plastic scraper and packed in 1.9 mm zirconia rotors.

### IV. Simulations.

### A. Density Functional Theory (“DFT”) Calculations:

DFT calculations were performed using the Gaussian 16 computational package. See M. J. Frisch, et al., Gaussian 16 rev., GAUSSIAN INC., Wallingford, CT, USA (2016), incorporated by reference herein in its entirety. All geometries were optimized at B3LYP/6-31G(d,p) level of theory. After stationary points were verified by the absence of imaginary frequencies, single point energies of the optimized geometries were calculated using B3LYP/6-311++G(d,p). Solvent effects were accounted for by employing SMD model. See A. V. Marenich, et al., Universal Solvation Model Based on Solute Electron Density and on a Continuum Model of the Solvent Defined by the Bulk Dielectric Constant and Atomic Surface Tensions, 113 J. PHYS. CHEM. B 6378 (2009), incorporated by reference herein in its entirety. THF was selected because of its modified dielectric constant. Grimme's DFT-D3 method with BJ-damping (GD3BJ) was used for dispersion correction. See S. Grimme, et al., Effect of the damping function in dispersion corrected density functional theory, 32 J. COMPUT. CHEM. 1456 (2011), incorporated by reference herein in its entirety. To calculate the adiabatic redox energy, the geometries of neutral and charged states were optimized and their Gibbs free energies were calculated. The reduction energy was defined as the G(M)−G(M⁻). The energies were divided by Faraday's constant and then 1.4 was subtracted from it to convert to electrochemical potentials (versus Li/Li⁺). See O. Borodin, et al., Oxidative Stability and Initial Decomposition Reactions of Carbonate, Sulfone, and Alkyl Phosphate-Based Electrolytes, 117 J. PHYS. CHEM. C 8661 (2013), incorporated by reference herein in its entirety.

### V. Synthesis.

### A. Tosylation of Glycols

In a typical procedure, a round-bottom flask was charged with 38.13 g (0.2 mol) of tosyl chloride (TsCl) and 10.61 g (0.1 mol) of diethylene glycol. Then, 100 mL of dichloromethane (“DCM”) was added to dissolve all of the materials. The flask was cooled to 0° C. using an ice bath, and approximately 45 g (0.8 mol) of powdered potassium hydroxide (KOH) was added in small portions under stirring to maintain a low temperature. The resultant white suspension was kept under an ice bath for 3 hours. The reaction was quenched by adding 100 mL of ice deionized water, which also dissolved excess KOH. The organic phase was separated and washed with 100 mL of deionized water twice. The combined aqueous phase was extracted by 50 mL of DCM. The combined organic phase was dried with anhydrous sodium sulfate (Na₂SO₄), and DCM was removed under a vacuum to yield 39 g of bis-tosylated diethylene glycol product as a white powder. The product was used directly in the next step without further purification.

Under similar procedures, bis-tosylated triethylene glycol (“oxybis(ethane-2,1-diyl) bis (4-methylbenzenesulfonate)”) was synthesized from triethylene glycol as a white powder; bis-tosylated tetraethylene glycol (“ethane-1,2-diylbis(oxy))bis(ethane-2,1-diyl) bis(4-methylbenzenesulfonate)”) and bis-tosylated pentaethylene glycol (“((oxybis(ethane-2,1-diyl))bis(oxy))bis(ethane-2,1-diyl) bis(4-methylbenzenesulfonate)”) were obtained from tetraethylene glycol and pentaethylene glycol as colorless viscous liquids all in high (>90%) yield.

### B. Synthesis of 1,1,1-trifluoro-2-(2-(2-(2,2,2-trifluoroethoxy)ethoxy)ethoxy)ethane (“E3F1”)

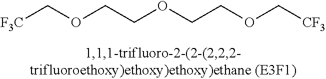 [SMILES: FC(F)(F)COCCOCCOCC(F)(F)F]

2,2,2-Trifluoroethanol (14.5 g, 2.4 equiv.) was added drop-wise to a mixture of sodium hydride (60% in mineral oil, 9.7 g, 4 equiv.) and tetrahydrofuran (THF, 200 mL) at 0° C. via syringe pump under N₂ atmosphere. The resulting mixture was allowed to stir for 2 hours at room temperature. Oxybis(ethane-2,1-diyl) bis(4-methylbenzenesulfonate) (25 g, 1 equiv.) dissolved in 100 mL THF was then added drop-wise to the resulting alkoxide solution at 0° C. The resulting solution was refluxed for 8 hours and then quenched with water. The reaction mixture was then extracted with 80 mL ethyl acetate (3 times) and the combined organic phase was washed with brine and dried over anhydrous Na₂SO₄. After the removal of solvent by a rotary evaporator, the crude product was dried over 4 Å molecular sieves and then purified by fractional distillation. The final product (E3F1) is a colorless liquid (7.92 g, b.p. 67° C., 8 mmHg) obtained in a yield of 49%. ¹H NMR (CDCl₃, 300 MHz): δ 3.88 (q, J=8.7 Hz, 4H), 3.71 (m, 8H); ¹³C NMR (CDCl₃, 75 MHz): δ 129.5, 125.8, 122.1, 118.4 (q, J=278 Hz), 78.9, 70.7, 69.4, 68.9, 68.5, 68.0 (q, J=34 Hz).

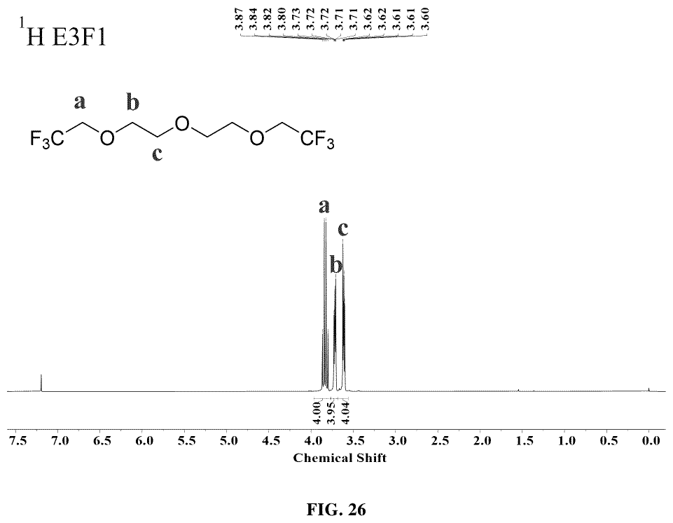

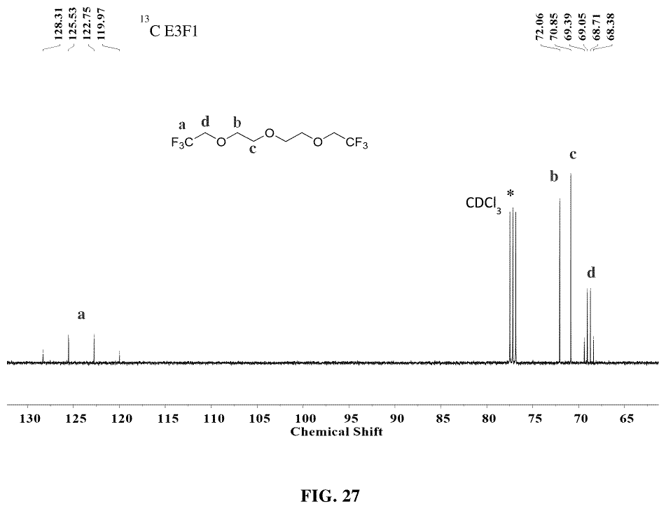

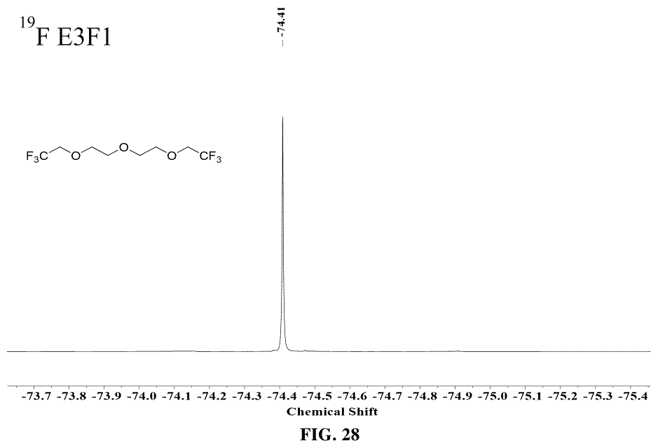

Alternatively, anhydrous tetrahydrofuran (THF, 100 mL, dried over 4 Å sieves for 12 hours) and sodium hydride (NaH, 60% in mineral oil, 5.77 g, 2.6 equiv.) were added into a round-bottom flask charged with nitrogen. The mixture was stirred to form a uniform grey suspension. 2,2,2-Trifluoroethanol (9.99 mL, 2.5 equiv.) was added to the suspension dropwise at 0° C. When no more gas evolved, oxybis(ethane-2,1-diyl) bis(4-methylbenzenesulfonate (23.01 g, 1.0 equiv.) dissolved in anhydrous THF (100 mL) was added, and the mixture was heated to reflux for 12 hours. The reaction system was cooled to room temperature, quenched by several drops of methanol followed by 30 mL of water. THF was removed under vacuum and the remaining mixture was extracted three times with 30 mL of dichloromethane (CH₂Cl₂). The combined organic phase was twice washed with 30 mL water, dried over anhydrous Na₂SO₄, and filtered. After the CH₂Cl₂ was removed under vacuum, the crude E3F1 was distilled under reduced pressure to afford 11.21 g E3F1 as a colorless liquid in 75% yield. ¹H NMR (FIG. 26, CDCl₃, 400 MHz): δ 3.83 (q, J=8.8 Hz, 4H), 3.71 (dd, J=5.8, 3.2 Hz, 4H), 3.64-3.55 (m, 4H); ¹³C NMR (FIG. 27, CDCl₃, 101 MHz): δ 128.31, 125.53, 122.75, 119.7 (q, J=279.6 Hz), 72.06, 70.85, 69.40, 69.06, 68.72, 68.38 (q, J=34.0 Hz); ¹⁹F{¹H} NMR (FIG. 28, CDCl₃, 376 MHz): δ −74.41 (s, 6F).

### C. Synthesis of 1,1,1,14,14,14-hexafluoro-3,6,9,12-tetraoxatetradecane (“E4F1”)

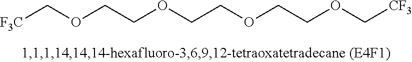 [SMILES: FC(F)(F)COCCOCCOCCOCC(F)(F)F]

2,2,2-Trifluoroethanol (13.1 g, 2.4 equiv.) was added drop-wise to a mixture of sodium hydride (60% in mineral oil, 8.7 g, 4 equiv.) and tetrahydrofuran (THF, 200 mL) at 0° C. via syringe pump under N₂ atmosphere. The resulting mixture was allowed to stir for 2 hours at room temperature. (Ethane-1,2-diylbis(oxy))bis(ethane-2,1-diyl) bis(4-methylbenzenesulfonate) (25 g, 1 equiv.) dissolved in 100 mL THF was then added drop-wise to the resulting alkoxide solution at 0° C., after which the resulting solution was refluxed for 8 hours and then quenched by adding water. The reaction mixture was extracted with 80 mL ethyl acetate (3 times) and the combined organic phase was washed with brine and dried over anhydrous Na₂SO₄. After the removal of solvent by a rotary evaporator, the crude product was dried over 4 Å molecular sieves and then purified by fractional distillation. The final product (E4F1) is a colorless liquid (9.98 g, b.p. 96° C., 8 mmHg) obtained in a yield of 58%. ¹H NMR (CDCl₃, 300 MHz): δ 3.89 (q, J=8.9 Hz, 4H), 3.71 (m, 12H); ¹³C NMR (CDCl₃, 75 MHz): δ 129.5, 125.8, 122.1, 118.4 (q, J=278 Hz), 71.8, 70.6, 70.6, 69.3, 68.9, 68.4, 68.0 (q, J=34 Hz).

### D. Synthesis of 1,1,1,17,17,17-hexafluoro-3,6,9,12,15-pentaoxaheptadecane (“E5F1”)

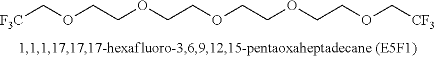 [SMILES: FC(F)(F)COCCOCCOCCOCCOCC(F)(F)F]

2,2,2-Trifluoroethanol (11.9 g, 2.4 equiv.) was added drop-wise to a mixture of sodium hydride (60% in mineral oil, 8.0 g, 4 equiv.) and tetrahydrofuran (THF, 200 mL) at 0° C. via syringe pump under N₂ atmosphere. The resulting mixture was allowed to stir for 2 hours at room temperature. ((Oxybis(ethane-2,1-diyl))bis(oxy))bis(ethane-2,1-diyl) bis(4-methylbenzenesulfonate (25 g, 1 equiv.) dissolved in 100 mL THF was then added drop-wise to the resulting alkoxide solution at 0° C. The resulting solution was refluxed for 8 hours and then quenched by adding water. The reaction mixture was extracted with 80 mL ethyl acetate (3 times) and the combined organic phase was washed with brine and dried over anhydrous Na₂SO₄. After the removal of solvent by a rotary evaporator, the crude product was dried over 4 Å molecular sieves and then purified by fractional distillation. The final product (E5F1) is a colorless liquid (7.90 g, b.p. 129° C., 8 mmHg) obtained in a yield of 44%. ¹H NMR (CDCl₃, 300 MHz): δ 3.89 (q, J=8.8 Hz, 4H), 3.76 (m, 4H), 3.65 (m, 12H); ¹³C NMR (CDCl₃, 75 MHz): δ 129.5, 125.8, 122.1, 118.4 (q, J=278 Hz), 71.8, 70.6, 70.5, 70.5, 69.3, 68.8, 68.4, 67.9 (q, J=34 Hz).

### E. Synthesis of Borate Fluoroethers of Formula (III)

A fluoro-substituted poly(ethyleneglycol) (R⁷—(OCH₂CH₂)ₚ—OH) and boric acid anhydride (B₂O₃) were dissolved in toluene under N₂ atmosphere and refluxed at 110° C. to eliminate generated water. The extent of the reaction was determined by the amount of the generated water. After the reaction was completed, toluene was evaporated under vacuum conditions for 12 hours, and clear liquid was obtained.

### 1. Synthesis of tris(2-(2,2,2-trifluoroethoxy)ethyl) borate

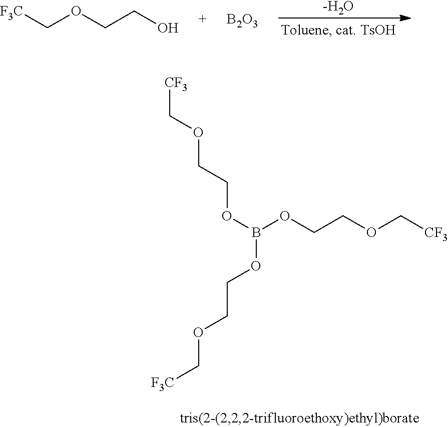 [SMILES: OCCOCC(F)(F)F ; "B2O3" ; "-H2O" ; FC(F)(F)COCCOB(OCCOCC(F)(F)F)OCCOCC(F)(F)F]

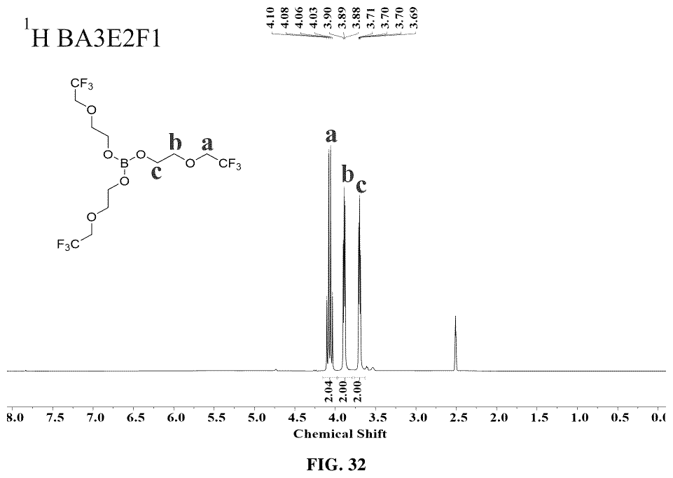

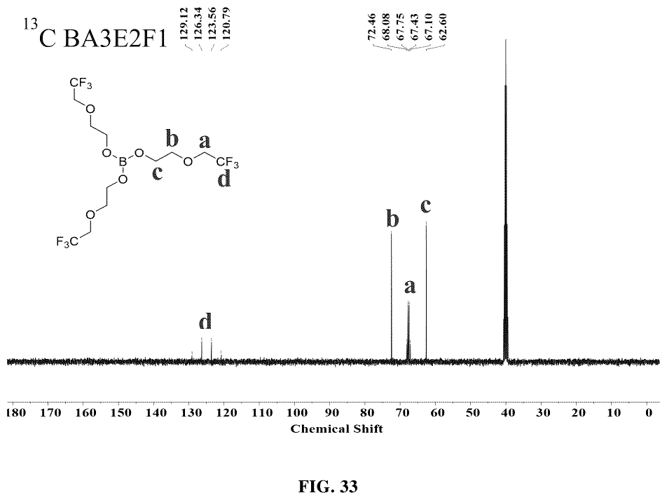

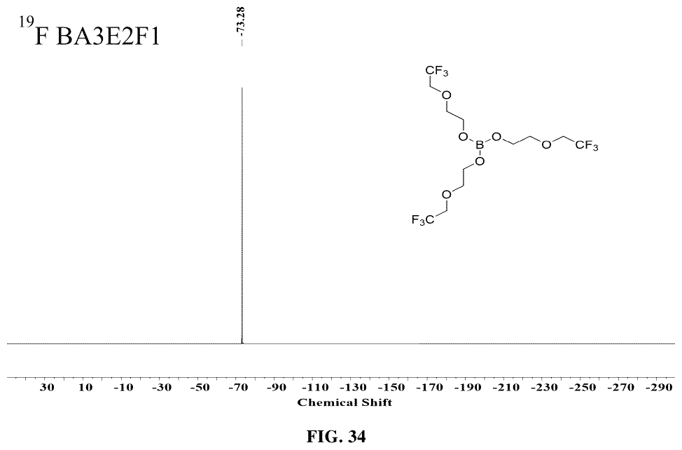

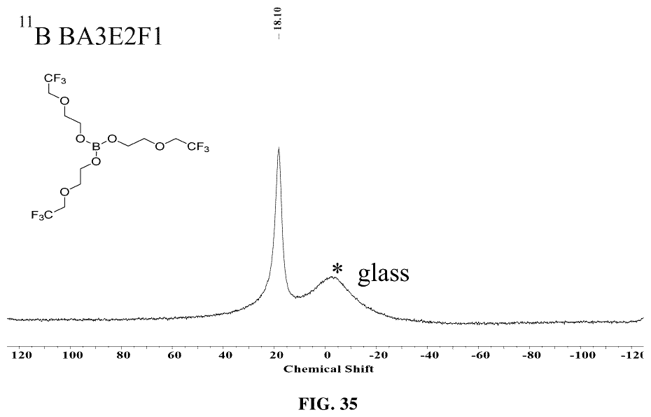

In an example of a synthesis of a borate fluoroether of formula (III), 0.69 g B₂O₃ (1 equiv.), toluene (80 mL), 8.55 g 2-(2,2,2-trifluoroethoxy)ethan-1-ol (6 equiv.), and 0.034 p-toluenesulfonic acid monohydrate (0.018 equiv.) were added to a round-bottom flask under nitrogen. The mixture was heated to reflux while water was removed by a Dean-Stark apparatus. The reaction was kept refluxing for 4 h until no more water was generated. Toluene was removed under vacuum, and the residue purified by fractional distillation under reduced pressure. To minimize the hydrolysis of the product in air, the receiving flask was refilled with nitrogen at the end of distillation and sealed before transferring to a glovebox. The product was collected as 1.14 g (13% yield) of a colorless liquid. ¹H NMR (FIG. 32, DMSO, 400 MHz): δ 4.06 (q, J=9.3 Hz, 6H), 3.96-3.78 (m, 6H), 3.69 (dd, J=5.7, 3.8 Hz, 6H); ¹³C NMR (FIG. 33, DMSO, 101 MHz): δ 129.12, 126.34, 123.56, 120.79 (q, J=279.4 Hz), 72.46, 68.08, 67.75, 67.43, 67.10 (q, J=32.8 Hz), 62.60; ¹⁹F{¹H}NMR (FIG. 34, CDCl₃): δ −73.28 (s, 9F); ¹¹B NMR (FIG. 35): δ 18.1.

### F. Synthesis of Aluminum Fluoroethers of Formula (III)

A fluoro-substituted poly(ethyleneglycol) (R⁷—(OCH₂CH₂)ₚ—OH) and aluminum isopropoxide were mixed and heated at 100° C. After completion of the reaction, isopropanol was evaporated under reduced pressure.

### G. Synthesis of Phosphate Fluoroethers of Formula (III)

A fluoro-substituted poly(ethyleneglycol) (R⁷—(OCH₂CH₂)r-OH) and POCl₃ were mixed at 0-5° C. in benzene, with pyridine added as an acid-quencher. Liquid phosphate fluoroether products were purified by fractional distillation, and solid phosphate fluoroether products were purified by recrystallization.

### H. Synthesis of 1,14-difluoro-3,6,9,12-tetraoxatetradecane

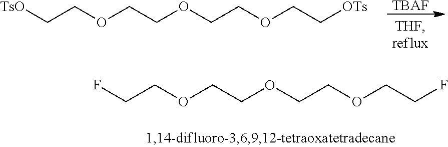

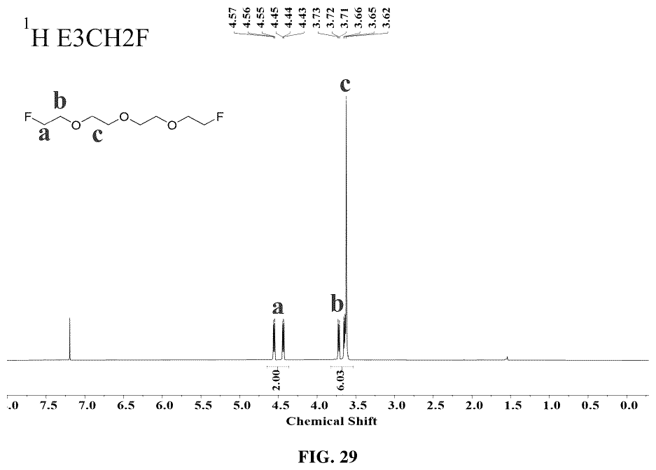

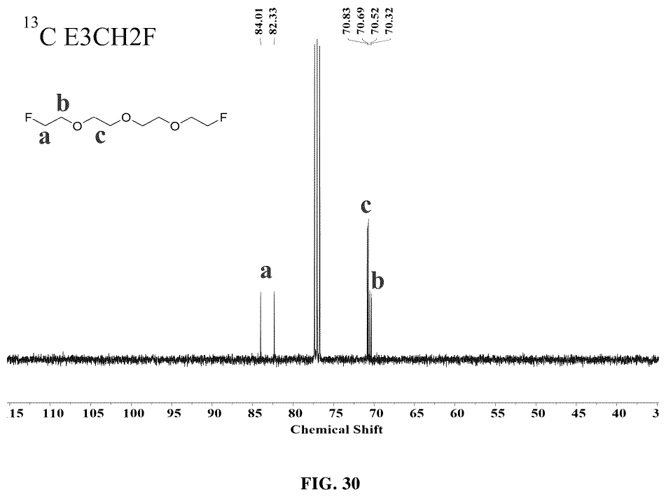

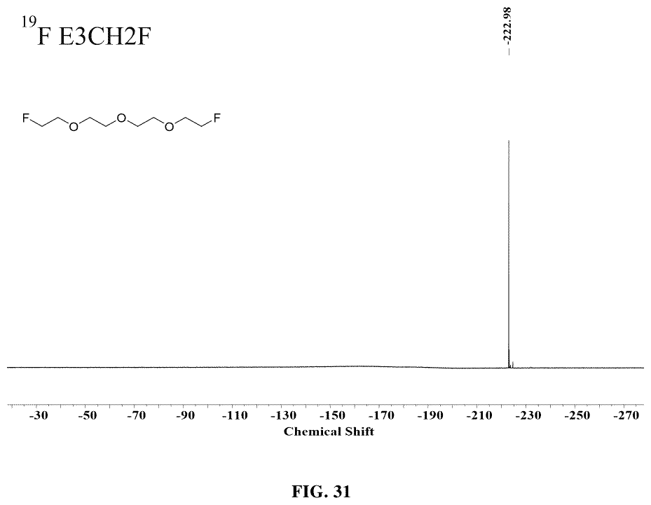

Bis-tosylated tetraethylene glycol (38 g, 1 equiv.) and tetrabutylammonium fluoride (TBAF, 182 mL, 1 M in THF, 2.4 equiv.) were added into a round-bottom flask. The mixture was heated to reflux for 3 hours. THF was removed under vacuum, and the crude product was distilled under reduced pressure. The crude product was dissolved in dichloromethane (50 mL) and then twice washed with 30 mL of 1 M H₂SO₄, washed once with 30 mL of water, and once with 30 mL of brine (saturated aqueous NaCl solution). The organic phase was separated, dried over anhydrous Na₂SO₄, and filtered. The dichloromethane was removed under vacuum. The product was distilled under reduced pressure to provide 1,14-difluoro-3,6,9,12-tetraoxatetradecane as a colorless liquid. ¹H NMR (FIG. 29, CDCl₃, 400 MHz): δ 4.71-4.40 (m, 4H), 3.93-3.59 (m, 12H); ¹³C NMR (FIG. 30, CDCl₃, 101 MHz): δ 84.01, 82.33 (d, J=169.2 Hz), 70.83, 70.69 (d, J=13.9 Hz), 70.52, 70.32 (d, J=19.7 Hz); ¹⁹F{¹H}NMR (FIG. 31, CDCl₃, 376 MHz): δ −222.98 (s, 2F).

### VI. Reversible Lithium-Ion (De)Intercalation with Fluoroethers

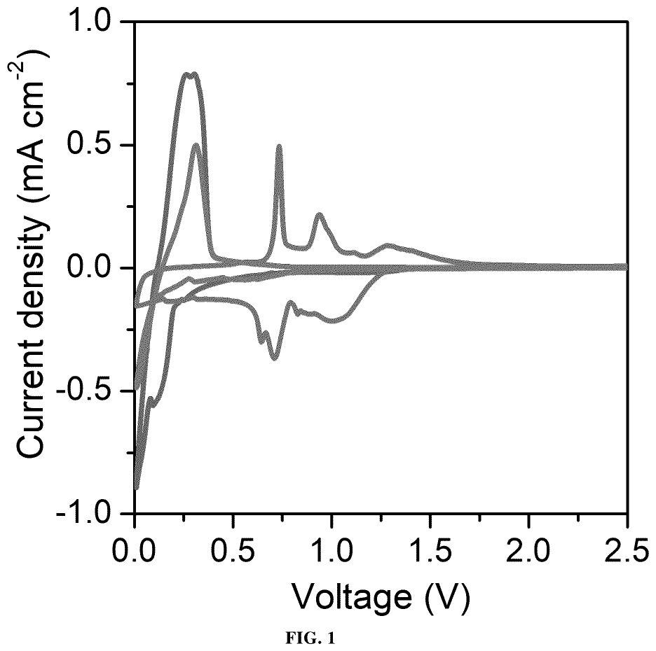

The influence of electrolyte selection on lithium intercalation was studied in lithium metal/graphite (“Li/Gr”) cells. Li/Gr cells using 1 M lithium bis(fluorosulfonyl)amide (LiFSA) in E3F1, 1 M LiPF₆ in EC/DMC (ethylene carbonate/dimethyl carbonate), and 1 M LiFSA in diglyme, as electrolytes, were first explored using cyclic voltammetry (CV). FIG. 1 illustrates that the E3F1 cell and the EC/DMC cell have similar reduction peaks starting from 0.5 V and peaking at 0.01 V, which correspond to graphite lithiation reactions. In the subsequent reverse scan, delithiation peaks were observed for the E3F1 and EC/DMC cells at approximately 0.25 V. By contrast, the CV curve for the Li/Gr cell including diglyme electrolyte demonstrates multiple diffuse peaks between 2 V and 0.01 V. Without being bound by theory, it is believed that multiple diffuse peaks in a CV curve is characteristic for the solvent co-intercalation reaction. See B. Jache, et al., A comparative study on the impact of different glymes and their derivatives as electrolyte solvents for graphite co-intercalation electrodes in lithium-ion and sodium-ion batteries, 18 PHYS. CHEM. CHEM. PHYS. 14299 (2016), incorporated by reference herein in its entirety.

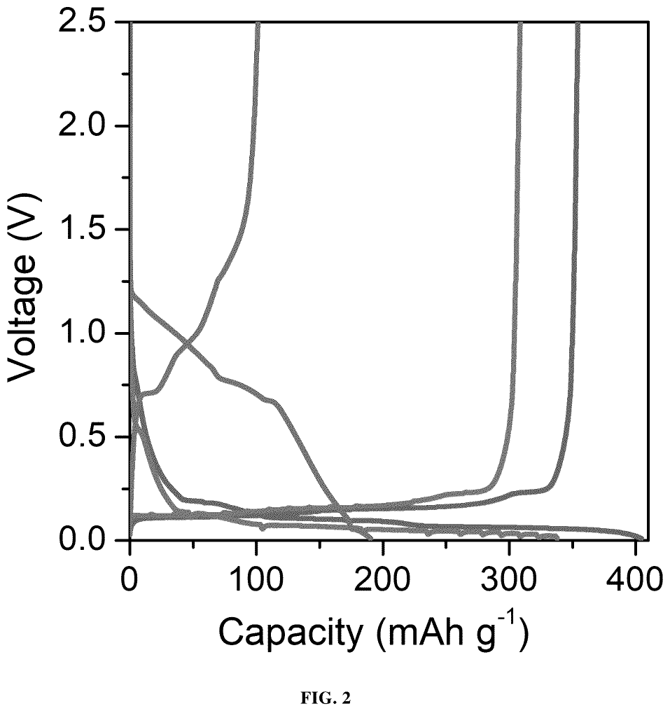

FIG. 2 illustrates the first galvanostatic cycle of Li/Gr cells including 1 M LiFSA in E3F1, 1 M LiPF₆ in EC/DMC, and 1 M LiFSA in diglyme, at a current rate of C/20 (1C≈2.17 mA·cm⁻²). Similarly to the CV, the voltage profile of the E3F1 cell is comparable to the voltage profile of the EC/DMC cell, supporting the absence of solvent co-intercalation in E3F1 electrolyte. The lithiation potential of the E3F1 cell drops below 0.2 V soon after the initial stage, and reaches a lithiation capacity of 404.4 mAH·g⁻¹. Subsequent delithiation maintains a low overpotential and achieves a first-cycle coulombic efficiency of 87.6%, which is a value similar to commercially relevant 1 M LiPF₆ in EC/DMC electrolyte (with a coulombic efficiency of 90.1%). By contrast, the Li/Gr cell including 1 M LiFSA in diglyme as electrolyte exhibits a higher lithiation potential (˜1 V), low lithiation capacity (190.3 mAh·g⁻¹), and low coulombic efficiency (53.2%). Without being bound by theory, the poor graphite cycling observed in “normal ethers” such as diglyme has been attributed to solvent co-intercalation. Accordingly, both the CV and galvanostatic cycling of Li/Gr cells demonstrate that E3F1 electrolyte enables reversible lithiation/delithiation of graphite without solvent co-intercalation.

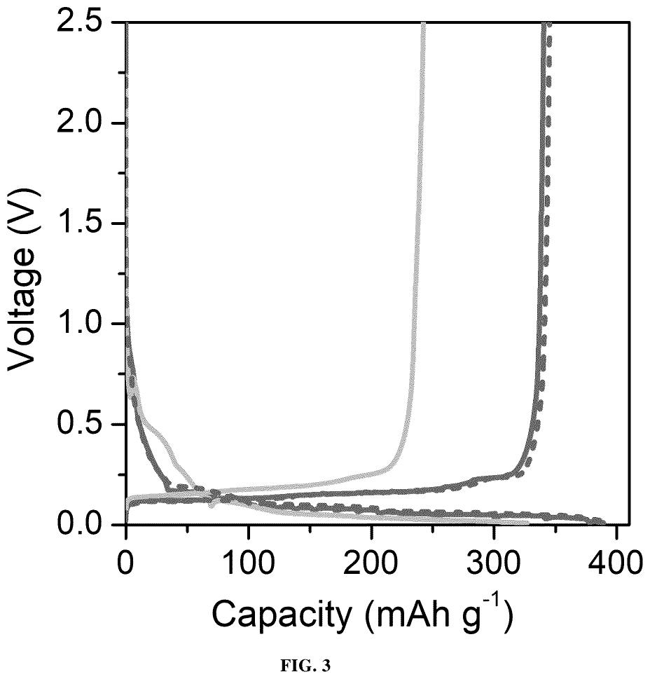

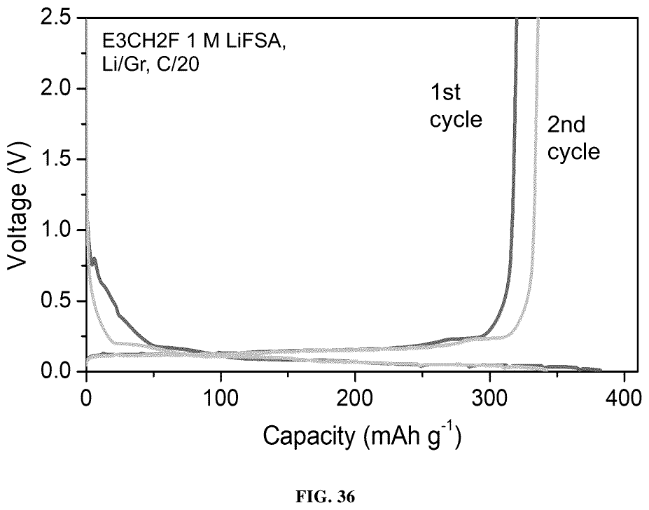

FIG. 3 illustrates that E4F1 and E5F1 may support efficient lithium intercalation and (de)intercalation within graphite without solvent co-intercalation. Further, the voltage profile of 0.5 M LiFSA in E3F1 illustrated in FIG. 3 demonstrates that observed lithium intercalation is not dependent on salt concentration. Accordingly, FIG. 3 demonstrates that fluoroether electrolytes such as E3F1, E4F1, and E5F1 may intrinsically support reversible lithium intercalation and (de)intercalation independently of high salt concentration or diluents, in contrast to the dependencies upon high salt concentration or diluents observed for HCE and LHCE electrolytes. Li/Gr cells including fluoroethers of the present disclosure are thus configured to promote lithium intercalation and (de)intercalation within graphite without fluoroether co-intercalation. Voltage profiles of Li/Gr cells using 1,14-difluoro-3,6,9,12-tetraoxatetradecane indicated reversible lithium intercalation without solvent co-intercalation, as illustrated in FIG. 36.

To investigate lithium insertion, a differential analysis was performed on the Li/Gr voltage profiles illustrated in FIG. 2. First-order derivatives of capacity-voltage curves (dQ/dV) were calculated numerically and plotted as a function of voltage.

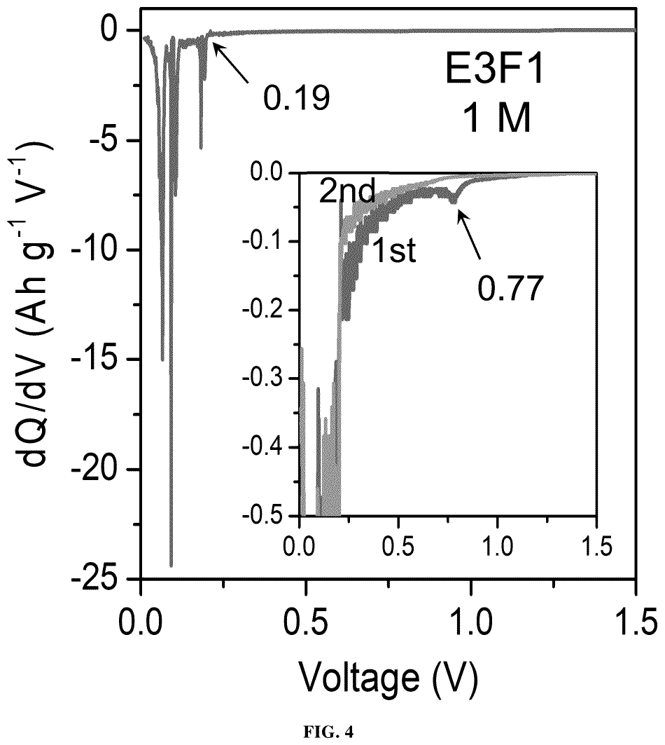

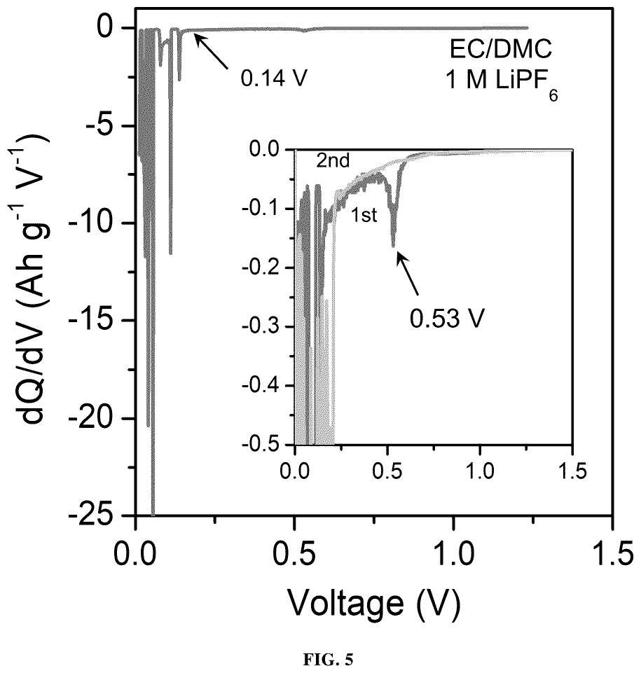

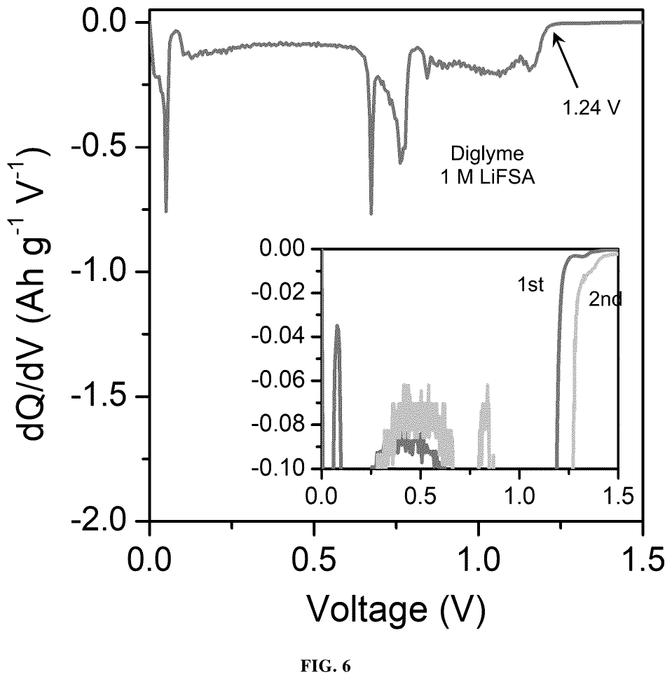

FIG. 4 illustrates the dQ/dV curve for the first lithiation using E3F1 electrolyte. The sharp peaks visible below 0.19 V in FIG. 4 resemble different stages of graphite lithiation reaction that occur without solvent co-intercalation. See J. Yang, et al., Molecular Engineering to Enable High-Voltage Lithium-Ion Battery: From Propylene Carbonate to Trifluoropropylene Carbonate, 6 ACS ENERGY LETT. 371 (2021), incorporated by reference herein in its entirety. The tiny peak visible at approximately 0.77 V in the inset in FIG. 4 demonstrates the formation of a solid electrolyte interphase (“SEI”). FIG. 5 illustrates the dQ/dV plot of lithiation in EC/DMC electrolyte, which parallels the plot illustrated in FIG. 5 for E3F1 electrolyte, except that in EC/DMC electrolyte, there is no SEI formation potential. Further, FIG. 6 illustrates that diglyme electrolyte leads to broad peaks from 1.24 V, corresponding to the high potentials of solvent co-intercalated lithiation. B. Jache, et al., (2016). As FIGS. 4-6 illustrate, differential analysis reinforces the mechanistic similarities between EC/DMC and E3F1 electrolytes and the differences between E3F1 and diglyme electrolytes in graphite intercalation behavior.

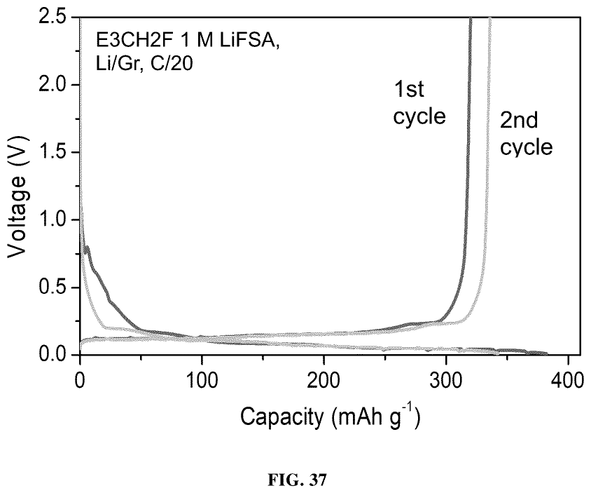

The x-ray diffraction pattern of graphite lithiated in 1,14-difluoro-3,6,9,12-tetraoxatetradecane demonstrates the characteristic peaks of the LiₓC₆ phase, as illustrated in FIG. 37. The peaks verify the desired lithium intercalation mechanism occurs, similarly to other fluoroether electrolytes.

### VII. Long-term Cycling at Ambient and Elevated Temperatures.

Graphite/LiFePO₄ (“Gr/LFP”) full cell cycling demonstrated the benefits resulting from the elimination of solvent co-intercalation. Gr/LFP full cells, including, separately, 1 M LiFSA in E3F1, 1 M LiFSA in diglyme, and 1 M LiPF₆ in EC/DMC were cycled at a current rate of C/3 at 20° C. after three formation cycles at C/20.

The Gr/LFP cell including E3F1 electrolyte achieved a first discharge capacity (124 mAh·g⁻¹) and a coulombic efficiency (80%) for the first formation cycle that was comparable to that of the cell including EC/DMC. However, the Gr/LFP cell including diglyme reached only a coulombic efficiency of 56% due to solvent co-intercalation.

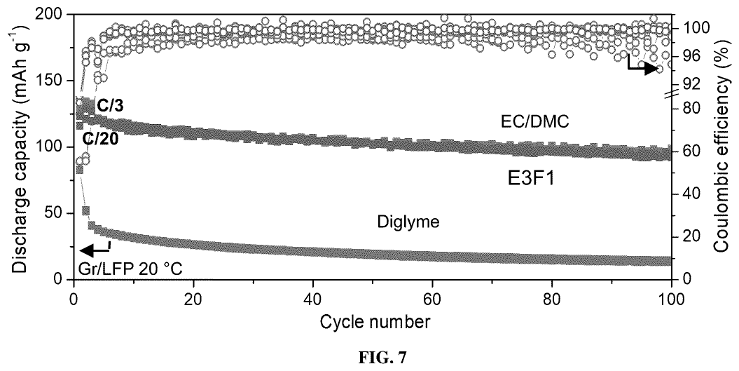

FIG. 7 illustrates that when the Gr/LFP cells were cycled repeatedly at C/3, the Gr/LFP cell including E3F1 may retain 92 mAh·g⁻¹ capacity at the 100^{th} cycle, which is a capacity comparable to a capacity of a commercial carbonate cell and six times higher than a capacity of the Gr/LFP cell including diglyme. Based on calculations from the discharge capacity at the 100^{th} cycle, the E3F1 electrolyte enables energy densities 10 times higher than diglyme electrolyte in Gr/LFP full cells, which may be one reason why the diglyme cell may demonstrate a lower voltage.

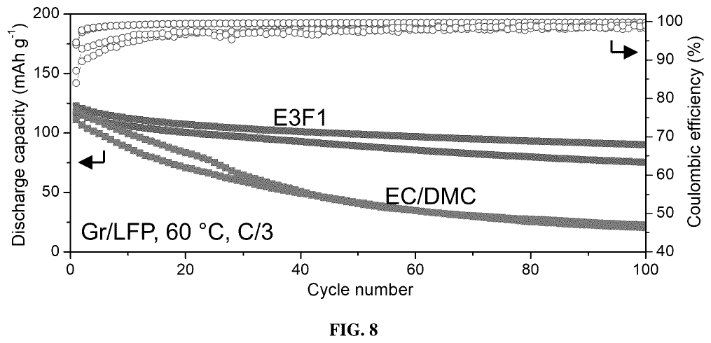

The superior thermal stability of fluoroether electrolytes, such as E3F1, E4F1, and E5F1, relative to conventional electrolytes, is demonstrated by Gr/LFP full cell cycling at 60° C. FIG. 8 illustrates that Gr/LFP cells including E3F1 electrolyte may be cycled repeated at 60° C. and their capacity retention may be comparable to cycling at 20° C. (approximately 69% at 60° C. compared to approximately 77% at 20° C. at the 100^{th} cycle). All values in FIG. 8 were averaged from two experiments. By comparison, Gr/LFP cells including EC/DMC electrolyte demonstrate rapid capacity decay and lower coulombic efficiencies at the onset of full cell cycling at 60° C. At the 100^{th} cycle, EC/DMC electrolyte may only maintain approximately 19% of an original discharge capacity, which is much lower than the cycling performance of EC/DMC electrolyte at 20° C. of approximately 79%.

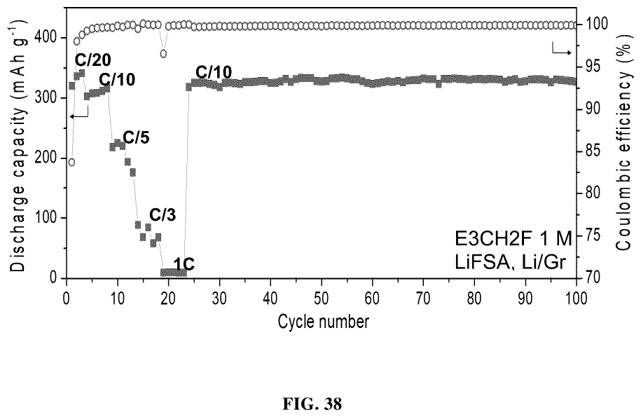

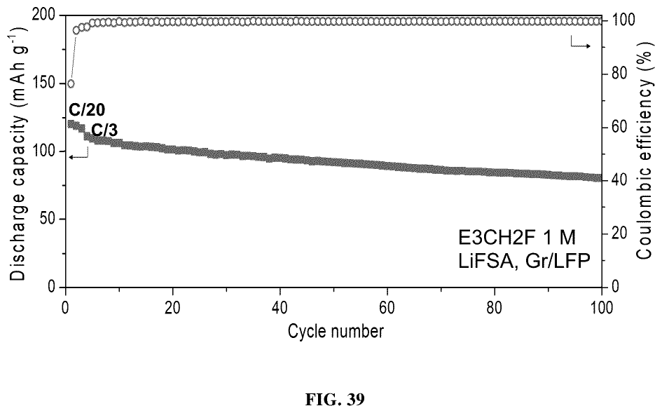

FIG. 38 illustrates stable cycling of a Li/Gr half cell using 1,14-difluoro-3,6,9,12-tetraoxatetradecane as electrolyte. A Gr/LFP full cell using 1,14-difluoro-3,6,9,12-tetraoxatetradecane as electrolyte demonstrates stable cycling as well as capacity retention that is close to the capacity retention demonstrated when using E3F1 as electrolyte, as illustrated in FIG. 39.

The cell including E3F1 electrolyte demonstrates significant capacity retention and stable overpotential throughout 100 cycles. By contrast, the overpotential of the cell including EC/DMC increases with increasing cycle number, which may indicate continuous electrolyte degradation. See B. Ravdel, et al., Thermal stability of lithium-ion battery electrolytes, 119-121 J. POWER SOURCES 805 (2003); X. Zhang, et al., Advanced Eletrolytes for Fast-Charging High-Voltage Lithium-Ion Batters in Wide-Temperatures Range, 10 ADV. ENERGY MATER. 2070098 (2020); each of which is incorporated by reference herein in its entirety. Without being bound by theory, the relatively poor thermal stability of EC/DMC electrolyte may be attributed at least in part to the instability of the LiPF₆ salt. See S. E. Sloop, et al., Chemical Reactivity of PF₅ and LiPF₆ in Ethylene Carbonate/Dimethyl Carbonate Solutions, 4 ELECTROCHEM. SOLID-STATE LETT. A42 (2001), incorporated by reference herein in its entirety. The high-temperature cycling of LiFSA in E3F1 may be considered especially significant because imide salts, such as LiFSA, have generally been known to corrode the aluminum current collector, but that was not observed for the Gr/LFP cell including E3F1. The cycling performance of the Gr/LFP cell including E3F1 at 60° C. and 25° C. demonstrates that E3F1 electrolyte may have a broader working temperature window and the fluoroether electrolytes of the present disclosure are promising electrolyte candidates for lithium-ion batteries.

### VIII. Ex Situ Characterization of Graphite Intercalation Compounds.

The mechanism of lithium intercalation in fluoroether electrolytes was analyzed using diffraction and spectroscopic techniques. Graphite intercalated in E3F1 or E4F1 electrolytes have golden colors similar to graphite intercalated in EC/DMC electrolyte, while graphite intercalated in diglyme electrolyte leads to black-colored intercalated graphite. Fluoroether electrolytes of the present disclosure produce graphite intercalation compounds (“GIC”) similarly to EC/DMC electrolyte but differently from diglyme electrolyte.

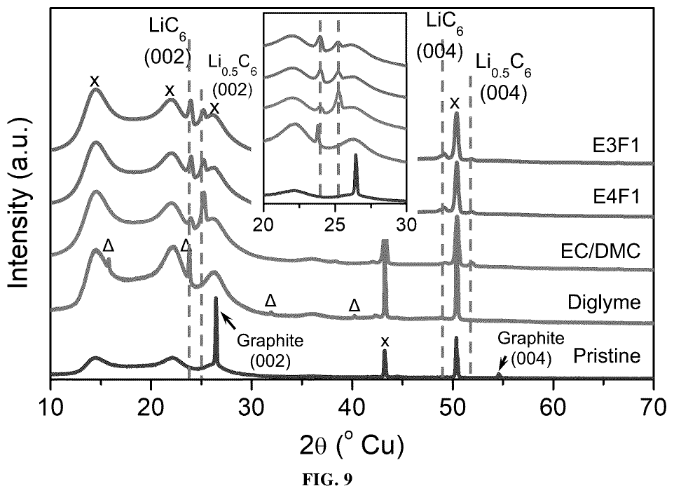

FIG. 9 illustrates ex situ X-ray diffraction (“XRD”) patterns of graphite intercalated in different electrolytes, and includes pristine graphite for comparison. Pristine graphite demonstrates a (002) peak at 2θ=26.5° and (004) peak at 2θ=54.6°, corresponding to an interlayer distance of 3.36 Å. After lithium-ion insertion in E3F1, E4F1, or EC/DMC electrolyte, graphite (002) and (004) peaks shift to lower diffraction angles due to lattice expansion. Based on previously reported mechanisms of graphite staging due to lithium insertion, splitting of graphite peaks in these lithiated samples indicates a coexistence of two stages: the (002) peak at 2θ=24.0° and (004) peak at 2θ=49.10 are assigned to stage-1 LiC₆ phase, with an interlayer distance of 3.70 Å in agreement with literature reports; stage-2 Li_{0.5}C₆ phase produces a (002) peak at 2θ=25.3° and (004) peak at 2θ=51.9°, with an interlayer distance of 3.52 Å. See V. Reynier, et al., XRD evidence of macroscopic composition inhomogeneities in the graphite-lithium electrode, 165 J. POWER SOURCES 616 (2007); H. He, et al., Dynamic study of Li intercalation into graphite by in situ high energy synchrotron XRD, 92 ELECTROCHIMICA ACTA 148 (2013); each of which is incorporated by reference herein in its entirety. The formation of Li-C GICs in fluoroether electrolytes of the present disclosure is in agreement with electrochemical observations hereinabove and demonstrates the ability of fluoroether electrolytes of the present disclosure to advantageously suppress solvent co-intercalation. By contrast, graphite electrodes “lithiated” in diglyme electrolyte demonstrate a series of peaks at 2θ=15.8°, 23.8°, 31.9°, and 40.2°, highlighted in FIG. 9 by triangle symbols, and the diglyme series of peaks correspond to (002), (003), (004), and (005) peaks of solvent co-intercalated ternary GICs, as widely reported in the literature. See B. Jache, et al. (2016); H. Kim, et al., Exploiting Lithium-Ether Co-Intercalation in Graphite for High-Power Lithium-Ion Batteries. 7 ADV. ENERGY MATER. 1700418 (2017); each of which is incorporated by reference herein in its entirety.

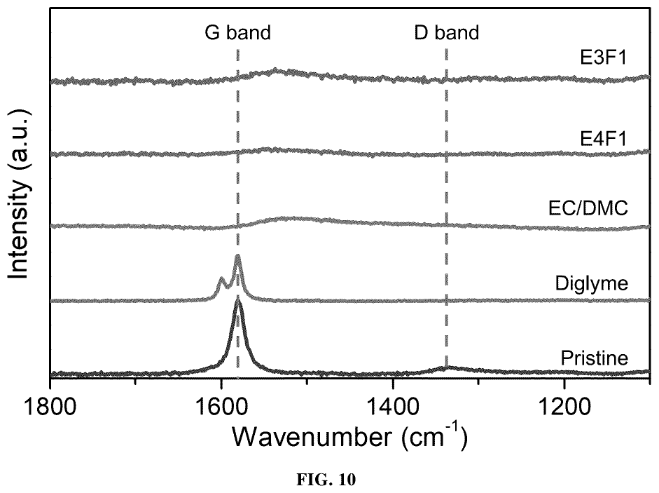

To complement the diffraction data, Raman spectroscopy was also used to characterize graphite electrodes. FIG. 10 illustrates that a Raman spectrum of pristine graphite includes a graphitic “G band” at approximately 1580 cm⁻¹ and a disordered “D band” at approximately 1330 cm⁻¹. Both the G band and the D band are known to diminish with lithiation according to in situ Raman spectra evolution of graphite electrode cycled in 1 M LiPF₆ in EC/DMC electrolyte. See C. Sole, et al., In situ Raman study of lithium-ion intercalation into microcrystalline graphite, 172 FARADAY DISCUSSIONS 223 (2014), which is incorporated by reference herein in its entirety. Because E3F1 and E4F1 electrolytes also produce LiₓC₆ insertion complexes without solvent co-intercalation, the G and D bands are absent in the corresponding intercalated graphite samples illustrated in FIG. 10. By contrast, the Raman spectrum of graphite intercalated in diglyme electrolyte illustrated in FIG. 10 demonstrates a split G band, which is characteristic of partially lithiated graphite. See C. Sole, et al. (2014). The intercomplete intercalation in diglyme electrolyte provides support for the demonstrated low capacity of graphite in diglyme electrolyte as illustrated herein in FIG. 2. As demonstrated herein, Raman spectra bands of GICs are highly dependent upon the nature of the species intercalated in the graphite, whether the species is solvent, ion, or solvent-ion complex.

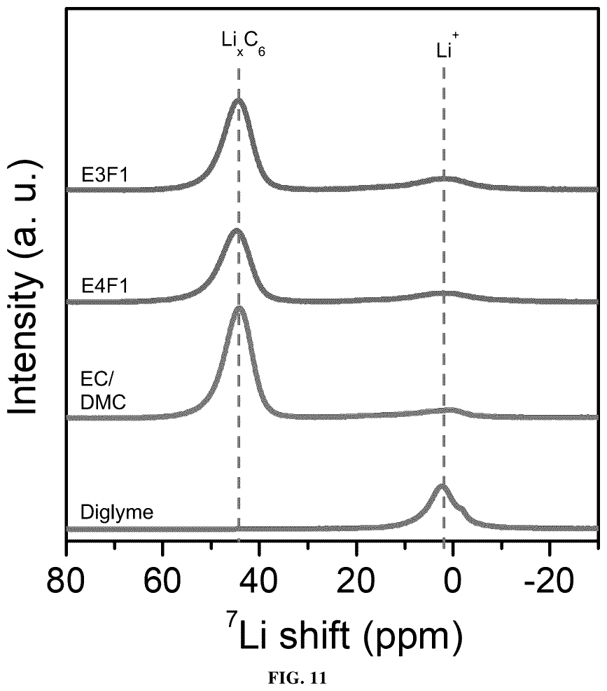

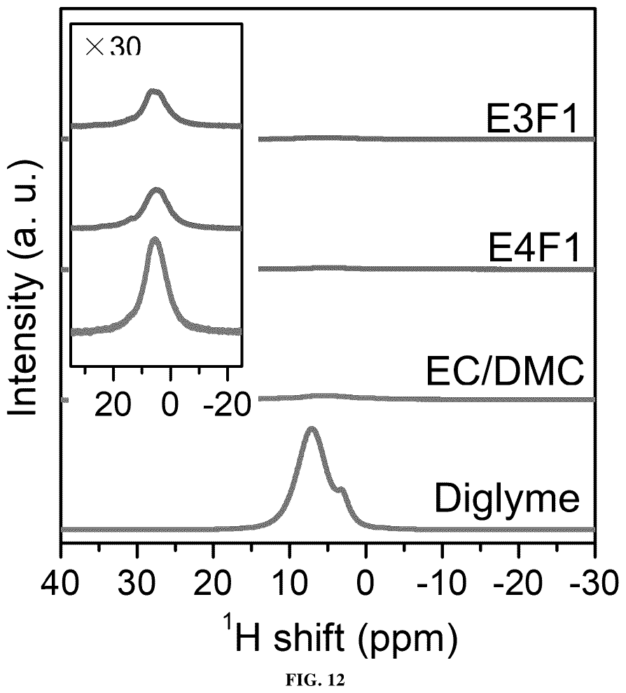

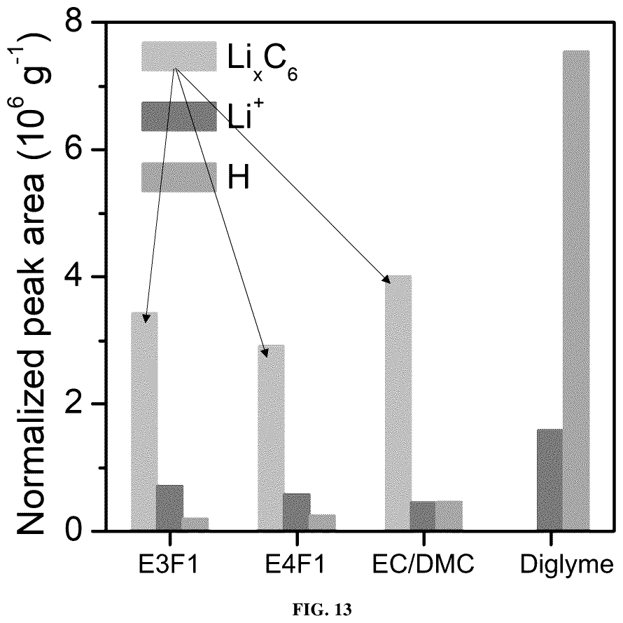

Solid-state magic angle spinning (“MAS”) NMR spectroscopy was used to further investigate the composition of lithiated graphite electrodes. FIG. 11 illustrates ⁷Li NMR spectra of graphite lithiated in E3F1, E4F1, EC/DMC, or diglyme electrolytes. LiₓC₆ insertion complexes in E3F1, E4F1, and EC/DMC electrolyte samples produce high signal-to-noise ratio (“S/N”) shifts of approximately 45 ppm, which agrees with prior reports. See M. Letellier, et al., In situ ⁷Li nuclear magnetic resonance observation of the electrochemical intercalation of lithium in graphite; 1st cycle, 45 CARBON 1025 (2007), which is incorporated by reference herein in its entirety. A relatively low S/N shift is also observed for Li⁺ species in the solid electrolyte interface (“SEI”) and potentially any salt residue. In the sample of LiₓC₆ insertion complex cycled in diglyme, no LiₓC₆ species are observed in the ⁷Li NMR spectrum, and the S/N for the 2 ppm peak appears higher. Without being bound by theory, it is believed that the higher S/N for the 2 ppm peak in the ⁷Li NMR spectrum for the LiₓC₆ insertion complex cycled in diglyme is likely due to solvent co-intercalated ternary GIC. Additionally, FIGS. 12 and 13 illustrate that graphite sample cycled in diglyme electrolyte includes an abundance of protons that is an order of magnitude higher than the abundance of protons in other samples. Without being bound by theory, it is believed that the higher abundance of protons arises from the co-intercalated diglyme electrolyte molecules. Although graphite samples cycled in E3F1 or E4F1 electrolyte also demonstrate residual proton signals, as illustrated in FIG. 13, the residual proton signals are at approximately the same order of magnitude as for graphite sample cycled in EC/DMC electrolyte. Accordingly, solid-state NMR further confirms the formation of LiₓC₆ and the absence of solvent co-intercalation in fluoroether electrolytes.

The reversibility of graphite structure change was evaluated by Raman spectroscopy and X-ray diffraction. Reflective graphite particles may be observed in graphite cycled in E3F1 electrolyte in high density and the Raman spectra of those particles exactly mirror pristine graphite, indicating that the graphite structure is not altered by cycling. By contrast, optical images demonstrate that the graphite sample in diglyme electrolyte only has a few reflective graphite particles, and the remainder of the surface of the graphite sample is dark and rough. Although Raman spectra of reflective graphite particles maintain pristine graphite features, the dark and rough regions of the graphite samples do not demonstrate Raman spectra characteristic for ordered graphite structure. According to the Raman spectra, the structure of most graphite particles becomes disordered with cycling in diglyme electrolyte.

Graphite (002) and (004) peaks are well-preserved after cycling in E3F1, E4F1, or EC/DMC electrolyte, but after cycling in diglyme electrolyte, the XRD pattern includes only very weak and broad graphite peak remaining. Structural characterizations with XRD and Raman spectroscopy demonstrate that fluoroether electrolytes enable reversible lithium (de)intercalation into graphite and may explain the rapid capacity decay in the initial cycles of Gr/LFP cells in diglyme electrolyte illustrated in FIG. 7.

### IX. Intercalation Mechanism Demonstrated by In Situ Synchotron XRD.

To explore the mechanism of lithium intercalation while excluding the effects of sample preparation, in situ synchrotron X-ray diffraction was performed on lithium/graphite (Li/Gr) cells. The voltage profiles of in situ and normal coin cells are similar, despite minor differences in capacity, demonstrating that the effect of beamline exposure on the electrochemistry of the coin cells is negligible.

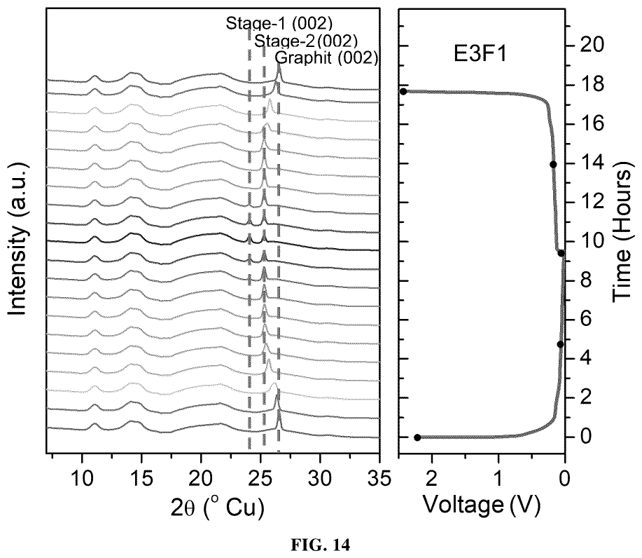

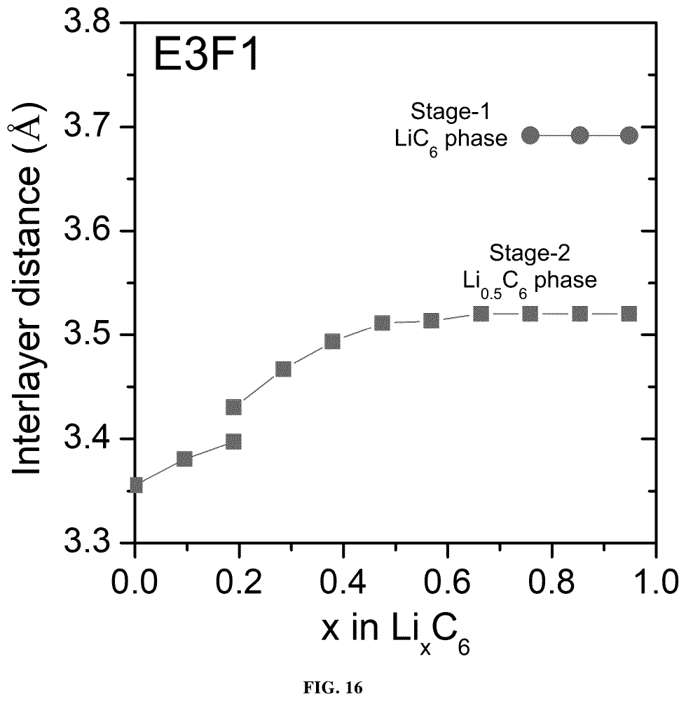

FIG. 14 illustrates the in situ XRD pattern aligned with the voltage profile for the Li/Gr cell using 1 M LiFSA in E3F1 as electrolyte. Before lithiation, the (002) peak of pristine graphite is observed at 2θ=26.5°, corresponding to an interlayer distance of 3.36 Å. In the beginning of lithiation, the graphite interlayer diffraction peak gradually shifts to lower diffraction angles due to the expansion of lattice, but no clear stage distinction is observed. When the overpotential drops below 0.04 V, the graphite interlayer diffraction peak position settles at 2θ=25.3°, corresponding to the (002) peak of stage-2 phase with an interlayer distance of 3.52 Å. Simultaneously, a new peak emerges at 2θ=24.0°, originating from stage-1 phase (002), with an interlayer distance of 3.70 Å. Thereafter, the stage-1 phase peak increases while the stage-2 peak decreases with further lithium insertion due to the phase transition. FIG. 16 illustrates the evolution of graphene interlayer distance with graphite lithiation.

The in situ XRD results for Li/Gr cell in E4F1 electrolyte are similar to the results for Li/Gr cell in E3F1 electrolyte. In situ XRD studies of graphite cycled in carbonate electrolytes has been shown to result in shifting and splitting of the graphite (002) peak similarly to cycling in E3F1 and E4F1 electrolytes, and thus the in situ XRD data illustrated herein demonstrates that fluoroether electrolytes of the present disclosure are characterized by a lithium insertion mechanism similar to that of commercially available carbonate electrolytes. See Y. Reynier, et al. (2007); H. He, et al. (2013).

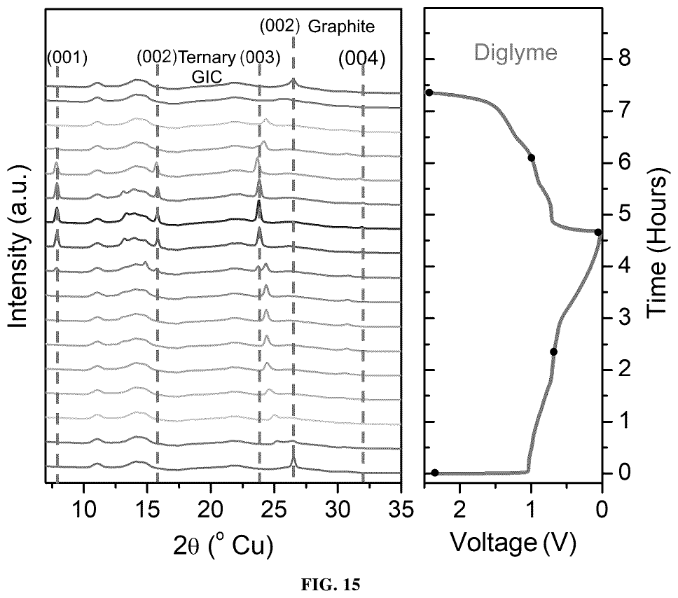

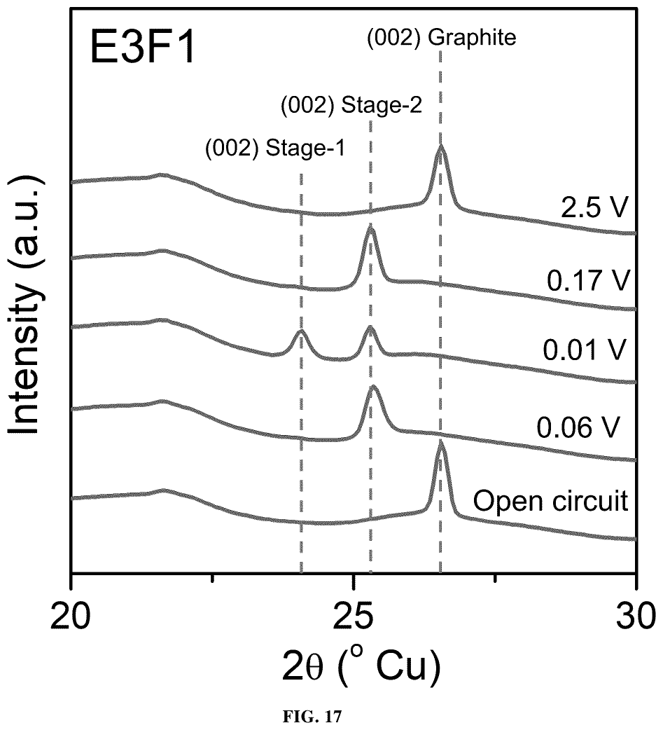

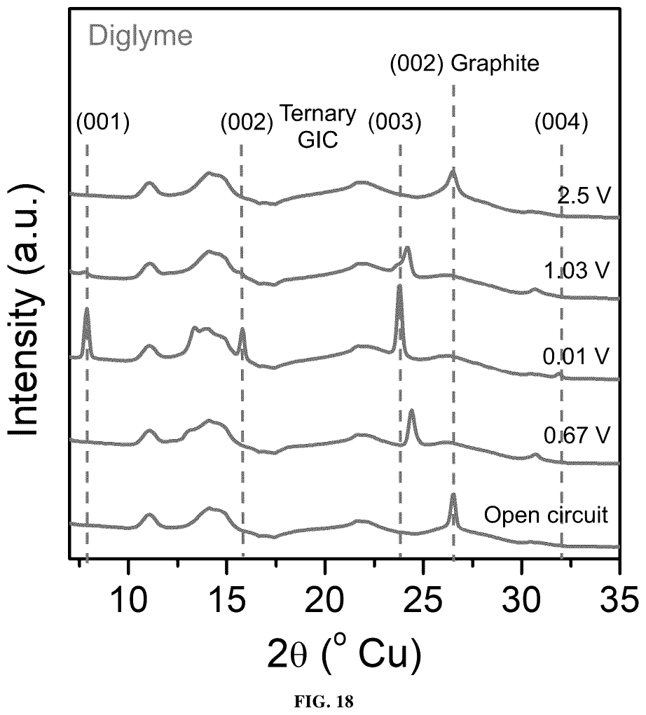

By contrast, Li/Gr cell in diglyme electrolyte provides a very different XRD pattern from those for fluoroether electrolytes of the present disclosure, as illustrated in FIG. 15. In addition to demonstrating a shifting of the original graphite (002) peak, a series of new peaks at 2θ=7.9°, 15.8°, 23.8°, and 31.9° are assigned as (001), (002), (003), and (004) peaks of Li-diglyme-graphite ternary GIC with an interlayer distance of 11.18 Å, which is in agreement with the literature for in situ XRD results of cells cycled in diglyme electrolyte. See B. Jache, et al. (2016); H. Kim, et al. (2017). Without being bound by theory, it is believed that the peak at 2θ=13.4° originates from in-plane superstructural ordering of intercalated complexes of solvent and ions. See H. Kim, et al., Sodium intercalation chemistry in graphite, 8 ENERGY ENVIRON. SCI. 2963 (2015), which is incorporated by reference herein in its entirety. Because solvent co-intercalation perturbs the layered graphite structure, the (002) peak of graphite broadens significantly after just one cycle in diglyme electrolyte. In FIGS. 14 and 15, the black dots represent XRD patterns selected as representative of key points, and these representative XRD patterns are illustrated in FIGS. 17 and 18, respectively. Despite different charging rates and sample preparation processes, ex situ results illustrated in FIG. 9 corroborate the in situ XRD patterns for graphite fully intercalated or deintercalated in E3F1 and diglyme electrolytes. The ex situ and in situ results provide mutual independent confirmation for the graphite intercalation mechanism and further support the absence of solvent co-intercalation for fluoroether electrolytes.

### X. Gr/Electrolyte Interface Passivation by Fluoroether Electrolytes of the Present Disclosure.

The solid electrolyte interphase (“SEI”) composition and structure is known to play a critical role in enabling reversible lithium intercalation and deintercalation and long-term lithium-ion battery cycling. See K. Xu, Nonaqueous Liquid Electrolytes for Lithium-Based Rechargeable Batteries, 104 CHEM. REV. 4303 (2004); K. Xu, Whether EC and PC Differ in Interphasial Chemistry on Graphitic Anode and How, 156 J. ELECTROCHEM. SOC'Y A751 (2009); M. Nie, et al., Lithium Ion Battery Graphite Solid Electrolyte Interphase Revealed by Microscopy and Spectroscopy, 117 J. PHYS. CHEM. C 1257 (2013); each of which is incorporated by reference herein in its entirety. The formation of the SEI in fluoroether electrolytes was initially indicated by the dQ/dV plots illustrated in FIG. 4, which demonstrated a peak at approximately 0.77 V. Because the dQ/dV peak appears only in the first cycle, without being bound by theory, it is believed that the peak is due to reductive degradation of electrolyte and consequent SEI formation. FIG. 5 illustrates that E4F1 and EC/DMC electrolytes similarly demonstrate SEI formation by dQ/dV plots, but at different potentials. Accordingly, cells including fluoroether electrolytes of the present disclosure are configured to form solid electrolyte interphase compositions. However, no analogous dQ/dV peak can be observed for diglyme electrolyte, as illustrated in FIG. 6. Without being bound by theory, it is believed that the lack of a SEI formation peak in diglyme electrolyte may be explained by solvent co-intercalation reaction starting at much higher potential than normal lithiation reaction (1.24 V vs. 0.19 V) and/or glyme ether solvents being known for their good reductive stabilities and for not being reduced to form a robust SEI. S. Feng, et al., Mapping a stable solvent structure landscope for aprotic Li-air battery organic electrolytes, 5 J. MATER. CHEM. A. 23987 (2017), which is incorporated by reference herein in its entirety.

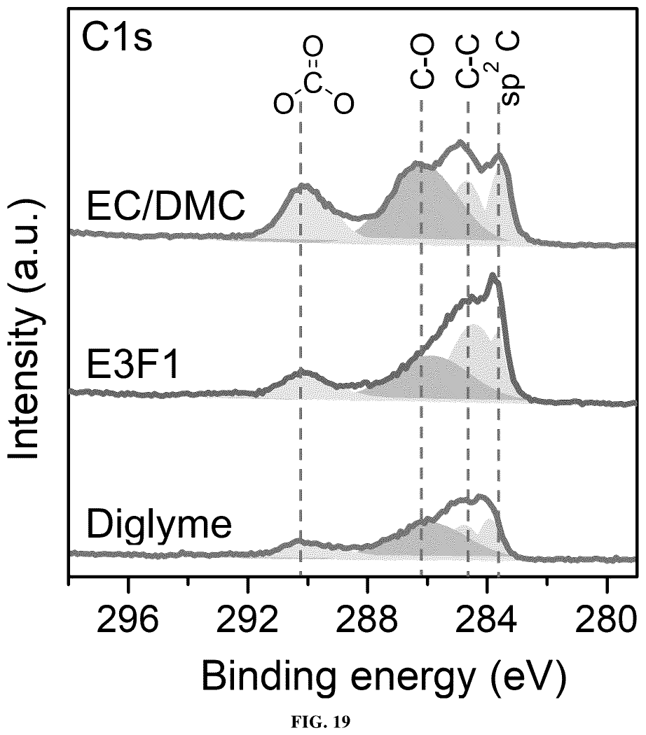

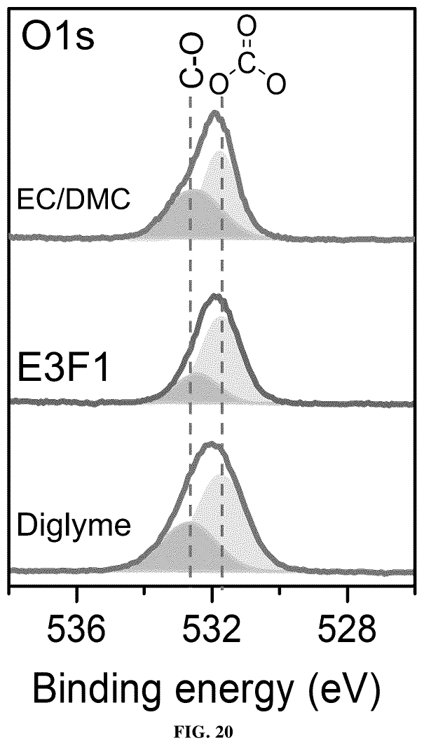

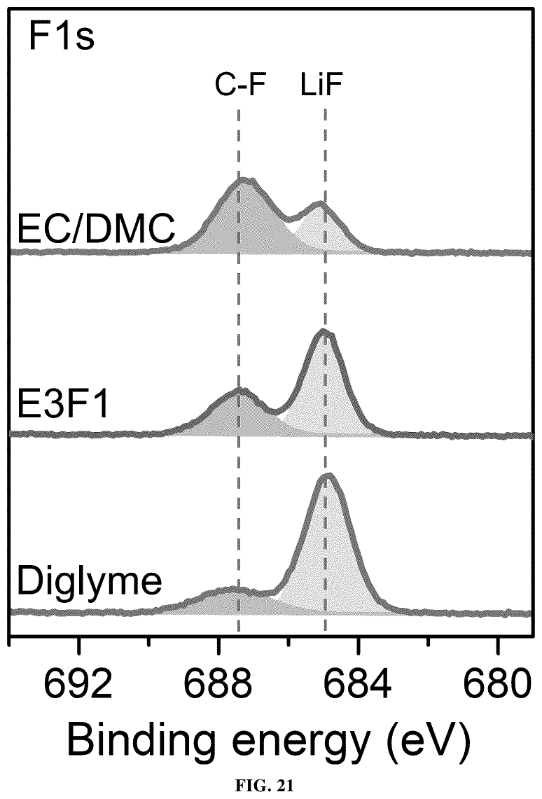

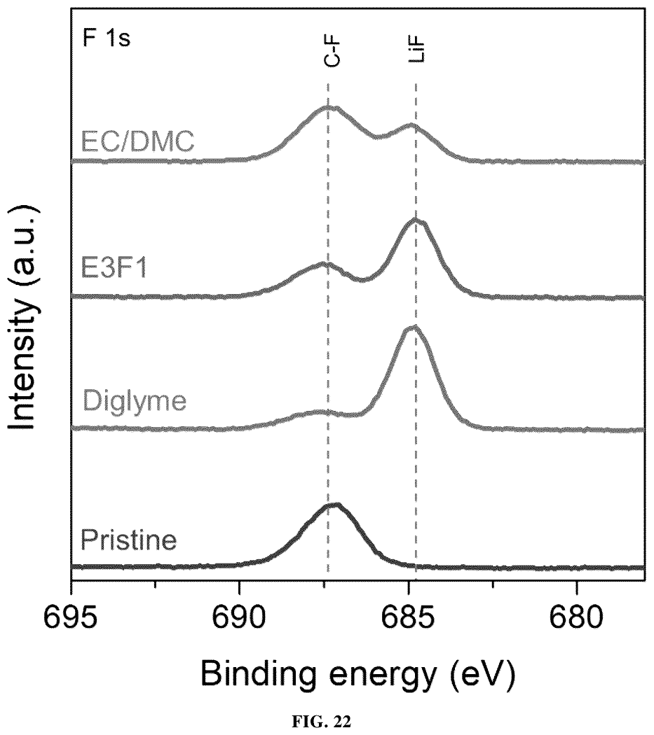

X-ray photoelectron spectroscopy (“XPS”) was used to probe the graphite SEI composition. FIGS. 19-21 illustrate the XPS spectra of graphite electrode sample retrieved from Gr/LFP cells after three formation cycles at C/20 (ending on deintercalation). In the XPS spectrum of C is (FIG. 19), EC/DMC sample demonstrated more carbonate (290.2 eV) and ether-like (286.0 eV) components generated from carbonate solvent degradation. Carbonate solvents have been known to be preferentially decomposed on the graphite surface to produce lithium (bi)carbonate salts. See S. Feng, et al. (2017). E3F1 electrolyte demonstrated intensities of C—C (284.6 eV) components higher than EC/DMC and diglyme electrolytes, which indicates that the E3F1 electrolyte molecules do degrade and contribute to a solvent-derived surface passivation layer on the graphite. However, the diglyme electrolyte demonstrated much lower intensities for solvent-derived C—C and C—O components. FIG. 20 illustrates the 0 is XPS spectra, for which EC/DMC, E3F1, and diglyme electrolytes have similar compositions, despite a slightly higher fraction of C═O (532.8 eV) for EC/DMC electrolyte. In the F 1s XPS spectra illustrated in FIG. 21, peaks of LiF (684.7 eV) and C—F (687.4 eV) were observed in each of EC/DMC, E3F1, and diglyme electrolytes. The intensity of LiF peak increases from EC/DMC to E3F1 to diglyme electrolyte, while the intensity of C—F peak decreases in the same order, the trend of which demonstrates that the salt-derived LiF component has the highest fraction in the interface with diglyme electrolyte, and the lowest fraction in the interface with EC/DMC electrolyte. For the SEI in E3F1 electrolyte, LiF may be generated from both solvent and salt degradation. FIG. 22 illustrates that the PVDF binder in graphite electrode may contribute significantly to the C—F peak, so deconvolution of E3F1-derived and salt-derived SEI components using F is XPS spectra may be difficult. The XPS study of the SEI demonstrates that the solvent-derived SEI formed in the fluoroether electrolytes of the present disclosure may have a key role in preventing solvent co-intercalation.

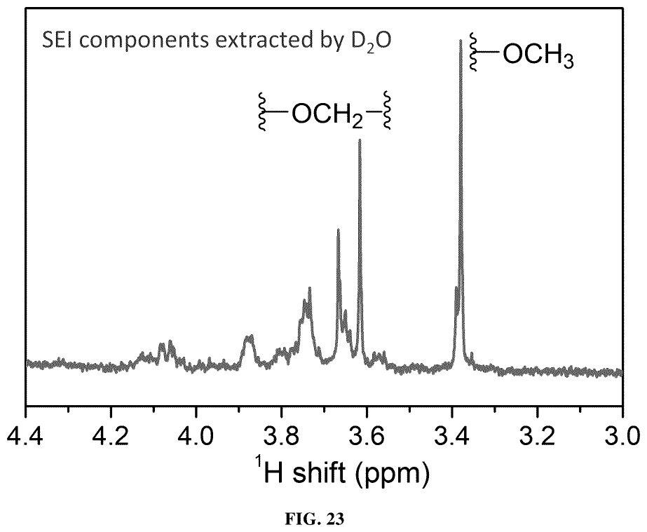

The SEI composition may be probed using NMR spectroscopy. Graphite electrodes were retrieved from Gr I E3F1 with 1 M LiFSA I LFP cells after three formation cycles at a current rate of C/20 (ending on deintercalation). After rising with anhydrous DME to remove residual salt and solvent, and drying under vacuum, cycled graphite samples were extracted by D₂O solvent, and the extract was analyzed by solution-state NMR. FIG. 23 illustrates the ¹H NMR spectra of SEI components extracted by D₂O, in which multiple peaks are observed with chemical shifts characteristic for ether-like protons. The shifts between 4.2 ppm and 3.6 ppm were assigned to —OCH₂— groups in different chemical environments, and the shifts at approximately 3.4 ppm were assigned to —OCH₃ groups. FIG. 18 illustrates that a single peak for LiF (˜123 ppm) and multiple peaks for —CF₃ groups (˜74 ppm) were detected by proton-decoupled ¹⁹F NMR. Compared to the NMR spectra of pure E3F1 electrolyte, an NMR spectrum of the organic species in D₂O extract illustrates shifts for similar functional groups, but illustrates that the species is not pristine E3F1 electrolyte. Density functional theory (“DFT”) calculations have predicted that reductive degradation of E3F1 electrolyte will generate LiF and organic fragments maintaining a structure similar to E3F1 electrolyte. While LiF was detected by ¹⁹F NMR, the other signals at approximately 74 ppm very likely correspond to E3F1-derived organic components in SEI, but it may be difficult to separate the organic components and determine the exact structures of those degradation products.

To further investigate the graphite interfacial properties, electrochemical impedence spectroscopy (“EIS”) was conducted on graphite/LiFePO₄ (Gr/LFP) cells. LFP was selected over lithium metal to minimize the influence of counter-electrode, because most electrolytes do not form resistive passivation layers at the interface with LFP. See M. Cuisinier, et al., Evolution of the LiFePO₄ positive electrode interface along cycling monitored by MAS NMR, 224 J. POWER SOURCES 50 (2013); K. Edström, et al., The cathode-electrolyte interface in the Li-ion battery, 50 ELECTROCHIMICA ACTA 397 (2004); each of which is incorporated by reference herein in its entirety. Table 1 below illustrates that E3F1 and EC/DMC electrolyte cells have similar interfacial resistance, which supports the formation of SEI in the fluoroether electrolytes of the present disclosure. By contrast, diglyme electrolyte cell demonstrates lower interfacial resistance. The absence of passivation layer at the interface of glyme electrolytes and graphite electrode is known. See H. Kim, et al. (2017). Based on the observations hereinabove, the absence of passivation layer enables solvent co-intercalation in glymes.

TABLE 1
Fitting Parameters of EIS

| | R1 | R2 | Q2 | | R3 | Q3 | | R4 | Q4 | |
|---|---|---|---|---|---|---|---|---|---|---|
| | (Ω) | (Ω) | (F s^{a-1}) | a2 | (Ω) | (F s^{a-1}) | a3 | (Ω) | (F s^{a-1}) | a4 |
| E3F1 | 20.34 | 4.09 | 2.76 · 10⁻³ | 0.30 | 21.88 | 1.26 · 10⁻³ | 0.74 | 70.97 | 1.01 · 10⁻² | 0.50 |
| EC/DMC | 4.48 | 7.02 | 9.67 · 10⁻⁶ | 0.92 | 16.12 | 4.15 · 10⁻³ | 0.54 | 68.4 | 1.80 · 10⁻² | 0.81 |
| Diglyme | 4.80 | 7.12 | 1.16 · 10⁻³ | 0.54 | 13.89 | 6.14 · 10⁻⁶ | 0.82 | 78.95 | 1.99 · 10⁻³ | 0.53 |

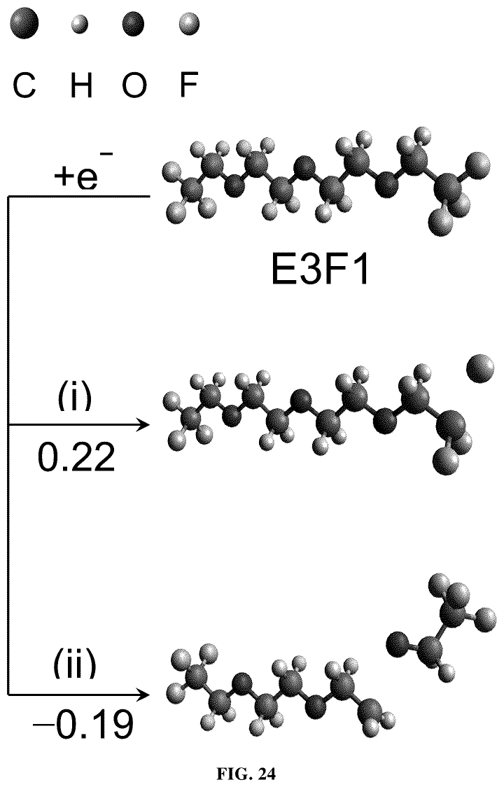

To explore the SEI formation mechanism in fluoroether electrolytes, reductive degradation of the electrolytes was simulated by DFT calculations. As used herein, the term “adiabatic reduction potential” refers to the electrochemical potential of single electron reduction (M+e⁻→M⁻), in which the geometry of product (M-) is optimized. EC has a calculated reduction potential of 0.62 V_{Li}, which means that the reduction of EC is favored to occur before and during graphite lithiation. The reductive degradation of EC is known to passivate the graphite electrode and give rise to a solvent-derived SEI. See M. Nie, et al. (2013). By contrast, diglyme illustrates a reduction potential of −0.70 V_{Li}, indicating that diglyme electrolyte is thermodynamically stable at the operation potential of the graphite electrode. The relatively good reductive stability of diglyme electrolyte explains the deficiency of diglyme in passivating the graphite electrode. After fluorination, the reductive potential of E3F1 increases to 0.22 V_{Li} and −0.19 V_{Li} based on different degradation pathways, illustrated in FIG. 24. The reductive degradation of E3F1 electrolyte provides for graphite electrode passivation and enables reversible lithium (de)intercalation. FIG. 24 illustrates that the cleavage of the C—F bond (i) may be the most favorable reduction pathway of E3F1 electrolyte and may be responsible for its positive reduction potential, but the cleavage of C—O bond (ii) may also be possible because it leads to a reduction potential close to 0 V_{Li}. EC may be predicted to have higher reduction potential than E3F1 electrolyte by DFT calculations but dQ/dV plots (FIGS. 4 and 5) illustrate that SEI formation in E3F1 electrolyte starts at higher voltage than EC/DMC electrolyte. Without being bound by theory, it is believed that EC electrolyte has a higher reduction potential while SEI Formation in E3F1 electrolyte starts at higher voltage because the DFT calculations exclude salt effects and kinetic factors beyond thermodynamic potentials.

### XI. Comparison of Other Electrolytes for Lithium-Ion Batteries.

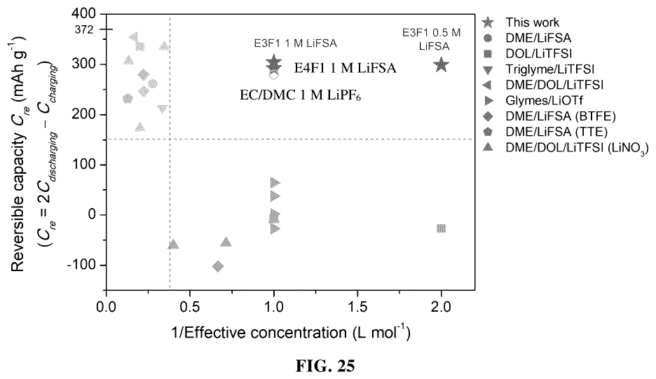

Fluoroether electrolytes of the present disclosure constitute the only group of ether solvents that achieve outstanding performance with graphite electrode at conventional salt concentrations, and similarly to commercial carbonate electrolytes. Most ether electrolytes with conventional salt concentrations demonstrate poor performance with graphite, as represented by the grey symmols in the bottom right corner of FIG. 25. High (effective) salt concentrations are required for ether-based HCEs and LHCEs so as to enable high reversible capacity. Reversible capacity, calculated by doubling the deintercalation capacity and subtracting the intercalation capacity, was extracted from first cycle data of Li/Gr cells in the following references, each of which is incorporated by reference herein in its entirety: DME/LiFSA (Y. Yamada, et al., A superconcentrated ether electrolyte for fast-charging Li-ion batteries, 49 CHEM. COMMUN. 11194 (2013)); DOL/LiTFSI (D. Lu, et al., Formation of Reversible Solid Electrolyte Interface on Graphite Surface from Concentrated Electrolytes, 17 NANO LETT. 1602 (2017)); triglyme/LiTFSI (H. Moon, et al., Mechanism of Li Ion Desolvation at the Interface of Graphite Electrode and Glyme-Li Salt Solvate Ionic Liquids, 118 J. PHYS. CHEM. C 20246 (2014)); DME/DOL/LiTFSI (P. Zeng, et al., A stable graphite electrode in superconcentrated LiTFSI-DME/DOL electrolyte and its application in lithium-sulfur full battery, 95 MATER. RES. BULL. 61 (2017)); Glymes/LiOTf (B. Jache, et al., (2016)); DME/LiFSA(BTFE) (L.-L., Jiang, et al., Inhibiting Solvent Co-Intercalation in a Graphite Anode by a Localized High-Concentration Electrolyte in Fast-Charging Batteries, 60 ANGEW. CHEMIE INT. ED. 3402 (2021)); DME/LiFSA(TTE) (H. Jia, et al., Enabling Ether-Based Electrolytes for Long Cycle Life of Lithium-Ion Batteries at High Charge Voltage, 12 ACS APPL. MATER. INTERFACES 54893 (2020)); and DME/DOL/LiTFSI(LiNO₃) (J. Ming, et al., New Insights on Graphite Anode Stability in Rechargeable Batteries: Li Ion Coordination Structures Prevail over Solid Electrolyte Interphases, 3 ACS ENERGY LETT. 335 (2018)). To account for the realistic solvation structure, as used herein, the term “effective concentration” refers to a molar concentration of solvating solvent such that diluents such as bis(2,2,2-trifluoroethyl)ether (“BTFE”) and 1,1,2-trichloro-1,2,2-trifluoroethane (“TTE”) are repelled. Accordingly, effective concentration corresponds to the reported salt concentration for most cases. For LHCEs specifically, effective concentration is estimate from the calculation: (moles of salt)/(volume of solvating solvent).

Most ether solvents co-intercalate into graphite at conventional concentrations (<3 M), which leads to reversible capacity below 150 mAh g⁻¹. To suppress ether solvent co-intercalation, high salt concentrations were typically used (HCEs). For localized high-concentration electrolytes (LHCEs), although superficial concentration is close to 1.5 M, the effective concentration is still as high as for HCEs, because the diluents cannot dissolve any salt. Only the fluoroether electrolytes of the present disclosure achieve high reversible capacities (approximately 300 mAh g⁻¹) at effective concentration close to 1M, similarly to commercial carbonates. Additionally, the mechanism of preventing solvent co-intercalation may be different between the fluoroether electrolytes of the present disclosure and HCEs or LHCEs as evidenced by SEI composition: fluoroethers passivate graphite electrode with solvent-derived SEI, while HCEs and LHCEs have been reported to produce an anion-derived SEI. See X. Zhang, et al. (2020); H. Jia, et al. (2020). Therefore, the fluoroether electrolytes of the present disclosure may inherently suppress solvent co-intercalation without the need of high salt concentration.

### XII. Novel Fluoroether Electrolytes.

It is expected that spectroscopic and spectrometric characterization, such as by ¹H and/or ¹³C nuclear magnetic resonance, FTIR spectroscopy, and/or mass spectrometry will demonstrate syntheses and purifications of compositions including the following novel fluoroether electrolyte compounds: compounds of formula (III):

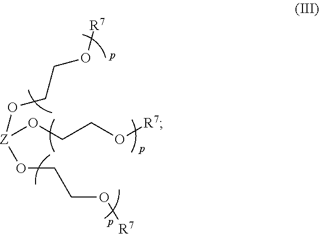

wherein each R⁷ is a fluoro-substituted C₂-C₆ alkyl group; Z is B, Al, or P═O; and p is 0, 1, 2, 3, 4, or 5; including, but not limited to, the following compounds:

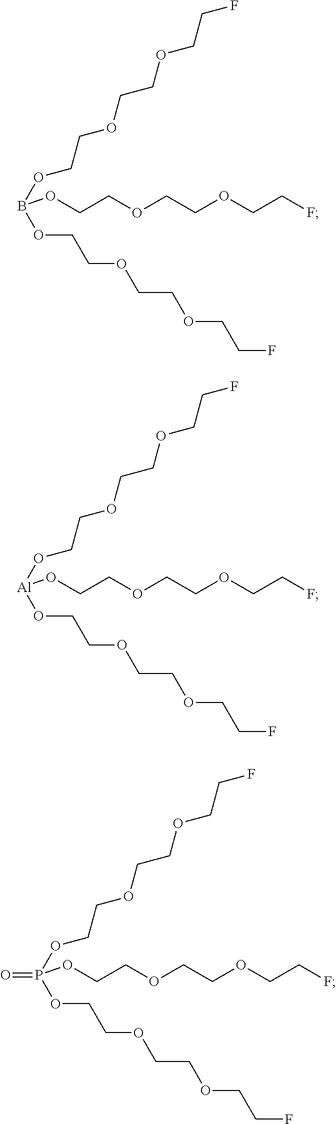

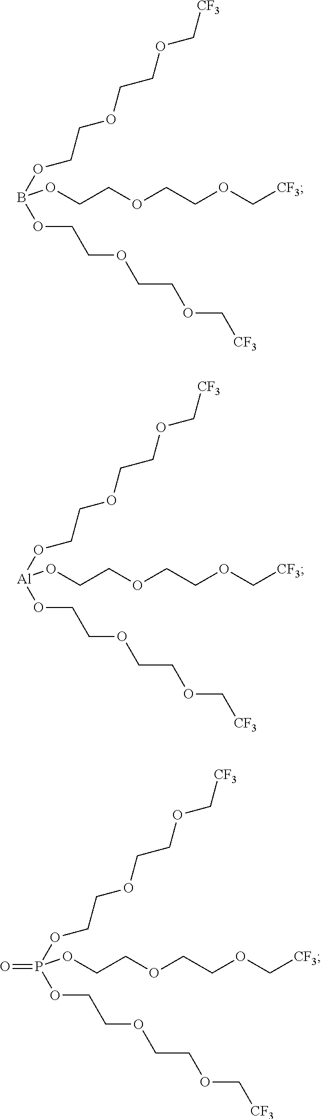

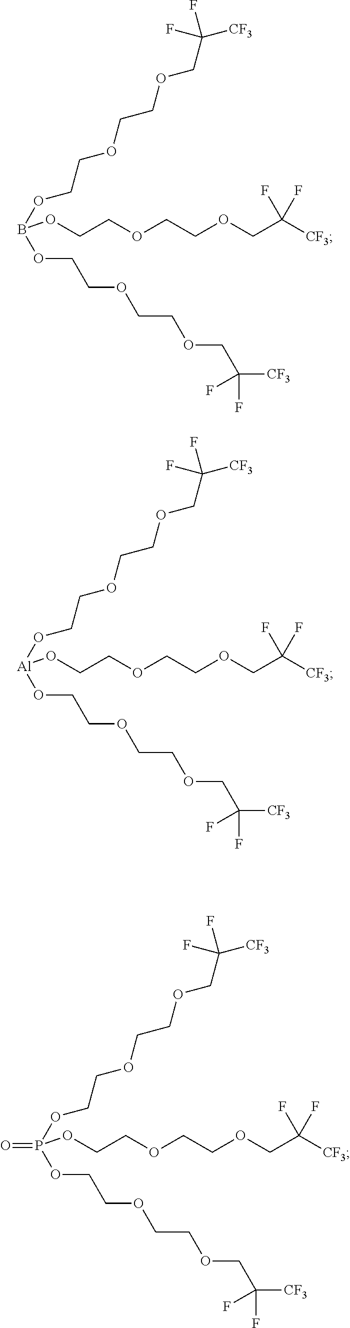

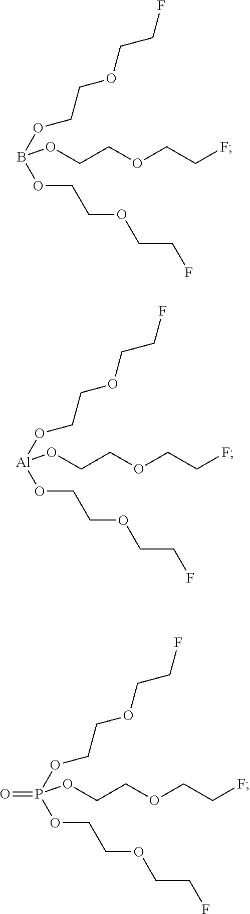

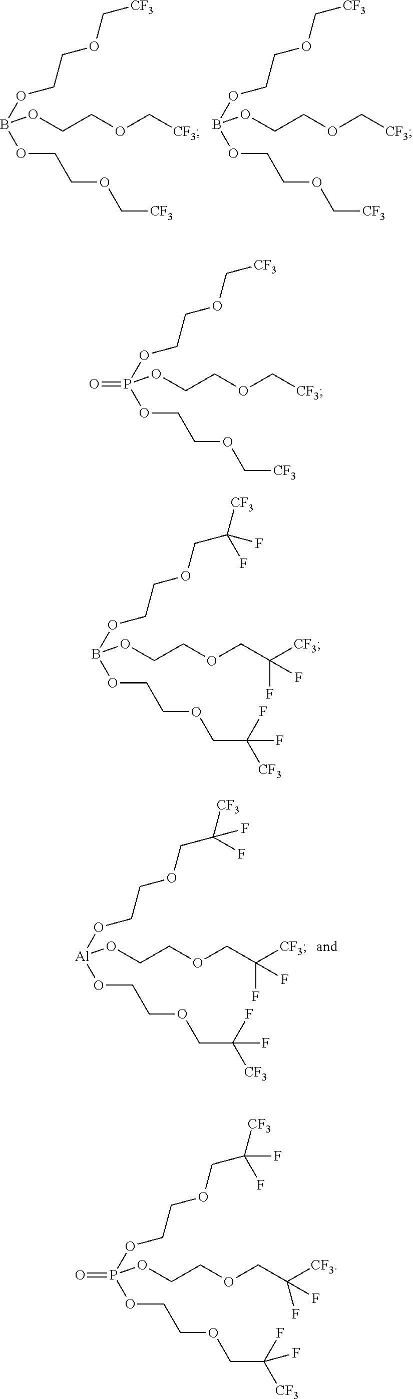

Further, it is expected that spectroscopic and spectrometric characterization, such as by ¹H and/or ¹³C nuclear magnetic resonance, FTIR spectroscopy, and/or mass spectrometry will demonstrate syntheses and purifications of compositions including novel fluoroether electrolyte compounds selected from the group consisting of:

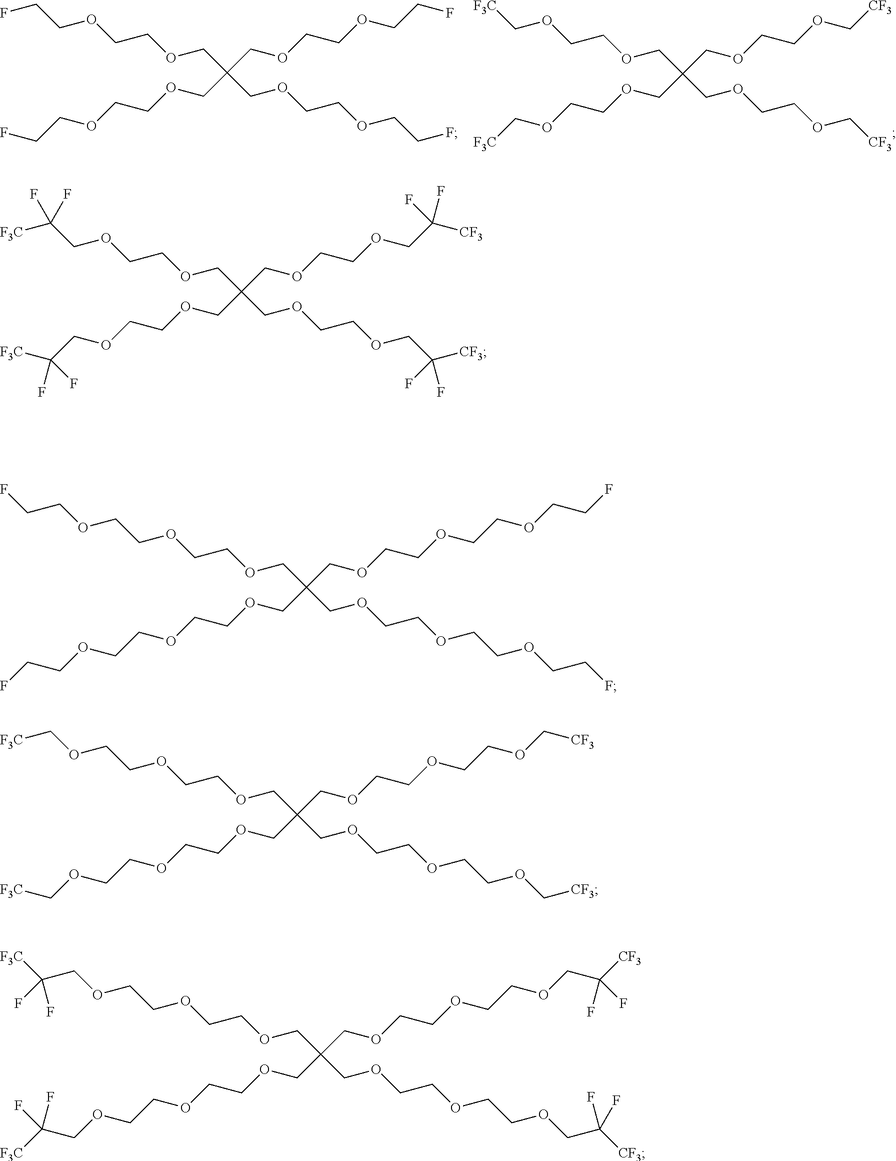

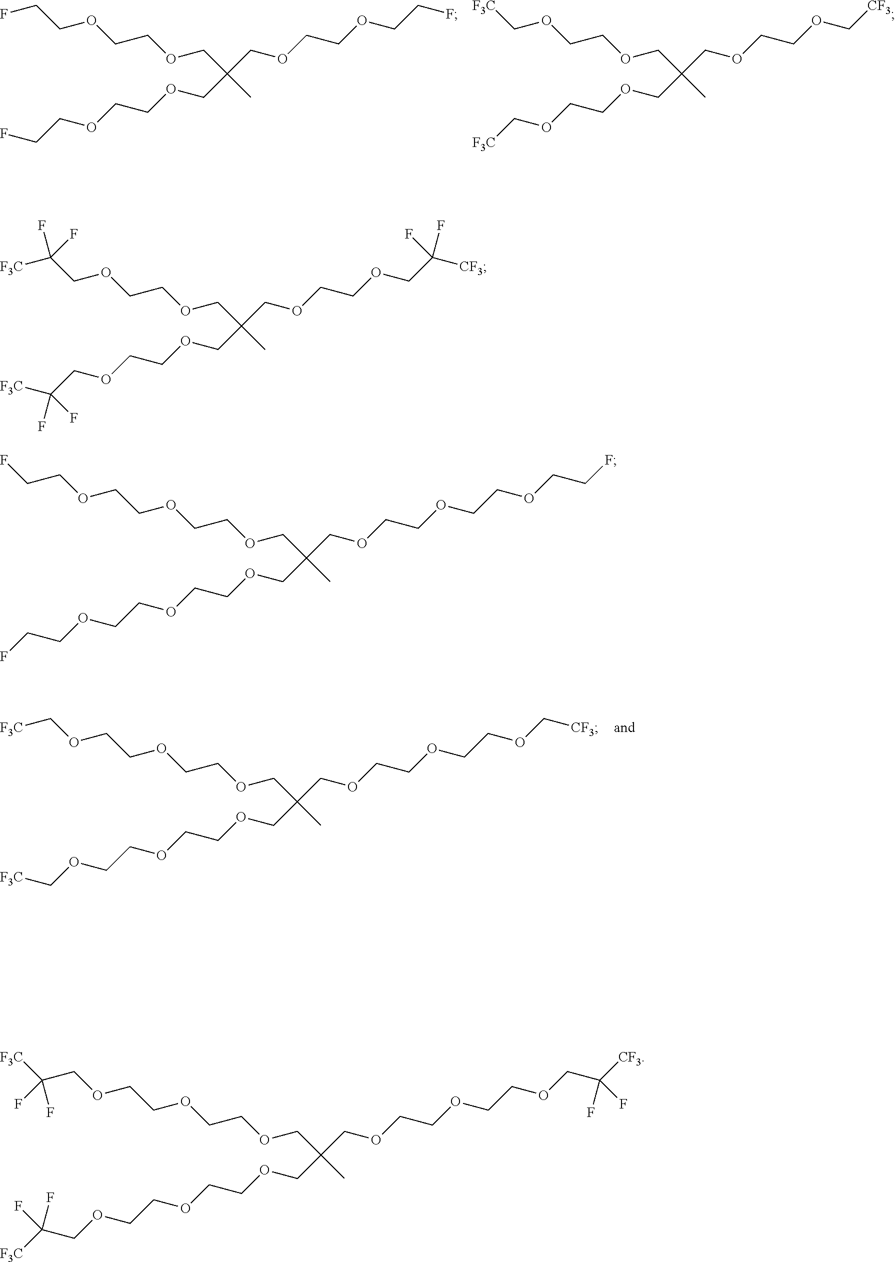

Although the present disclosure has been described with reference to examples and the accompanying drawings, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to a lithium-ion cell, comprising: a first electrode comprising lithium metal or lithium iron phosphate (LeFePO₄); a second electrode comprising graphite; a fluoroether electrolyte comprising one or more compounds of formulae (I), (II), and/or (III):

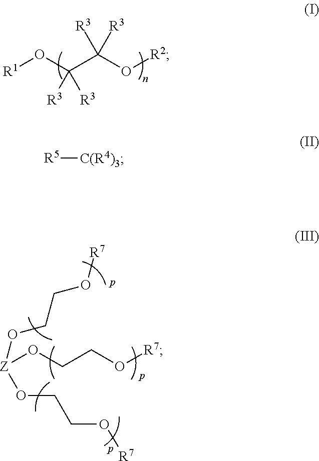

wherein R¹ is a fluoro-substituted C₂-C₆ alkyl group; R² is a C₂-C₆ alkyl group or a fluoro-substituted C₂-C₆ alkyl group; each R³ independently is H, F, methyl, or fluoro-substituted methyl; n is 0, 1, 2, 3, 4, or 5; each R⁴ is —CH₂—(OCH₂CH₂)ₘ—OR⁶; R⁵ is methyl or R⁴; R⁶ is a fluoro-substituted C₂-C₆ alkyl group; m is 0, 1, 2, 3, 4, or 5; each R⁷ is a fluoro-substituted C₂-C₆ alkyl group; Z is B, Al, or P═O; and p is 0, 1, 2, 3, 4, or 5.

A second aspect relates to the lithium-ion cell of aspect 1, wherein the fluoroether electrolyte comprises one or more compounds of formula (I):

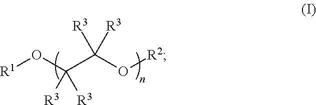

wherein R¹ is a fluoro-substituted C₂-C₆ alkyl group; R² is a C₂-C₆ alkyl group or a fluoro-substituted C₂-C₆alkyl group; each R³ independently H, F, methyl, or fluoro-substituted methyl; and n is 0, 1, 2, 3, 4, or 5.

A third aspect relates to the lithium-ion cell of any preceding aspect, wherein the fluoroether electrolyte comprises one or more compounds selected from 1,1,1-trifluoro-2-(2-(2-(2,2,2-trifluoroethoxy)ethoxy)ethoxy)ethane (E3F1), 1,1,1,14,14,14-hexafluoro-3,6,9,12-tetraoxatetradecane (E4F1), 1,1,1,17,17,17-hexafluoro-3,6,9,12,15-pentaoxaheptadecane (E5F1), 1,1,1,20,20,20-hexafluoro-3,6,9,12,15,18-hexaoxaicosane (E6F1), 1,1,1,2,2-pentafluoro-3-(2-(2-(2,2,3,3,3-pentafluoropropoxy)ethoxy)ethoxy)propane (E3F2), 1,1,1,2,2,15,15,16,16,16-decafluoro-4,7,10,13-tetraoxahexadecane (E4F2), 1,1,1,2,2,18,18,19,19,19-decafluoro-4,7,10,13,16-pentaoxanonadecane (E5F2), 1,1,1,2,2,21,21,22,22,22-decafluoro-4,7,10,13,16,19-hexaoxadocosane (E6F2), 1-fluoro-2-(2-(2-(2-fluoroethoxy)ethoxy)ethoxy)ethane, 1,14-difluoro-3,6,9,12-tetraoxatetradecane, 1,17-difluoro-3,6,9,12,15-pentaoxaheptadecane, 1,20-difluoro-3,6,9,12,15,18-hexaoxaicosane, 2-(2-(2-(2,2-difluoroethoxy)ethoxy)ethoxy)-1,1-difluoroethane, 1,1,14,14-tetrafluoro-3,6,9,12-tetraoxatetradecane, 1,1,17,17-tetrafluoro-3,6,9,12,15-pentaoxaheptadecane, and 1,1,20,20-tetrafluoro-3,6,9,12,15,18-hexaoxaicosane.

A fourth aspect relates to the lithium-ion cell of aspect 1, wherein the fluoroether electrolyte comprises one or more compounds of formula (II):

R⁵—C(R⁴)₃ (II);
wherein each R⁴ is —CH₂—(OCH₂CH₂)ₘ—OR⁶; R⁵ is methyl or R⁴; R⁶ is a fluoro-substituted C₂-C₆ alkyl group; and m is 0, 1, 2, 3, 4, or 5.

A fifth aspect relates to the lithium-ion cell of aspects 1 or 4, wherein the fluoroether electrolyte comprises one or more compounds selected from 1,15-difluoro-8,8-bis((2-(2-fluoroethoxy)ethoxy)methyl)-3,6,10,13-tetraoxapentadecane, 1,1,1,15,15,15-hexafluoro-8,8-bis((2-(2,2,2-trifluoroethoxy)ethoxy)methyl)-3,6,10,13-tetraoxapentadecane, 1,1,1,2,2,16,16,17,17,17-decafluoro-9,9-bis((2-(2,2,3,3,3-pentafluoropropoxy)ethoxy)methyl)-4,7,11,14-tetraoxaheptadecane, 1,21-difluoro-11,11-bis((2-(2-(2-fluoroethoxy)ethoxy)ethoxy)methyl)-3,6,9,13,16,19-hexaoxahenicosane, 1,1,1,21,21,21-hexafluoro-11,11-bis((2-(2-(2,2,2-trifluoroethoxy)ethoxy)ethoxy)methyl)-3,6,9,13,16,19-hexaoxahenicosane, 1,1,1,2,2,22,22,23,23,23-decafluoro-12,12-bis((2-(2-(2,2,3,3,3-pentafluoropropoxy)ethoxy)ethoxy)methyl)-4,7,10,14,17,20-hexaoxatricosane, 1,5-difluoro-8-((2-(2-fluoroethoxy)ethoxy)methyl)-8-methyl-3,6,10,13-tetraoxapentadecane, 1,1,1,15,15,15-hexafluoro-8-methyl-8-((2-(2,2,2-trifluoroethoxy)ethoxy)methyl)-3,6,10,13-tetraoxapentadecane, 1,1,1,2,2,16,16,17,17,17-decafluoro-9-methyl-9-((2-(2,2,3,3,3-pentafluoropropoxy)ethoxy)methyl)-4,7,11,14-tetraoxaheptadecane, 1,21-difluoro-11-((2-(2-(2-fluoroethoxy)ethoxy)ethoxy)methyl)-11-methyl-3,6,9,13,16,19-hexaoxahenicosane, 1,1,1,21,21,21-hexafluoro-11-methyl-11-((2-(2-(2,2,2-trifluoroethoxy)ethoxy)ethoxy)methyl)-3,6,9,13,16,19-hexaoxahenicosane, and 1,1,1,2,2,22,22,23,23,23-decafluoro-12-methyl-12-((2-(2-(2,2,3,3,3-pentafluoropropoxy)ethoxy)ethoxy)methyl)-4,7,10,14,17,20-hexaoxatricosane.

A sixth aspect relates to the lithium-ion cell of aspect 1, wherein the fluoroether electrolyte comprises one or more compounds of formula (III):

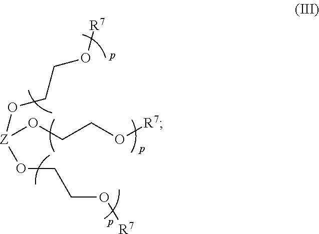

wherein each R⁷ is a fluoro-substituted C₂-C₆ alkyl group; Z is B, Al, or P═O; and p is 0, 1, 2, 3, 4, or 5.

A seventh aspect relates to the lithium-ion cell of aspects 1 or 6, wherein the fluoroether electrolyte comprises one or more compounds selected from tris(2-(2-(2-fluoroethoxy)ethoxy)ethyl) borate, tris(2-(2-(2-fluoroethoxy)ethoxy)ethoxy)aluminum, tris(2-(2-(2-fluoroethoxy)ethoxy)ethyl) phosphate, tris(2-(2-(2,2,2-trifluoroethoxy)ethoxy)ethyl) borate, tris(2-(2-(2,2,2-trifluoroethoxy)ethoxy)ethoxy)aluminum, tris(2-(2-(2,2,2-trifluoroethoxy)ethoxy)ethyl) phosphate, tris(2-(2-(2,2,3,3,3-pentafluoropropoxy)ethoxy)ethyl) borate, tris(2-(2-(2,2,3,3,3-pentafluoropropoxy)ethoxy)ethoxy)aluminum, tris(2-(2-(2,2,3,3,3-pentafluoropropoxy)ethoxy)ethyl) phosphate, tris(2-(2-fluoroethoxy)ethyl) borate, tris(2-(2-fluoroethoxy)ethoxy)aluminum, tris(2-(2-fluoroethoxy)ethyl) phosphate, tris(2-(2,2,2-trifluoroethoxy)ethyl) borate, tris(2-(2,2,2-trifluoroethoxy)ethoxy)aluminum, tris(2-(2,2,2-trifluoroethoxy)ethyl) phosphate, tris(2-(2,2,3,3,3-pentafluoropropoxy)ethyl) borate, tris(2-(2,2,3,3,3-pentafluoropropoxy)ethoxy)aluminum, and tris(2-(2,2,3,3,3-pentafluoropropoxy)ethyl) phosphate.

An eighth aspect relates to the lithium-ion cell of any preceding aspect, wherein a lithium salt is dissolved in the fluoroether electrolyte.

A ninth aspect relates to the lithium-ion cell of any preceding aspect, wherein during cycling, the lithium-ion cell is configured to promote lithium intercalation and (de)intercalation within graphite without fluoroether co-intercalation.

A tenth aspect relates to the lithium-ion cell of aspect 1, wherein the fluoroether electrolyte comprises one or more compounds selected from:

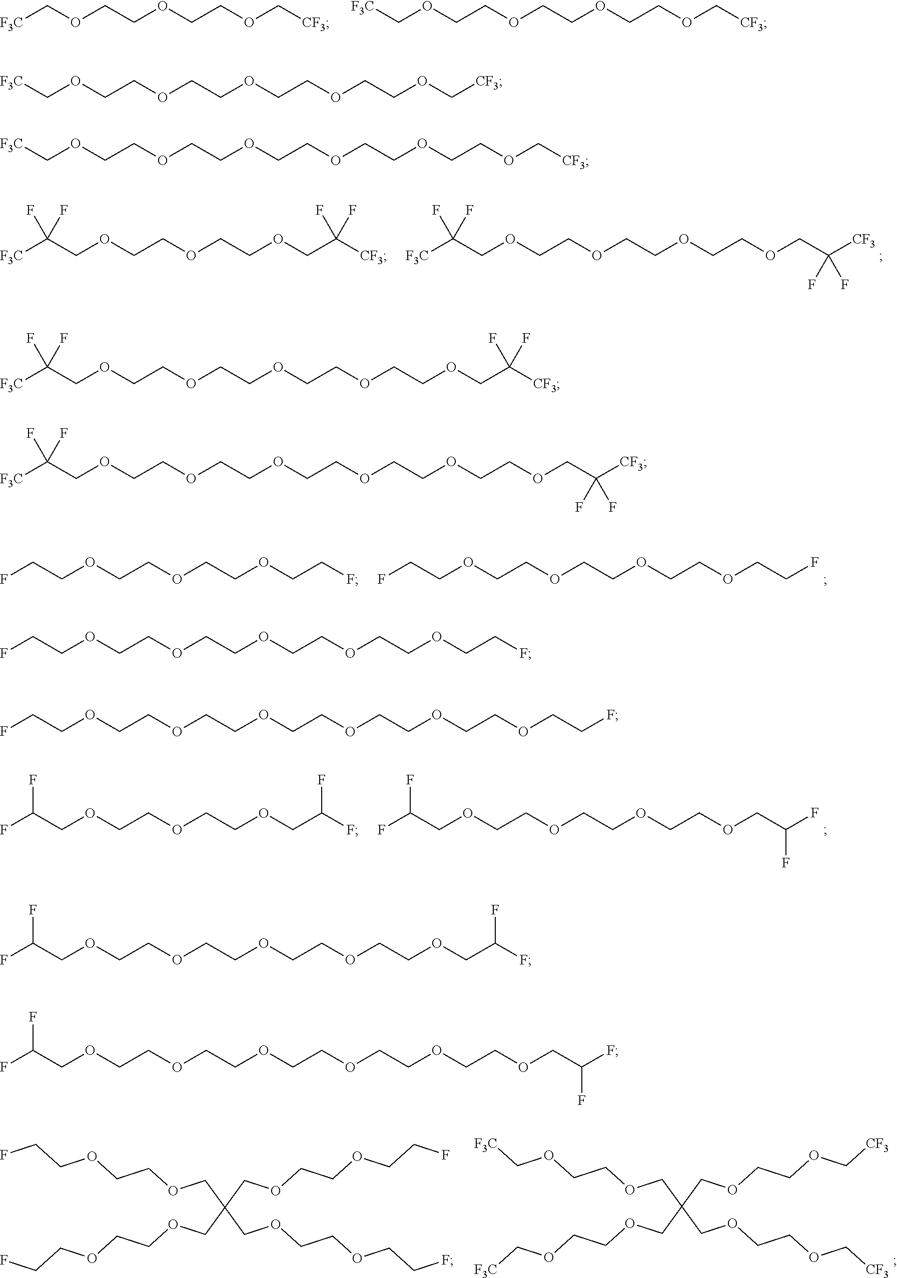

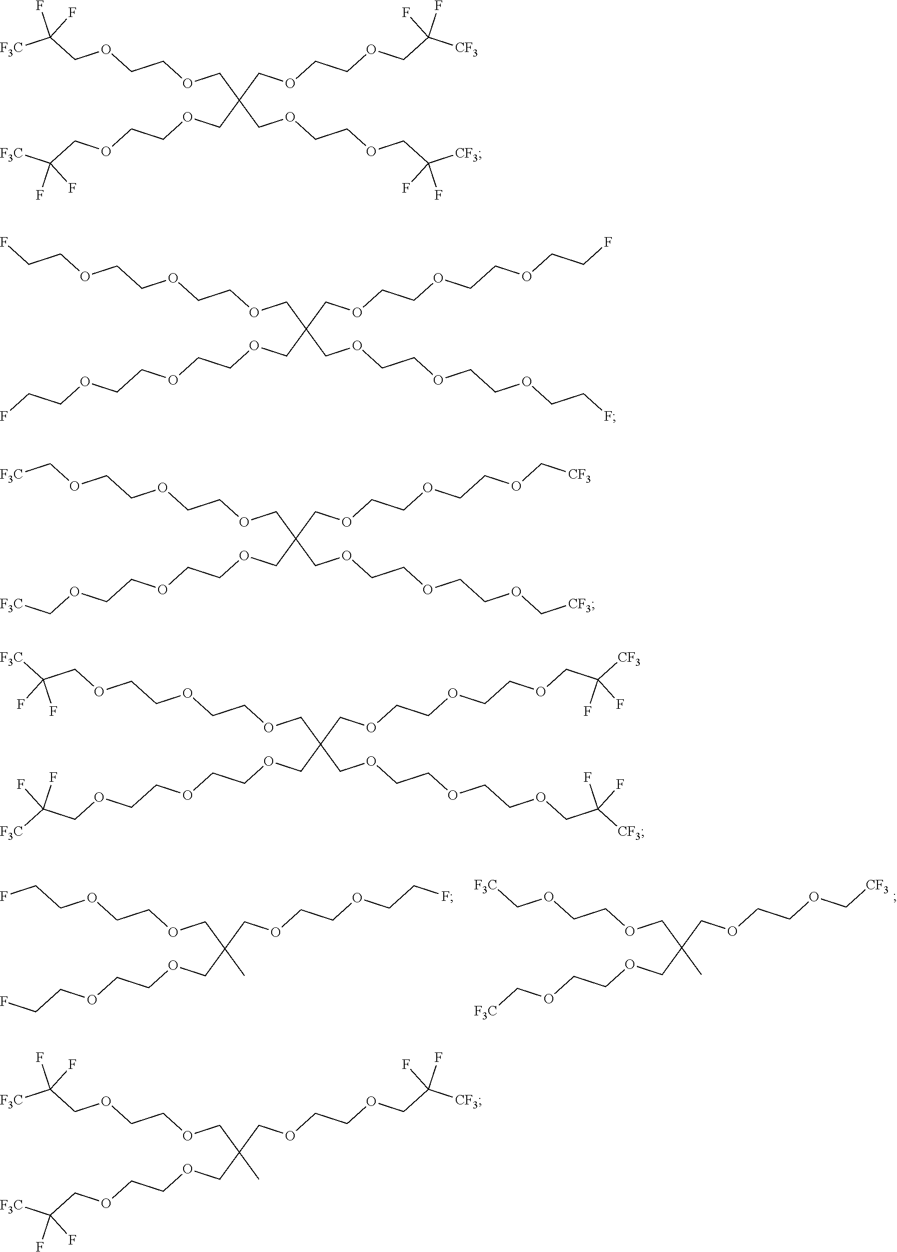

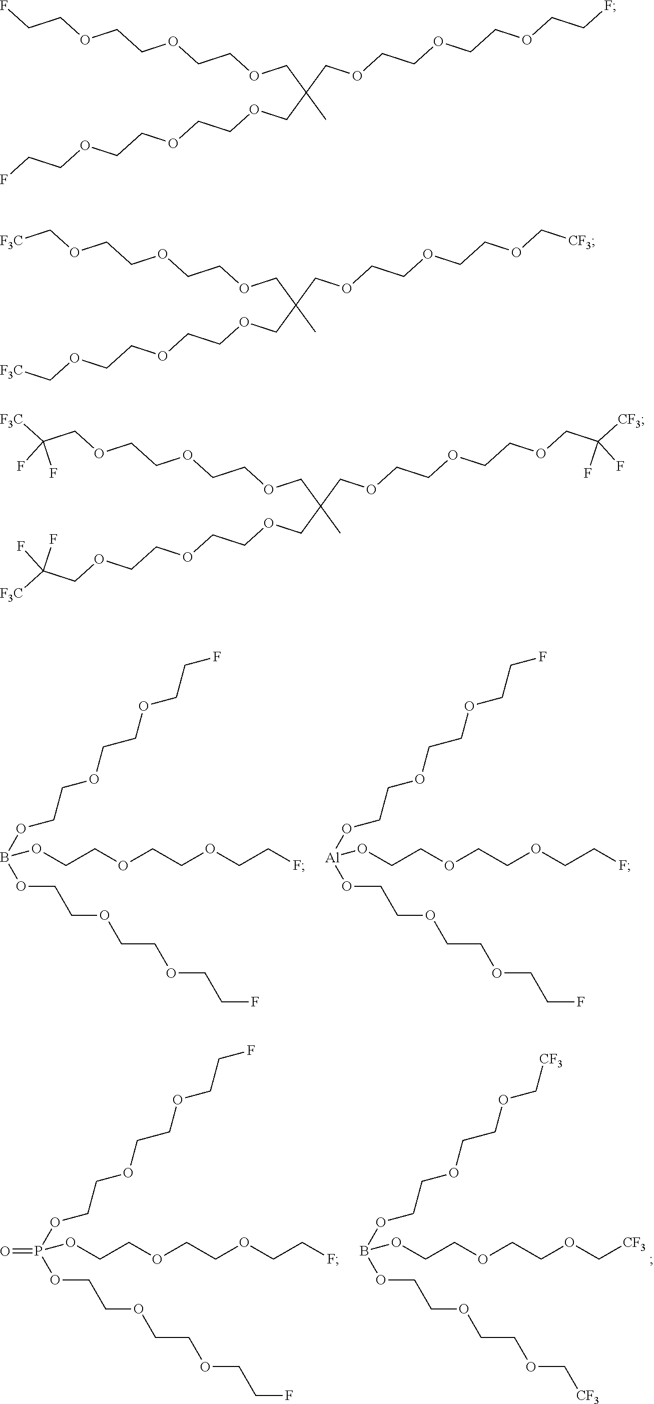

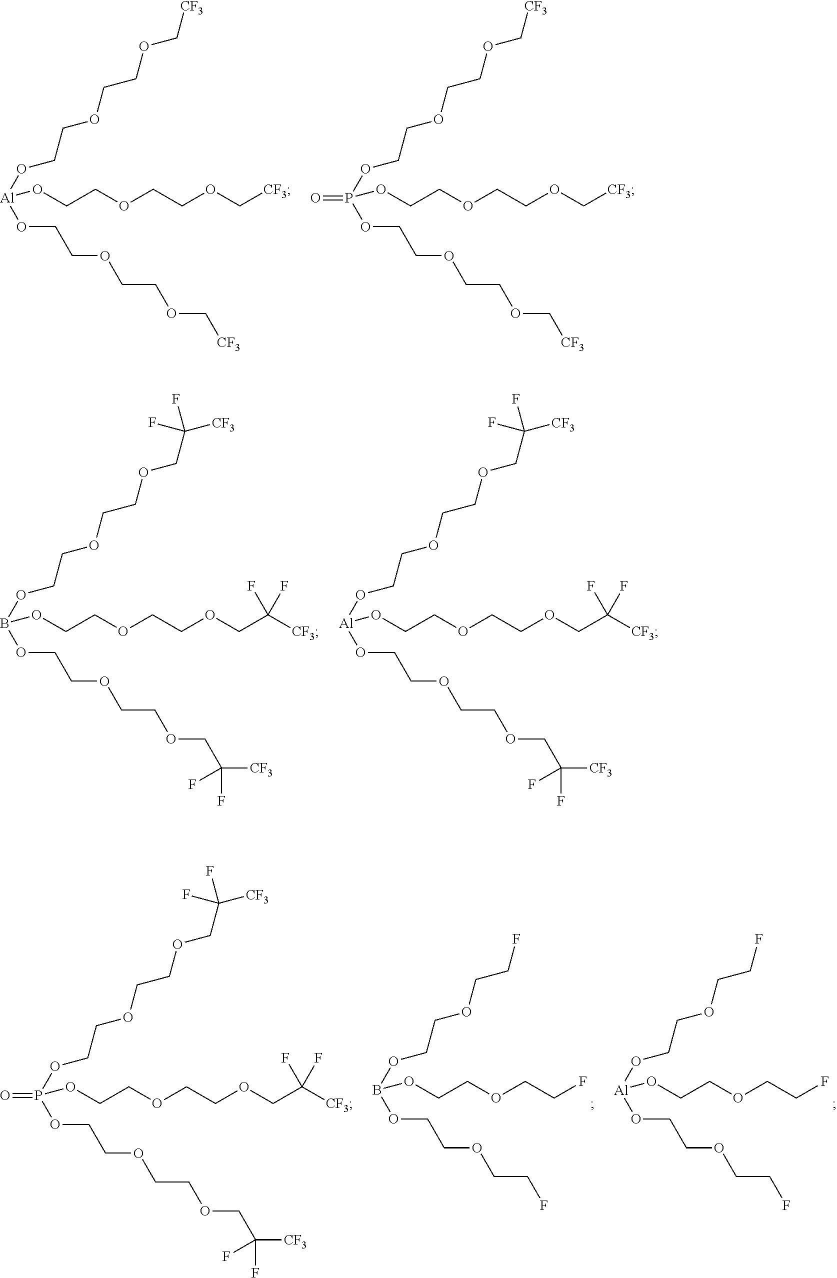

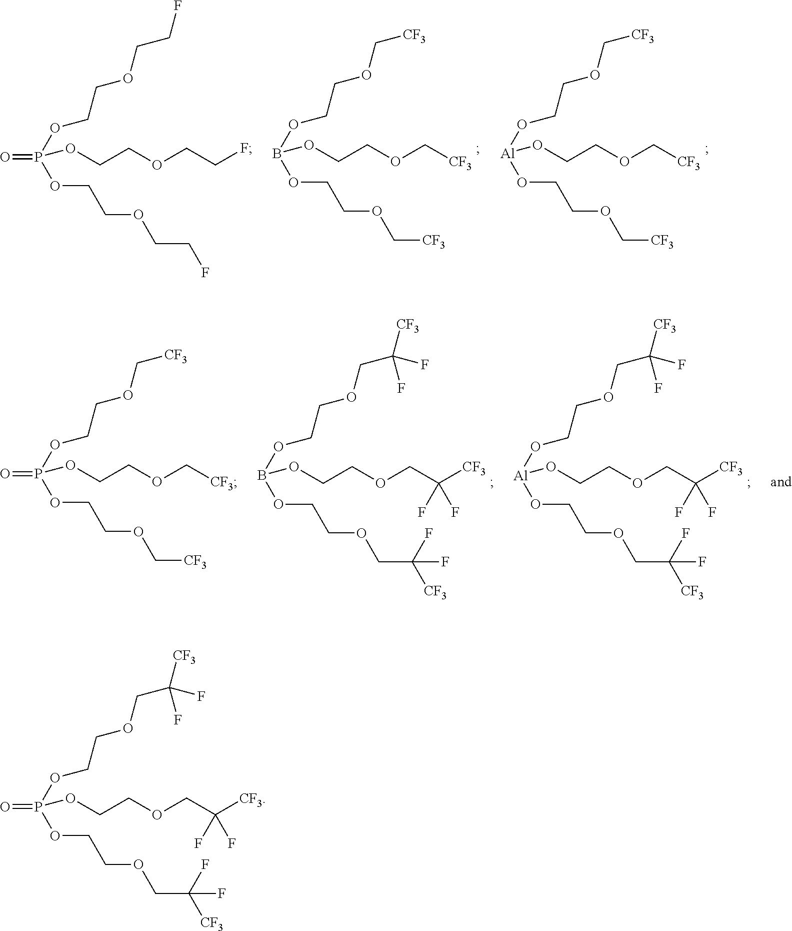

An eleventh aspect relates to the lithium-ion cell of any preceding aspect, wherein the lithium salt is selected from the group consisting of lithium bis(fluorosulfonyl)amide (LiFSA), LiTFSI, LiOTf, LiNO₃, LiPF₆, lithium bis(oxalato)borate (LiBOB), lithium difluoro(oxalato)borate (LiDFOB), LiBF₄, and LiClO₄.

A twelfth aspect relates to the lithium-ion cell of any preceding aspect, wherein the molarity of the lithium salt in the fluoroether electrolyte is from about 0.1 M to about 5.0 M.

A thirteenth aspect relates to the lithium-ion cell of any preceding aspect, wherein during cycling, the lithium-ion cell is configured to retain at least 80% capacity between a temperature range of from about −20° C. to about 600 C.

A fourteenth aspect relates to the lithium-ion cell of any preceding aspect, wherein the lithium-ion cell is configured to maintain a first-cycle coulombic efficiency of at least 85%.

A fifteenth aspect relates to the lithium-ion cell of any preceding aspect, wherein the lithium-ion cell is configured to produce graphite intercalation compounds.

A sixteenth aspect relates to a battery, comprising a plurality of lithium-ion cells of any preceding aspect, wherein the plurality of lithium-ion cells are connected in series or in parallel.

A seventeenth aspect relates to a process for preparing a lithium-ion cell of any preceding aspect, comprising: dissolving a lithium salt in a fluoroether electrolyte comprising one or more compounds of formulae (I), (II), and/or (III) so as to provide a solution; and adding the solution to a cell comprising a first electrode comprising lithium metal and a second electrode comprising graphite.

An eighteenth aspect relates to a composition comprising one or more compounds of formula (III):

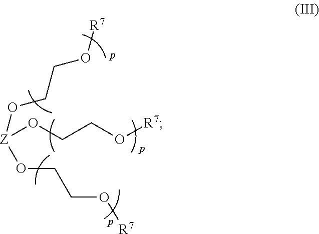

wherein each R⁷ is a fluoro-substituted C₂-C₆ alkyl group; Z is B, Al, or P═O; and p is 0, 1, 2, 3, 4, or 5.

A nineteenth aspect relates to the composition of aspect 18, wherein the one or more compounds is selected from consisting of:

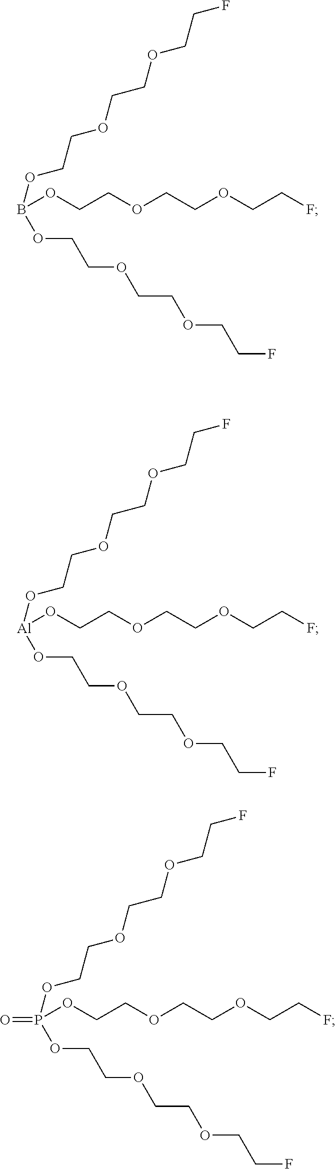

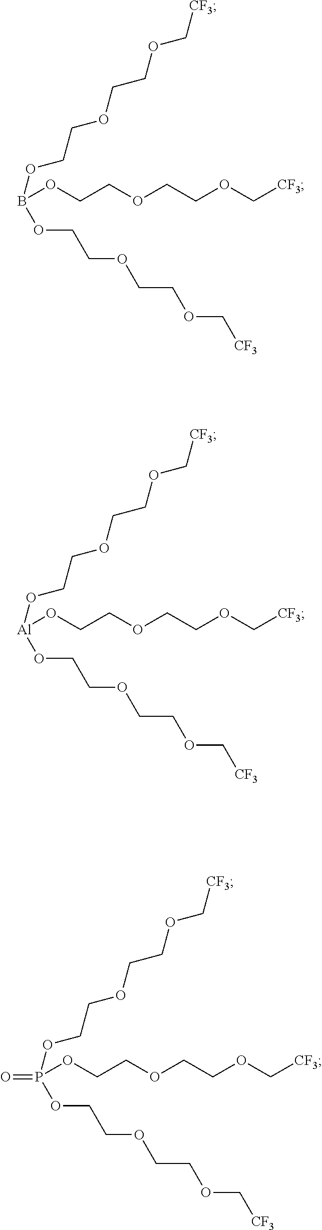

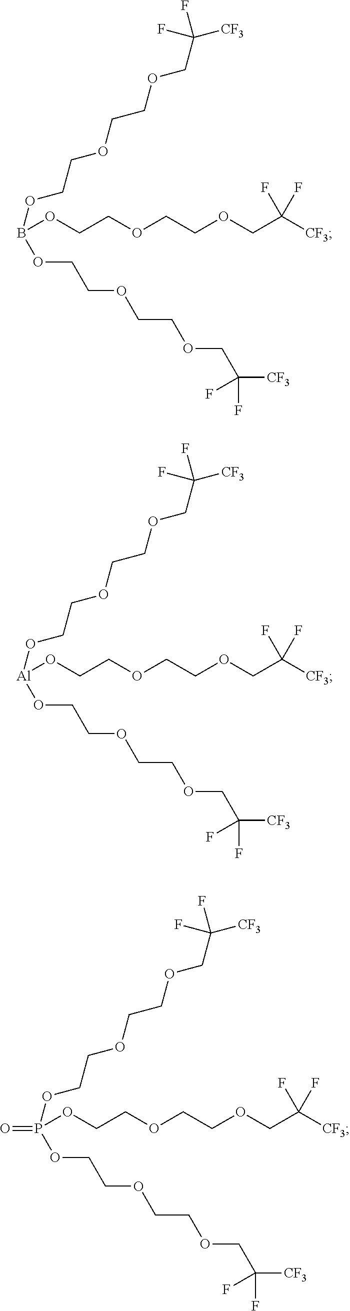

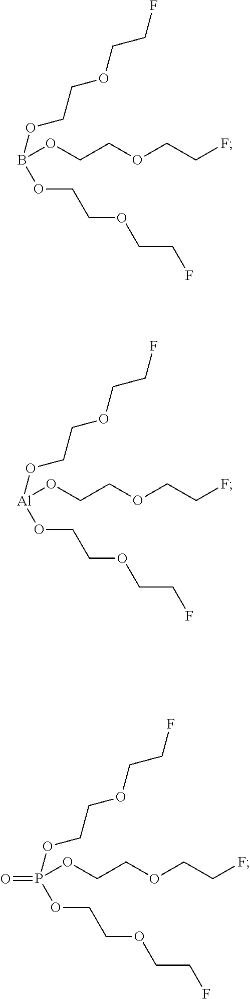

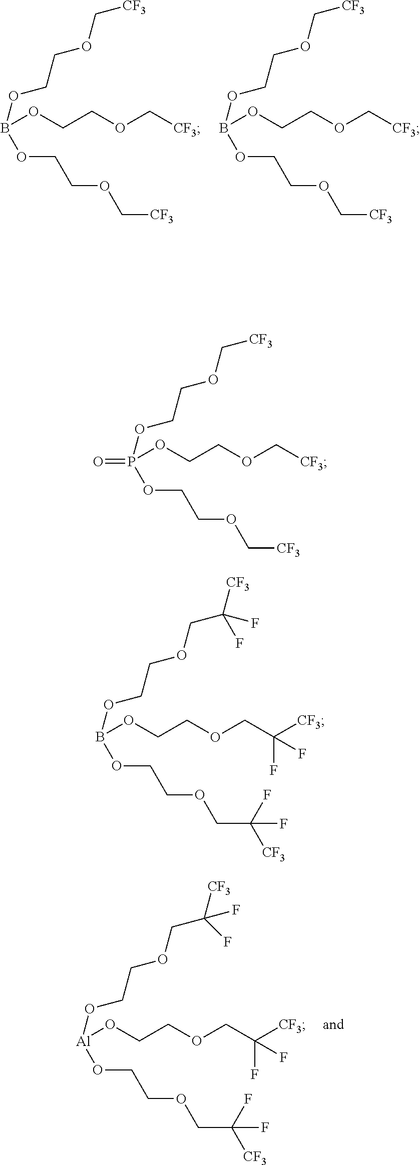

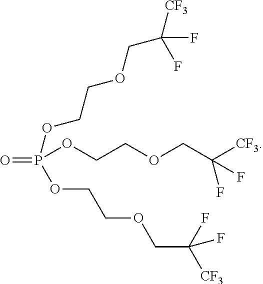 [SMILES: O=P(OCCOCC(F)(F)C(F)(F)F)(OCCOCC(F)(F)C(F)(F)F)OCCOCC(F)(F)C(F)(F)F]

A twentieth aspect relates to a composition comprising one or more compounds selected from:

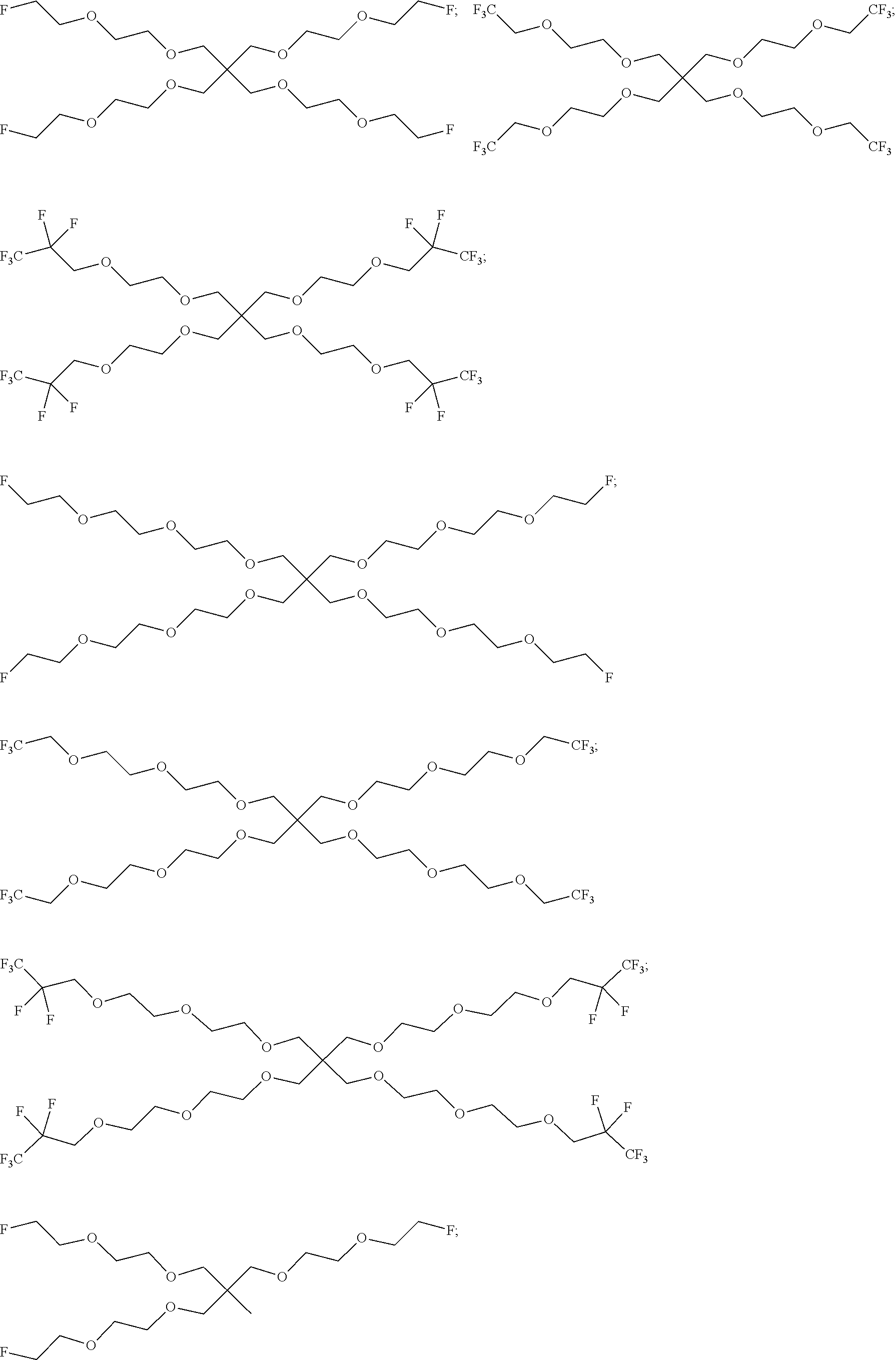

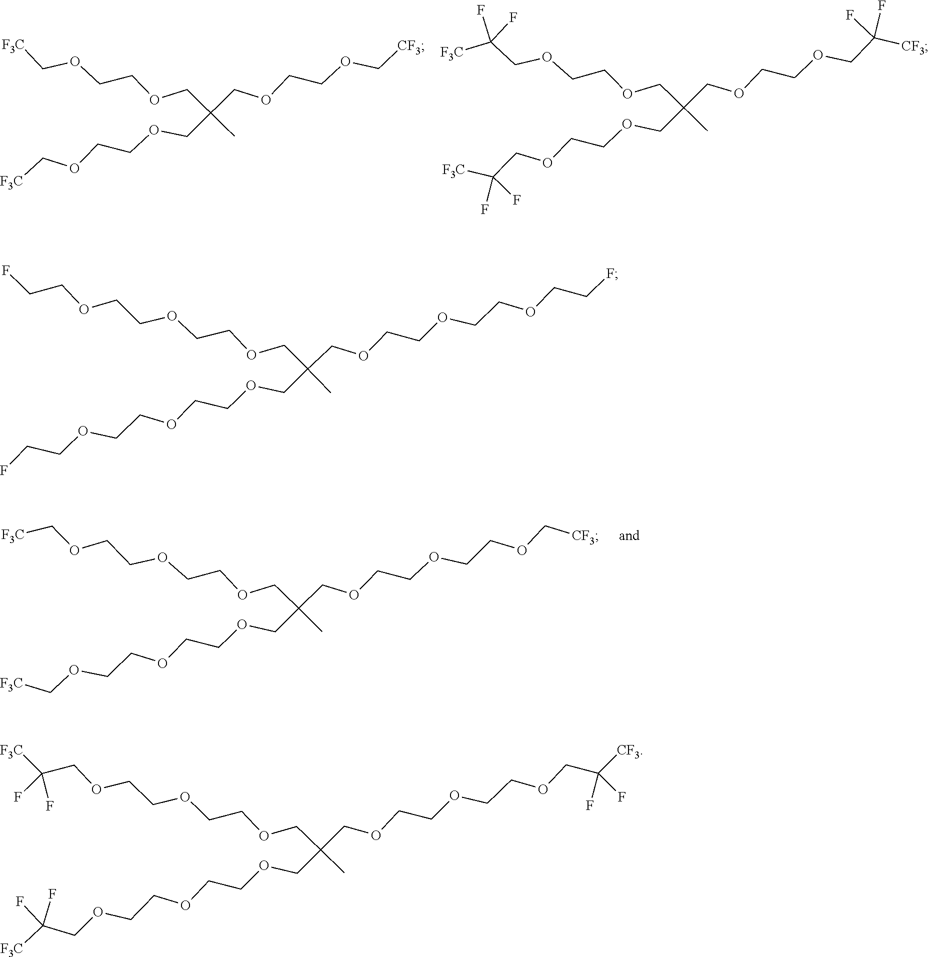 [SMILES: CC(COCCOCC(F)(F)F)(COCCOCC(F)(F)F)COCCOCC(F)(F)F ; CC(COCCOCC(F)(F)C(F)(F)F)(COCCOCC(F)(F)C(F)(F)F)COCCOCC(F)(F)C(F)(F)F ; CC(COCCOCCOCCF)(COCCOCCOCCF)COCCOCCOCCF ; CC(COCCOCCOCC(F)(F)F)(COCCOCCOCC(F)(F)F)COCCOCCOCC(F)(F)F ; CC(COCCOCCOCC(F)(F)C(F)(F)F)(COCCOCCOCC(F)(F)C(F)(F)F)COCCOCCOCC(F)(F)C(F)(F)F]

In addition to the features mentioned in each of the independent aspects enumerated above, some examples may show, alone or in combination, the optional features mentioned in the dependent aspects and/or as disclosed in the description above and shown in the figures.

1. A lithium-ion cell, comprising:
a first electrode comprising lithium metal or lithium iron phosphate (LiFePO₄);
a second electrode comprising graphite;
a fluoroether electrolyte comprising one or more compounds of formulae (I), (II), and/or (III): 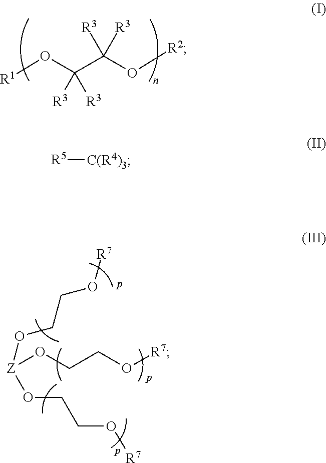
wherein R¹ is a fluoro-substituted C₂-C₆ alkyl group;
R² is a C₂-C₆ alkyl group or a fluoro-substituted C₂-C₆ alkyl group;
each R³ independently is H, F, methyl, or fluoro-substituted methyl;
n is 0, 1, 2, 3, 4, or 5;
each R⁴ is —CH₂—(OCH₂CH₂)ₘ—OR⁶;
R⁵ is methyl or R⁴;
R⁶ is a fluoro-substituted C₂-C₆ alkyl group;
m is 0, 1, 2, 3, 4, or 5;
each R⁷ is a fluoro-substituted C₂-C₆ alkyl group;
Z is B, Al, or P═O; and
p is 0, 1, 2, 3, 4, or 5.

2. The lithium-ion cell of claim 1, wherein a lithium salt is dissolved in the fluoroether electrolyte.

3. The lithium-ion cell of claim 1, wherein during cycling, the lithium-ion cell is configured promote lithium intercalation and (de)intercalation within graphite without fluoroether co-intercalation.

4. The lithium-ion cell of claim 1, wherein the fluoroether electrolyte comprises one or more compounds selected from:

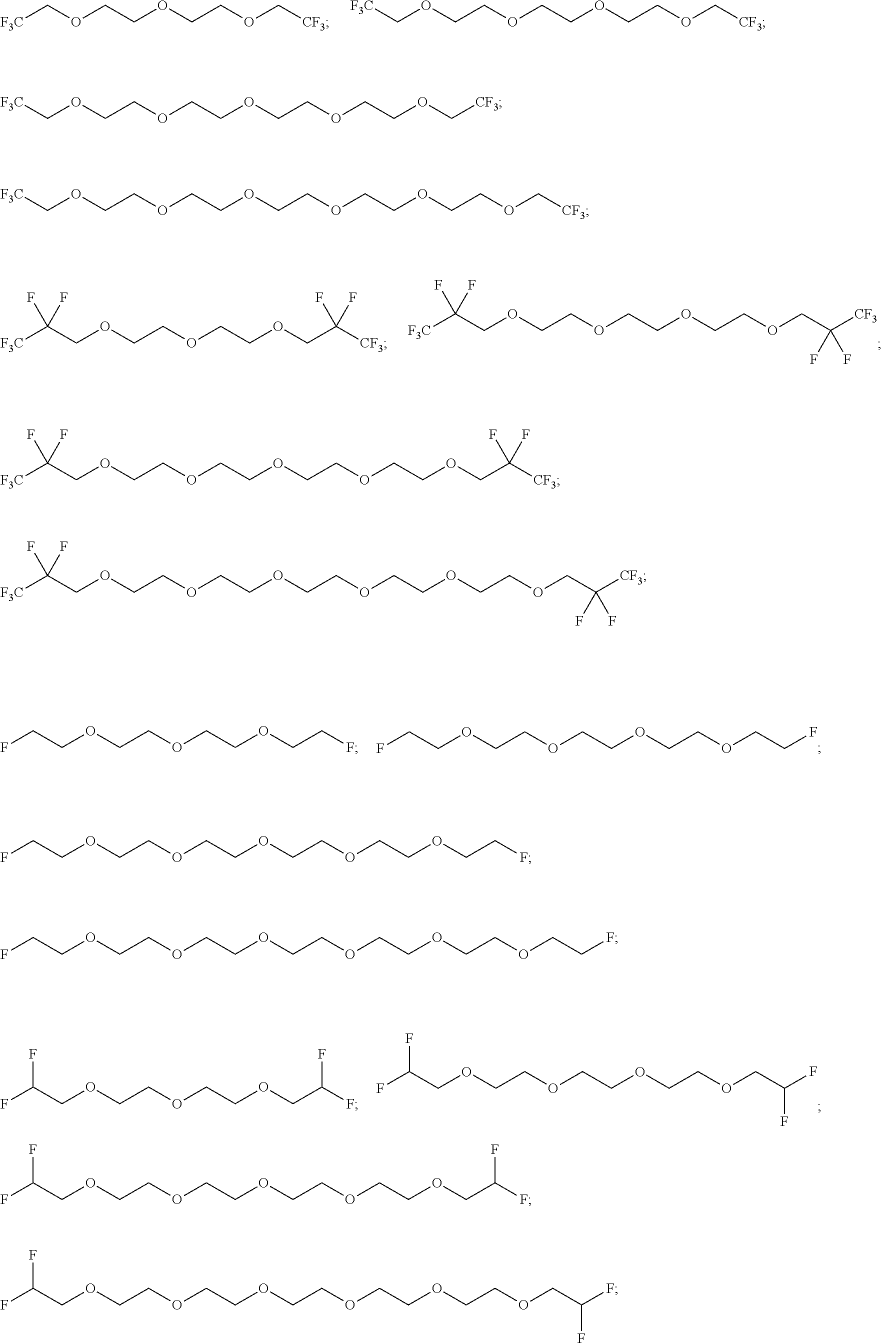

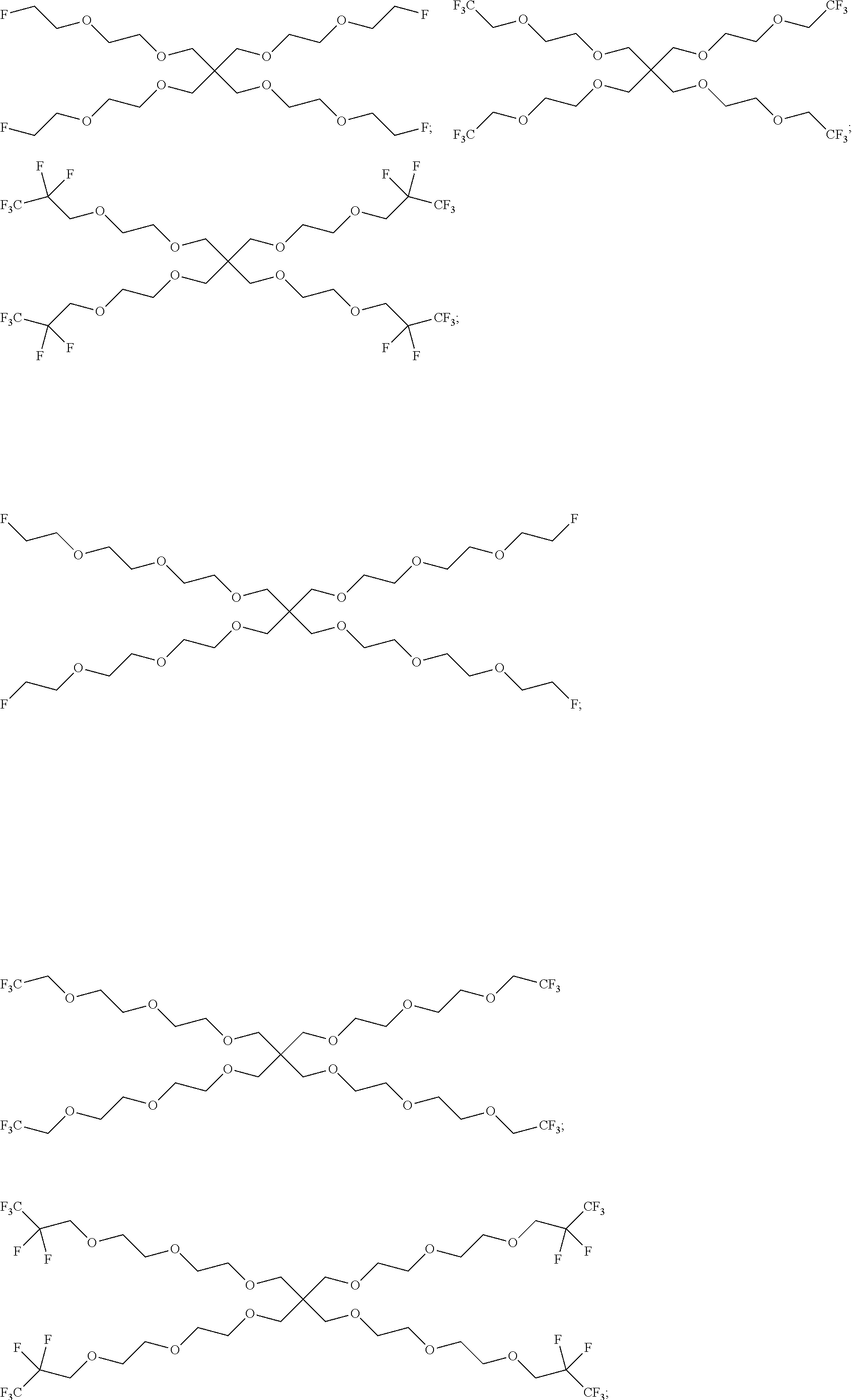

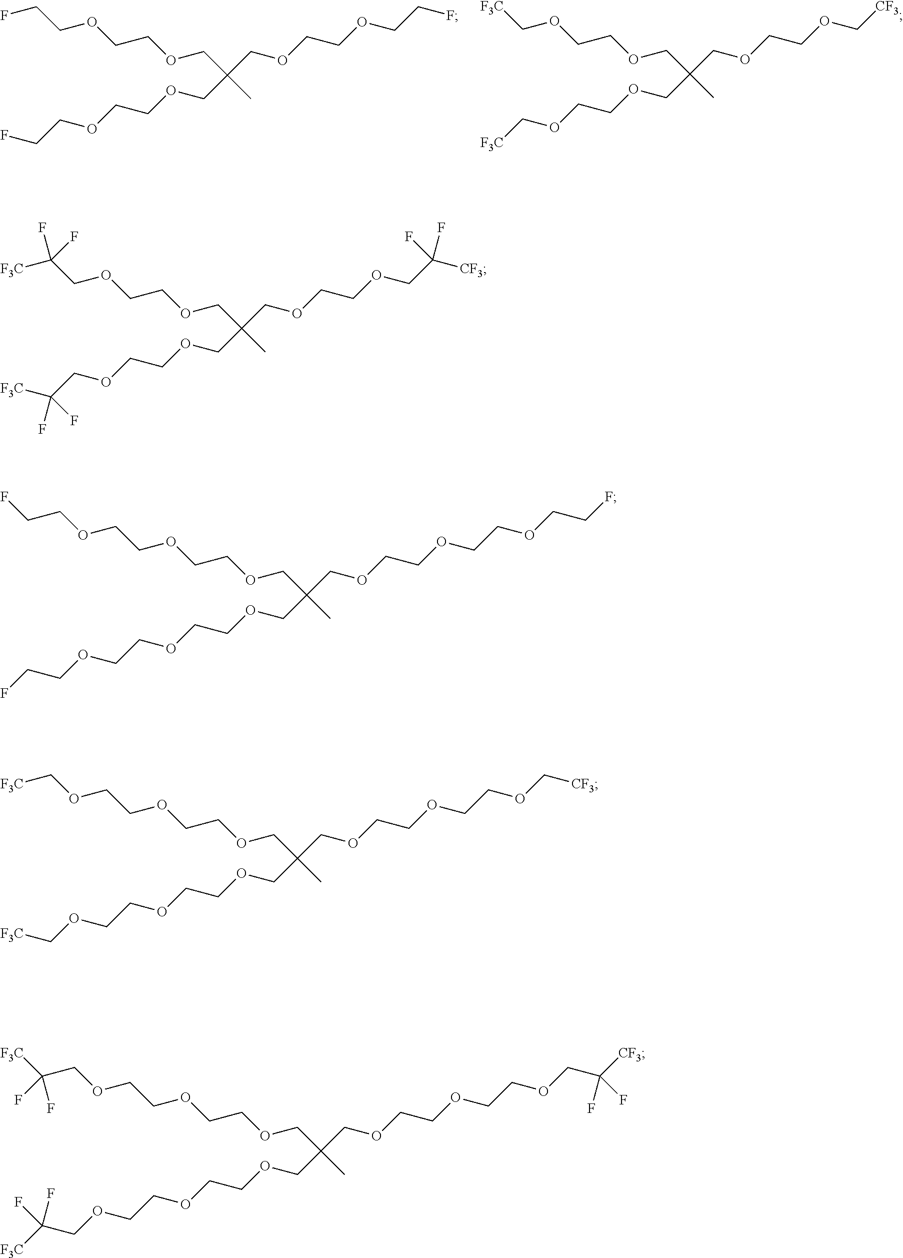 [SMILES: CC(COCCOCCF)(COCCOCCF)COCCOCCF ; CC(COCCOCC(F)(F)F)(COCCOCC(F)(F)F)COCCOCC(F)(F)F ; CC(COCCOCC(F)(F)C(F)(F)F)(COCCOCC(F)(F)C(F)(F)F)COCCOCC(F)(F)C(F)(F)F ; CC(COCCOCCOCCF)(COCCOCCOCCF)COCCOCCOCCF ; CC(COCCOCCOCC(F)(F)F)(COCCOCCOCC(F)(F)F)COCCOCCOCC(F)(F)F ; CC(COCCOCCOCC(F)(F)C(F)(F)F)(COCCOCCOCC(F)(F)C(F)(F)F)COCCOCCOCC(F)(F)C(F)(F)F]

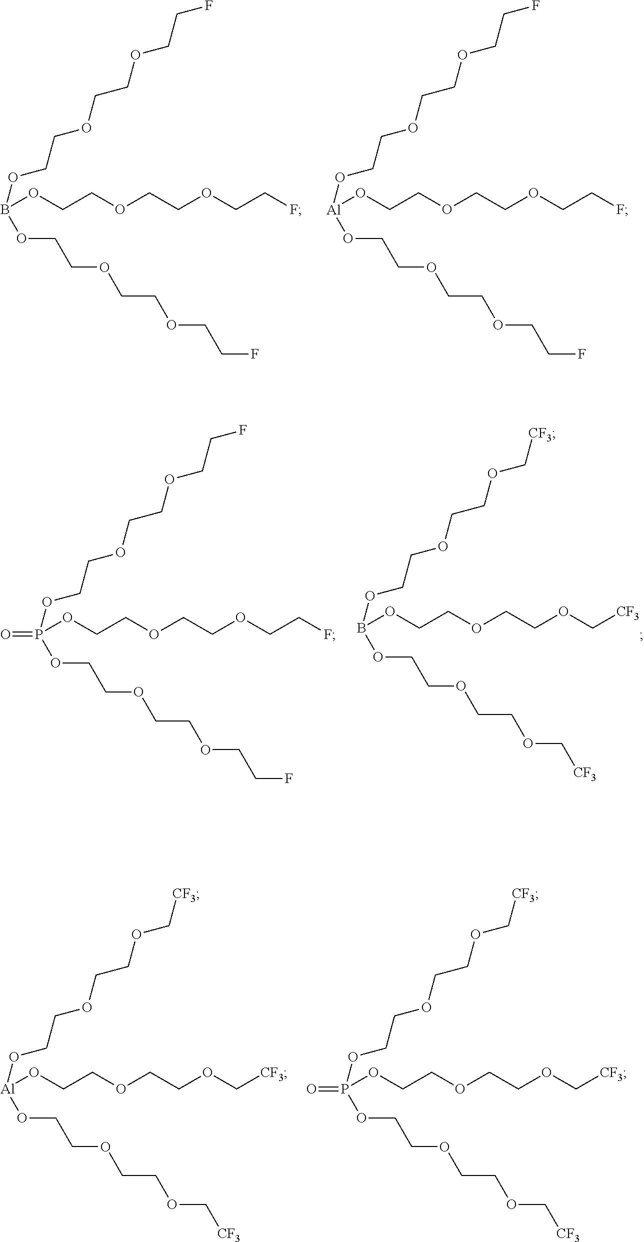

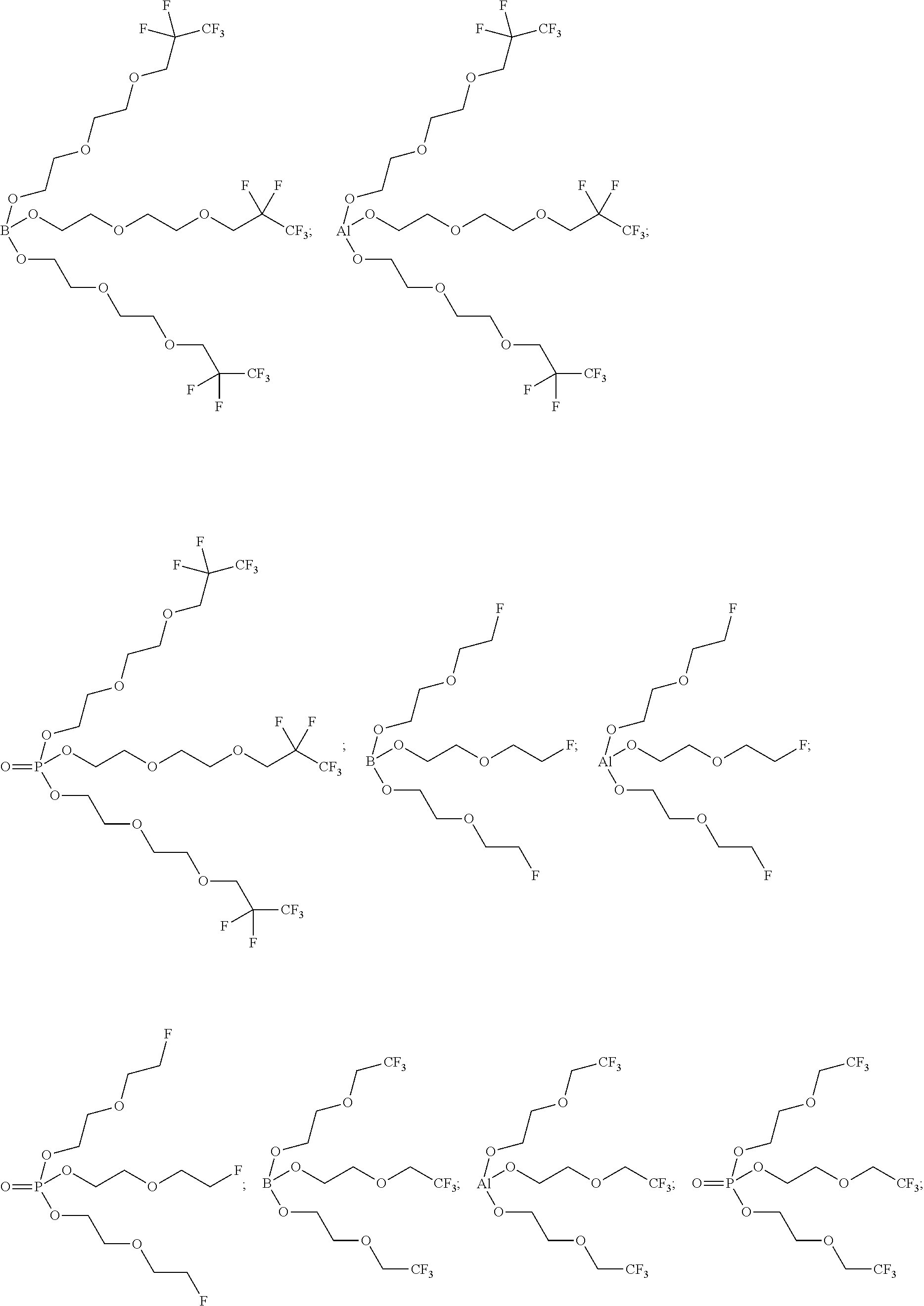

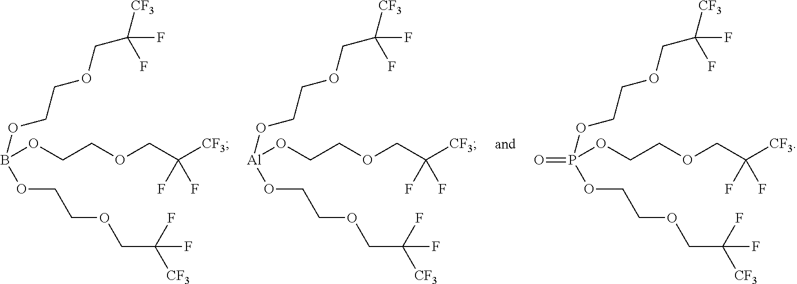

5. The lithium-ion cell of claim 1, wherein the fluoroether electrolyte comprises one or more compounds selected from:

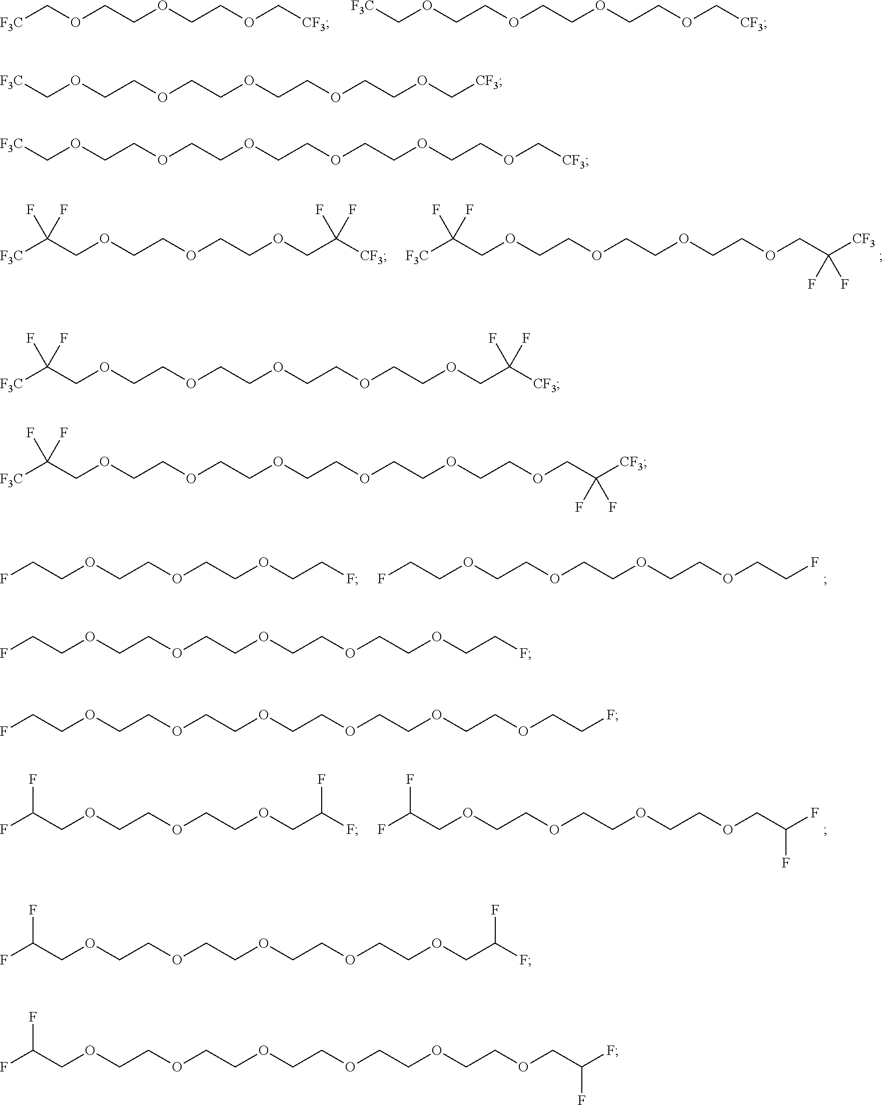

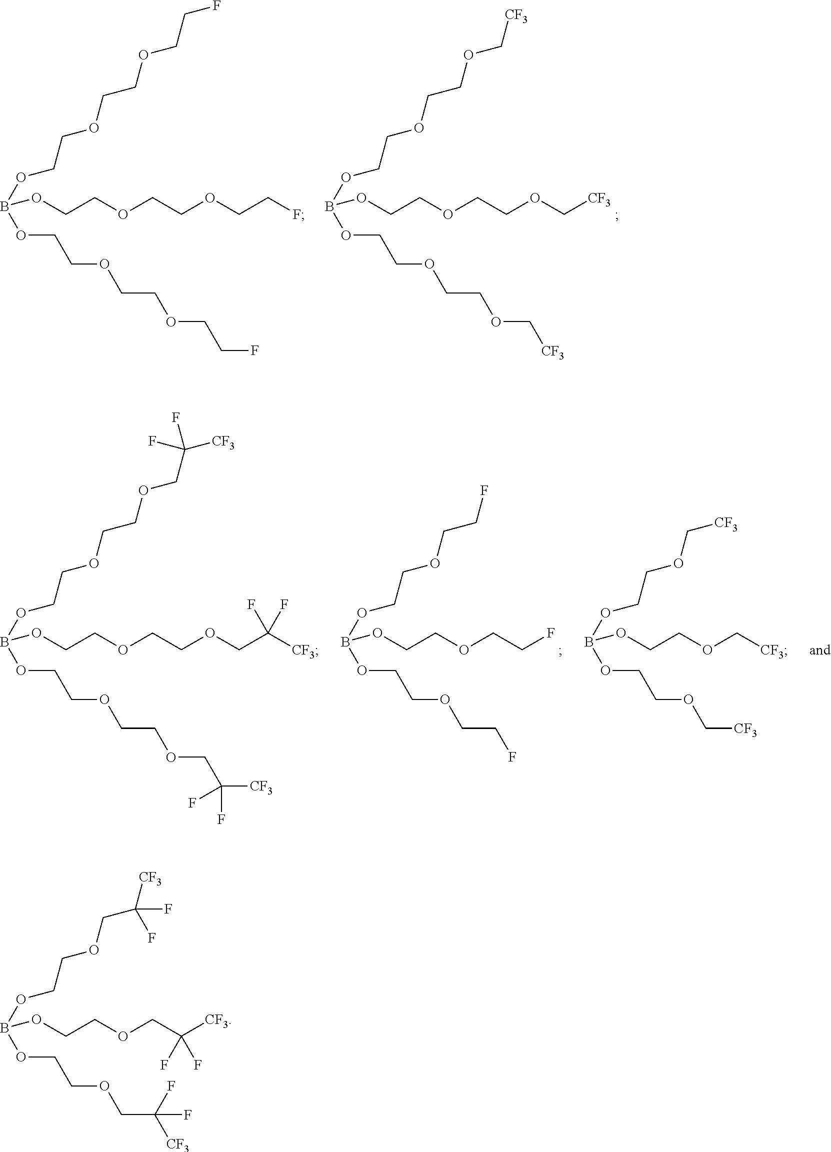

6. The lithium-ion cell of claim 1, wherein the lithium salt is selected from the group consisting of lithium bis(fluorosulfonyl)amide (LiFSA), LiTFSI, LiOTf, LiNO₃, LiPF₆, lithium bis(oxalato)borate (LiBOB), lithium difluoro(oxalate)borate (LiDFOB), LiBF₄, and LiClO₄.

7. The lithium-ion cell of claim 1, wherein the molarity of the lithium salt in the fluoroether electrolyte is from about 0.1 M to about 5.0 M.

8. The lithium-ion cell of claim 1, wherein during cycling, the lithium-ion cell is configured to retain at least 80% capacity between a temperature range of from about −20° C. to about 600 C.

9. The lithium-ion cell of claim 1, wherein the lithium-ion cell is configured to maintain a first-cycle coulombic efficiency of at least 85%.

10. The lithium-ion cell of claim 1, wherein the lithium-ion cell is configured to produce graphite intercalation compounds.

11. A battery, comprising a plurality of lithium-ion cells of claim 1, wherein the plurality of lithium-ion cells are connected in series or parallel.

12. A process for preparing a lithium-ion cell of claim 1, comprising:
dissolving a lithium salt in a fluoroether electrolyte comprising one or more compounds of formulae (I), (II), and/or (III) so as to provide a solution; and
adding the solution to a cell comprising a first electrode comprising lithium and a second electrode comprising graphite.

13. A composition comprising one or more compounds of formula (III): 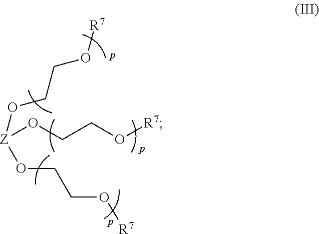
wherein each R⁷ is a fluoro-substituted C₂-C₆ alkyl group;
Z is B, Al, or P═O; and
p is 0, 1, 2, 3, 4, or 5.

14. The composition of claim 13, wherein the one or more compounds are selected from: 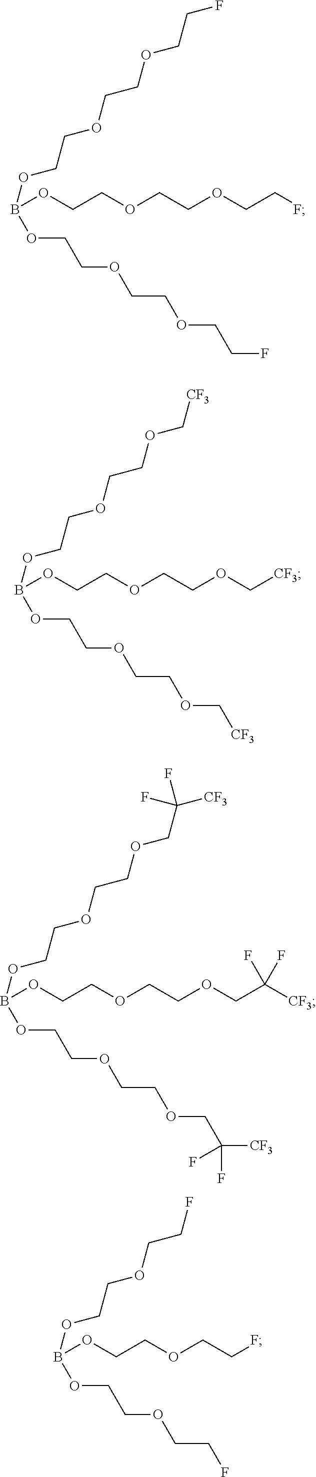 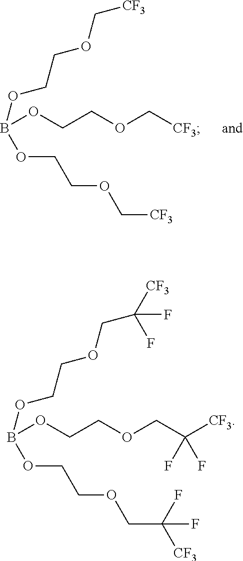 [SMILES: FC(F)(F)COCCOB(OCCOCC(F)(F)F)OCCOCC(F)(F)F ; "and" ; FC(F)(F)C(F)(F)COCCOB(OCCOCC(F)(F)C(F)(F)F)OCCOCC(F)(F)C(F)(F)F]
